(19) United States
(12) Patent Application Publication
(10) Pub. No.: US 2026/0369899 A1
(43) Pub. Date: Nov. 19, 2026

(54) JUMP-START TERMINAL

(71) Applicants: FURUKAWA ELECTRIC CO., LTD., Tokyo (JP); FURUKAWA AUTOMOTIVE SYSTEMS INC., Inukami-gun (JP)

(72) Inventors: Tomotsugu SHIRATORI, Inukami-gun (JP); Satoshi HIROSE, Inukami-gun (JP); Yuya IWAMATSU, Inukami-gun (JP)

(73) Assignees: FURUKAWA ELECTRIC CO., LTD., Tokyo (JP); FURUKAWA AUTOMOTIVE SYSTEMS INC., Inukami-gun (JP)

(21) Appl. No.: 19/140,783

(22) PCT Filed: Dec. 20, 2023
(86) PCT No.: PCT/JP2023/045695

§ 371 Date: Jun. 18, 2025

(30) Foreign Application Priority Data
Dec. 21, 2022 (JP) 2022-204454
Dec. 21, 2022 (JP) 2022-204455
Dec. 21, 2022 (JP) 2022-204456

(51) Int. Cl. H01R 4/48; B60R 16/03; H02G 3/16

(52) U.S. Cl. CPC H01R 4/48; B60R 16/03; H02G 3/16

(57) ABSTRACT

A jump-start terminal provided in a manner protruding from a base portion of a base body in an electrical connection box and clamped by a clamping portion in a clamp of a booster cable. The jump-start terminal is formed of a metal plate material connected to an electric circuit via a power supply input terminal. A locking recessed portion of a side bent piece that locks the clamping portion that performs clamping is provided in a manner protruding from at least one of both main surfaces of the metal plate material.

### TECHNICAL FIELD

The present invention relates to, for example, a jump-start terminal for connecting a booster cable to receive power when a battery of a vehicle such as a hybrid vehicle is dead.

### BACKGROUND ART

An automobile or the like is equipped with many electrical devices, and a battery is mounted as a power source. When a battery, which is such a power source, is over-discharged and the battery is dead, it is no longer possible to start an engine or operate other electrical devices.

For this reason, when a battery is dead, a battery post of the battery arranged in an engine room is clamped with a clamp provided at a tip of a booster cable, and power is supplied to cope with the dead battery.

Note that in a hybrid vehicle or the like, there has been a case where a battery is mounted on a vehicle rear portion or the like where a clamp of a booster cable cannot be directly attached to a battery post.

For this reason, Patent Literature 1 discloses an electrical connection box arranged in an engine room, the electrical connection box including a jump-start terminal (booster cable connection conductor) connected to a battery and clamped with a clamp of a booster cable.

The electrical connection box including the above-described jump-start terminal includes a jump-start terminal (booster cable connection conductor) formed by laminating a bus bar holding portion integrally formed on a case main body made from resin and a bus bar connected to a battery, and even in a case where a battery is mounted on a vehicle rear portion or the like, the jump-start terminal connected to the battery can be clamped with a clamp of a booster cable to supply power to the battery.

However, as described above, the jump-start terminal disclosed in Patent Literature 1 is configured by laminating the bus bar holding portion integrally formed in the case main body and the bus bar, and the laminated bus bar holding portion and bus bar are clamped with a clamp for conduction.

In a case of a hybrid vehicle or the like that may be energized with large current, large current is conducted to a contact portion between a clamp that clamps a jump-start terminal and a bus bar of the jump-start terminal and heat is generated, and a bus bar holding portion integrally formed with a case main body made from resin may deteriorate due to heat or aging.

### CITATION LIST

### Patent Literature

Patent Literature 1: JP 2002-330527 A

### SUMMARY OF INVENTION

### Technical Problem

An object of the present invention is to provide a jump-start terminal that can be clamped with a clamp for stable conduction and has high durability.

### Solution to Problem

According to the present invention, there is provided a jump-start terminal provided in a manner protruding from a base portion of a base body in an electrical connection box and clamped by a clamping portion in a clamp of a booster cable. The jump-start terminal includes a metal plate material connected to an electric circuit, and a locking portion that locks the clamping portion that performs clamping is provided on at least one of both main surfaces of the metal plate material.

The jump-start terminal provided in a manner protruding from the base portion of the base body in the above-described electrical connection box includes an aspect of protruding from another portion inside the electrical connection box, an aspect of protruding by providing a recessed portion around the jump-start terminal without protruding from another portion, an aspect of protruding outside the electrical connection box, an aspect of protruding in the inside so as to be exposed to the outside without protruding outside the electrical connection box, and the like.

“Provided on at least one of both main surfaces” as described above may mean “provided on at least one of both main surfaces”, or may mean “provided in a manner protruding from at least one of both main surfaces”.

By the present invention, the jump-start terminal of the present invention has high durability, and can be clamped by a clamp for stable conduction.

More specifically, since the jump-start terminal provided in a manner protruding from the base portion of the base body in the electrical connection box and clamped by the clamping portion in the clamp of the booster cable is formed of the metal plate material connected to the electric circuit, it is possible to improve durability such as heat resistance against heat generated by conduction or the like and weather resistance as compared with a jump-start terminal partially formed of a resin member.

Further, in the jump-start terminal formed of the metal plate material, the locking portion for locking the clamping portion that performs clamping is provided on at least one of both main surfaces of the metal plate material. For this reason, a clamping state of the clamp that performs clamping with the clamping portion can be stably stabilized with respect to the jump-start terminal formed of the metal plate material. For this reason, it is possible to stably perform conduction via the jump-start terminal clamped by the clamp.

Furthermore, since the clamped portion to be clamped by the clamping portion in the jump-start terminal can be clearly indicated by the locking portion, a worker can reliably clamp the clamped portion to be clamped by the clamping portion without making a mistake, and the clamp can be stably clamped to the jump-start terminal formed of the metal plate material.

Further, since the metal plate material is clamped by the clamping portion, a contact area between the clamping portion and the metal plate material is increased and conductivity is improved as compared with a case where a holding portion made from resin integrally formed in a case main body and the metal plate material are clamped by the clamping portion. For this reason, it is possible to reduce an amount of heat generation of the jump-start terminal caused by being clamped by the clamping portion and application of large current.

As an aspect of the present invention, the locking portion may be formed to have width corresponding to width of the clamping portion.

The width of the clamping portion is in a direction along a pivot axis of a clamp that pivots to open and close.

According to the present invention, it is possible to reliably lock the clamping portion with respect to the locking portion formed to have width corresponding to width of the clamping portion, and to further stabilize a clamping state of the clamp.

Further, as an aspect of the present invention, the locking portion may be provided at positions corresponding to both end portions in a width direction of the clamping portion.

According to the present invention, even the clamping portion formed to have a rectangular U-shaped cross section can reliably clamp, by the clamping portion, the locking portion provided at positions corresponding to both end portions in the width direction of the clamping portion. Further, since the locking portions are provided at positions corresponding to both end portions in the width direction of the clamping portion in the metal plate material, machining can be performed efficiently and easily as compared with a case where a locking portion is provided in the entire width direction.

Further, as an aspect of the present invention, the locking portion may be a recessed locking portion having a recessed shape with respect to a main surface.

According to the present invention, a tip of the clamping portion bites into and is locked with respect to the recessed locking portion having a recessed shape, so that a clamping state by the clamping portion with respect to the metal plate material is not unintentionally released, and a stable clamping state can be achieved.

Further, as an aspect of the present invention, the recessed locking portion may have a recessed shape formed to have depth of a part of plate thickness of the metal plate material.

By the present invention, it is possible to suppress decrease in member strength as compared with the recessed locking portion penetrating in a plate thickness direction of the metal plate material, and to achieve high durability and a stable clamping state. Further, it is possible to suppress decrease in conductivity of the jump-start terminal as compared with the recessed locking portion penetrating in the plate thickness direction of the metal plate material.

Further, as an aspect of the present invention, the locking portion may be a projecting locking portion having a projecting shape with respect to a main surface.

By the present invention, the projecting locking portion having a projecting shape bites into and is locked to a tooth portion of the clamping portion, so that a clamping state by the clamping portion with respect to the metal plate material is not unintentionally released, and a stable clamping state can be achieved.

Further, as an aspect of the present invention, the projecting locking portion may be a bead protruding in a plate thickness direction of the metal plate material.

The bead may be formed by bending or extruding the metal plate material in the plate thickness direction, or may be formed by build-up on the metal plate material.

By the present invention, a tip of the clamping portion is reliably locked to the bead having a projecting shape, so that a clamping state by the clamping portion with respect to the metal plate material is not unintentionally released, and a stable clamping state can be achieved.

Further, as an aspect of the present invention, the locking portion may be a protruding direction bead formed along the protruding direction of the metal plate material.

The protruding direction bead formed along the protruding direction may be formed in the entire range in the protruding direction of the metal plate material, or may be formed only in a clamped portion clamped by the clamping portion in the metal plate material. Further, the protruding direction bead may be formed by bending or extruding the metal plate material in the plate thickness direction, or may be formed by build-up on the metal plate material.

By the present invention, rigidity along a protruding direction of the metal plate material, that is, in the plate thickness direction can be improved, and the protruding direction bead formed along the protruding direction can bite into and be locked to a tip of the clamping portion, and a stable clamping state can be achieved.

Further, in the electrical connection box, the jump-start terminal needs a hole for the locking portion to pass through when being arranged in a manner penetrating a part of the base portion, and a hole for the locking portion having an uneven shape extending in the protruding direction to pass through the base portion can be made smaller than a hole for the locking portion having an uneven shape extending in the width direction to pass through, and the jump-start terminal can be stably attached to the base portion.

Further, as an aspect of the present invention, a plurality of the metal plate materials may be laminated in the plate thickness direction, and the locking portion may be an interlocking portion that interlocks in the plate thickness direction from one to another one of the metal plate materials that are laminated.

One or a plurality of the above-described interlocking portions may be provided. In a case where a plurality of the interlocking portions are provided, all the interlocking portions may interlock in the same direction, or some of the interlocking portions may interlock in a direction opposite to another one of the interlocking portions.

Further, the interlocking portion may be in an aspect in which the interlocking portion has a projecting shape on a main surface of the metal plate material on one side of the metal plate materials that are laminated and has a recessed shape on a main surface of the metal plate material on another side, or may be in an aspect in which the interlocking portion has a recessed shape on a main surface of the metal plate material on one side and has a projecting shape on a main surface of the metal plate material on another side. Note that the recessed shape includes not only a recess but also an opening and a notch.

By the present invention, since a plurality of the metal plate materials that are laminated are integrated by the interlocking portion, the jump-start terminal having high rigidity can be formed as compared with a case where the jump-start terminal is formed of one of the metal plate material.

Further, since the interlocking portion that interlocks and integrates the metal plate materials that are laminated functions as the locking portion, it is possible to stabilize a clamping state of the clamp with respect to the jump-start terminal formed of the metal plate materials that are laminated and integrated without separately providing a locking portion.

Further, as an aspect of the present invention, one of a plurality of the metal plate materials that are laminated may be used as a reference plate material, another one of the metal plate materials may be used as a joining plate material, the joining plate material may be shorter than the reference plate material, and the joining plate material may be laminated on a clamped portion clamped by the clamping portion in the reference plate material.

By the present invention, it is possible to reduce weight of the jump-start terminal that can be stably clamped by the clamping portion as compared with a case where the joining plate material is laminated on the entire reference plate material. Further, a step portion formed of the joining plate material shorter than the reference plate material can also function as a locking portion.

Further, as an aspect of the present invention, a plurality of the metal plate materials may be laminated in the plate thickness direction, and the locking portion may be provided on at least one of both main surfaces of the metal plate materials in a laminated state.

By the present invention, as compared with a case where the locking portion is provided by being machined to the metal plate material having the same plate thickness as thickness of a plurality of the metal plate materials that are laminated, it is possible to easily perform machining of providing a locking portion on any of the metal plate materials that are laminated to form the locking portion with high accuracy.

As an aspect of the present invention, one of a plurality of the metal plate materials that are laminated may be used as a reference plate material, another one of the metal plate materials may be used as a joining plate material, and the locking portion may be provided on the joining plate material.

By the present invention, it is possible to easily form the locking portion that does not penetrate, in the plate thickness direction, the metal plate materials that are laminated. Therefore, the locking portion can be provided without machining the reference plate material having another terminal portion to which another fuse or relay is connected. Further, since a shape of the reference plate material can be simplified, the reference plate material can be easily machined.

Further, as an aspect of the present invention, the joining plate material may be a metal thick plate material having plate thickness larger than that of the reference plate material.

By the present invention, the jump-start terminal having higher rigidity than a case where the metal plate materials having the same thickness are laminated can be formed.

Further, in a case where the locking portion is formed on the reference plate material, since machinability is higher than that of a metal thick plate material, the locking portion with high accuracy can be formed by easy machining.

Furthermore, since a metal thick plate material having plate thickness larger than that of a metal plate material has high conductivity, stable power supply can be performed, plate thickness of the metal thick plate material can be adjusted according to current that is conducted, and an amount of heat generated in the metal thick plate material can be adjusted.

Further, as an aspect of the present invention, in the metal thick plate material, on a base end side in a protruding direction in which the metal plate material protrudes, a fastening hole into which a fixing bolt for fixing a power supply input terminal connected to the electric circuit is fastened may be provided.

By the present invention, the metal thick plate material laminated with the reference plate material can function as a nut for screwing and connecting a fixing bolt for fixing a power supply input terminal connected to the electric circuit such as an automobile round plate terminal (LA terminal), and the power supply input terminal can be stably connected to the jump-start terminal.

As an aspect of the present invention, a fastening body that fastens and fixes a power supply input terminal connected to the electric circuit may be provided on the tip side of the metal plate material, and the locking portion may be the fastening body.

The fastening body may be a combination of a fixing bolt and a nut, a fixing bolt screwed to a nut provided on the reference plate material, or a nut screwed to a stud bolt provided on the reference plate material.

By the present invention, the fastening body that fixes a power supply input terminal to the jump-start terminal functions as a locking portion without separate provision of a locking portion, and the clamping portion that clamps the reference plate material is locked to the fastening body, so that a stable clamping state can be maintained.

Further, the present invention is a jump-start terminal provided in a manner protruding from a base portion of a base body in an electrical connection box and clamped by a clamping portion in a clamp of a booster cable, the jump-start terminal including two metal plate materials connected to an electric circuit and laminated in a plate thickness direction, and a locking portion that locks the clamping portion that performs clamping is provided at a tip portion of one of two of the metal plate materials, and the locking portion protrudes to the side opposite to another one of two of the metal plate materials.

By the present invention, the jump-start terminal of the present invention has high durability, and can be clamped by a clamp for stable conduction.

Specifically, since the jump-start terminal provided in a manner protruding from the base portion of the base body in the electrical connection box and clamped by the clamping portion in the clamp of the booster cable is formed of two of the metal plate materials that are connected to an electric circuit and laminated in the plate thickness direction, it is possible to improve durability such as heat resistance against heat generated by conduction or the like and weather resistance as compared with a jump-start terminal partially formed of a resin member.

Further, in the jump-start terminal formed of two metal plate materials laminated in the plate thickness direction, the locking portion for locking the clamping portion that performs clamping is provided at a tip portion of one of two of the metal plate materials, and the locking portion protrudes to the side opposite to another one of two of the metal plate materials. For this reason, a clamping state of the clamp that performs clamping with the clamping portion can be stabilized stably with respect to the jump-start terminal formed of the metal plate materials. For this reason, it is possible to stably perform conduction via the jump-start terminal clamped by the clamp.

Further, since the metal plate material is clamped by the clamping portion, a contact area between the clamping portion and the metal plate material is increased and conductivity is improved as compared with a case where a holding portion made from resin integrally formed in a case main body and the metal plate material are clamped by the clamping portion. For this reason, it is possible to reduce an amount of heat generation of the jump-start terminal caused by being clamped by the clamping portion and application of large current.

Further, as an aspect of the present invention, the locking portion may be formed of a tip bent portion obtained by bending a tip of one of two of the metal plate materials to the side opposite to another one of two of the metal plate materials.

By the present invention, it is possible to easily form the tip bent portion capable of stabilizing a clamping state of the clamp.

Further, as an aspect of the present invention, one on which the tip bent portion is provided of two of the metal plate materials may be set to a first metal plate material, another one of the metal plate materials may be set to a second metal plate material, and the first metal plate material may include a first mounting base portion on a mounting base side and a first terminal main body portion having small width protruding in the protruding direction from the first mounting base portion, and the second metal plate material may be formed in a substantially band shape with a second terminal main body portion having the same width as the first terminal main body portion of the first metal plate material and a second mounting base portion having the same width as the second terminal main body portion.

By the present invention, it is possible to laminate the first metal plate material formed of the first mounting base portion having large width and the first terminal main body portion having small width and the second metal plate material formed in a band shape with the second terminal main body portion and the second mounting base portion having the same width to form the jump-start terminal capable of stabilizing a clamping state of the clamp by the tip bent portion.

Further, as an aspect of the present invention, the tip bent portion may be formed to have width corresponding to width of the clamping portion and may be formed to have width smaller than width of the first terminal main body portion.

By the present invention, the tip bent portion that does not protrude in the width direction from the first terminal main body portion can be formed.

The present invention is a jump-start terminal provided in a manner protruding from a base portion of a base body in an electrical connection box and clamped by a clamping portion in a clamp of a booster cable, the jump-start terminal including a metal plate material that is connected to an electric circuit and in which a clamped portion on a tip side is clamped by the clamping portion, in which at least the clamped portion has predetermined thickness to be clamped by the clamping portion with required clamping force.

The jump-start terminal provided in a manner protruding from the base portion of the base body in the above-described electrical connection box includes an aspect of protruding from another portion inside the electrical connection box, an aspect of protruding by providing a recessed portion around the jump-start terminal without protruding from another portion, an aspect of protruding outside the electrical connection box, an aspect of protruding in the inside so as to be exposed to the outside without protruding outside the electrical connection box, and the like.

Having the predetermined thickness (thickness to be clamped by the clamping portion by application of clamping force that stabilizes a clamping state by the clamping portion) may be applied only to the clamped portion of the metal plate material or the entire metal plate material. Note that the predetermined thickness is thickness required to clamp the clamped portion of the metal plate material with the clamping portion in a state where biasing force by a spring of the clamp acts, and to stabilize the clamp.

Note that the required clamping force is force that allows stable conduction without coming off even when unintended force such as unintentional contact by a worker is applied.

By the present invention, the jump-start terminal of the present invention has high durability, and can be clamped by a clamp for stable conduction.

More specifically, the clamping portion that clamps the metal plate material is closed by a spring in a normal state, and the clamping portion is opened against biasing force of the spring to clamp the metal plate material. Therefore, clamping force for clamping the metal plate material is biasing force of the spring of the clamp, where biasing force of the spring is larger when the clamping portion is opened, and clamping force for clamping the metal plate material is also larger. For this reason, by setting thickness of the clamped portion clamped by the clamping portion to predetermined thickness, durability can be improved as compared with a case where a bus bar holding portion made from resin is included, and the clamping portion can clamp the clamped portion of the metal plate material with required clamping force. Therefore, it is possible to stably perform conduction by clamping with the clamp.

Further, since the metal plate material is clamped by the clamping portion, a contact area between the clamping portion and the metal plate material is increased and conductivity is improved as compared with a case where a holding portion made from resin integrally formed in a case main body and the metal plate material are clamped by the clamping portion. For this reason, it is possible to reduce an amount of heat generation of the jump-start terminal caused by being clamped by the clamping portion and application of large current.

As an aspect of the present invention, a direction orthogonal to a protruding direction in which the metal plate material protrudes on a main surface of the metal plate material may be defined as a width direction, and the clamped portion may include a bent clamped portion which is bent in a plate thickness direction along both end edges in the width direction of the metal plate material.

By the present invention, even in the metal plate material that is thinner than the predetermined thickness, the bent clamped portion having the predetermined thickness can be formed by bending in the plate thickness direction along both end edges in the width direction of the metal plate material. Therefore, weight can be reduced as compared with the metal plate material formed to have the predetermined thickness as a whole.

Further, as an aspect of the present invention, a locking portion that locks the clamping portion that performs clamping may be provided in the bent clamped portion. By the present invention, the clamping portion can stably perform clamping with required clamping force.

More specifically, since the bent clamped portion is formed only in a part in the width direction of the clamping portion, a contact area between the bent clamped portion and the clamping portion is reduced, and a clamping state tends to be unstable. However, the clamping portion is locked to a locking portion provided in the bent clamped portion, so that the clamping portion can perform clamping in a stable clamping state. The width of the clamping portion is in a direction along a pivot axis of a clamp that pivots to open and close.

Furthermore, since the clamped portion to be clamped by the clamping portion in the jump-start terminal can be clearly indicated by the locking portion, a worker can reliably clamp the clamped portion to be clamped by the clamping portion without making a mistake, and the clamp can be stably clamped to the jump-start terminal formed of the metal plate material.

Further, as an aspect of the present invention, a tip bent portion bent toward the side opposite to the bent clamped portion in the plate thickness direction may be provided at a tip of the metal plate material.

By the present invention, thickness of the clamped portion by the clamping portion can be further increased, clamping force of the clamping portion is increased, and the clamping portion can perform clamping in a more stable clamping state.

More specifically, since the clamping portion widely opens against biasing force of the spring and clamps the bend clamped portion and the tip bent portion bent to the side opposite to the bend clamped portion, thickness of the clamped portion by the clamping portion can be further increased, clamping force of the clamping portion is increased, and the clamp can perform clamping in a more stable clamping state.

Further, as an aspect of the present invention, another second metal plate material may be laminated on at least the clamped portion in the metal plate material to form the predetermined thickness.

By the present invention, it is possible to stably perform conduction by clamping with a clamp.

More specifically, since the metal plate material and the second metal plate material are laminated, thickness of the clamped portion which is clamped by the clamping portion can be set to the predetermined thickness, and the clamping portion can clamp the clamped portion of the metal plate material with required clamping force.

Further, as an aspect of the present invention, interlocking may be performed in the plate thickness direction from the metal plate material toward the second metal plate material that are laminated.

One or a plurality of the above-described interlocking portions may be provided. In a case where a plurality of the interlocking portions are provided, all the interlocking portions may interlock in the same direction, or some of the interlocking portions may interlock in a direction opposite to another one of the interlocking portions.

Further, the interlocking portion may be in an aspect in which the interlocking portion has a projecting shape on a main surface of the metal plate material on one side of the metal plate materials that are laminated and has a recessed shape on a main surface of the metal plate material on another side, or may be in an aspect in which the interlocking portion has a recessed shape on a main surface of the metal plate material on one side and has a projecting shape on a main surface of the metal plate material on another side. Note that the recessed shape includes not only a recess but also an opening and a notch.

By the present invention, since a plurality of the metal plate materials that are laminated are integrated by the interlocking portion, the jump-start terminal having high rigidity with increased plate thickness can be formed as compared with a case where the jump-start terminal is formed of one of the metal plate material.

Further, by clamping the interlocking portion with the clamping portion, the clamping portion is locked to the interlocking portion, and a stable clamping state can be obtained.

As an aspect of the present invention, the second metal plate material may be a metal thick plate material having plate thickness larger than that of the metal plate material.

By the present invention, the jump-start terminal having higher rigidity than a case where the metal plate materials having the same thickness are laminated can be formed.

Further, since a metal thick plate material having plate thickness larger than that of a metal plate material has high conductivity, stable power supply can be performed, plate thickness of the metal thick plate material can be adjusted according to current that is conducted, and an amount of heat generated in the metal thick plate material can be adjusted.

Further, as an aspect of the present invention, in the metal thick plate material, on a base end side in a protruding direction in which the metal plate material protrudes, a fastening hole into which a fixing bolt for fixing a power supply input terminal connected to an electric circuit is fastened may be provided.

By the present invention, the metal thick plate material laminated with the reference plate material can function as a nut for screwing and connecting a fixing bolt for fixing a power supply input terminal connected to the electric circuit such as an automobile round plate terminal (LA terminal), and the power supply input terminal can be stably connected to the jump-start terminal.

Further, as an aspect of the present invention, a fastening body that fixes a power supply input terminal connected to an electric circuit may be provided in the clamped portion, and the fastening body provided in the clamped portion may have the predetermined thickness.

Note that the fastening body includes a fixing bolt and a nut for fixing a power supply input terminal to the metal plate material, a nut screwed to a stud bolt implanted in the metal plate material, a fixing bolt screwed to a nut provided in the metal plate material, and the like.

By the present invention, since the predetermined thickness can be secured by the fastening body even if the metal plate material is not formed to have the predetermined thickness, the clamp can clamp the clamped portion with required clamping force.

Further, as an aspect of the present invention, a part of the metal plate material may be arranged at a predetermined interval in the plate thickness direction corresponding to the predetermined thickness to form the clamped portion.

In the clamped portion in which a part of the metal plate material is arranged at a predetermined interval in the plate thickness direction corresponding to the predetermined thickness, two of the metal plate materials may be arranged at a predetermined interval, or one of the metal plate materials may be branched and arranged at a predetermined interval.

By the present invention, as if a part of the metal plate material arranged at a predetermined interval forms the clamped portion having predetermined thickness, and clamping can be performed with required clamping force.

Further, as an aspect of the present invention, in the clamped portion, an interval holding portion for holding an interval between parts of the metal plate materials arranged at the predetermined interval may be provided.

By the present invention, when the clamped portion formed of parts of the metal plate materials arranged at a predetermined interval is clamped by the clamping portion, they tend to approach each other by clamping force of the clamping portion, but an interval between the parts of the metal plate materials can be held at a predetermined interval by the interval holding portion. Therefore, the clamp can clamp the clamped portion with required clamping force.

Further, as an aspect of the present invention, the interval holding portion may be a projecting interval holding portion that is provided on at least one of parts of the metal plate materials arranged at a predetermined interval and has a projecting shape toward another one.

By the present invention, when the clamped portion formed of a part of the metal plate material arranged at a predetermined interval is clamped by the clamping portion, the projecting interval holding portion provided in a part of one of the metal plate materials can abut on a part of another one of the metal plate materials or the projecting interval holding portion provided in a part of the metal plate material to hold an interval. Therefore, the clamp can clamp the clamped portion with required clamping force.

Further, as an aspect of the present invention, the projecting interval holding portion may be a bead protruding in a plate thickness direction of the metal plate material.

The bead may be formed by bending or extruding the metal plate material in the plate thickness direction, or may be formed by build-up on the metal plate material. By the present invention, a protrusion amount toward the other can be adjusted by a bead shape, and the bead protruding toward the other abuts on the other, so that a predetermined interval can be maintained. Therefore, the clamp can clamp the clamped portion with required clamping force.

Further, as an aspect of the present invention, the interval holding portion may be a projecting piece that is provided on at least one of parts of the metal plate materials arranged at a predetermined interval and is directed toward the other.

By the present invention, a protrusion amount toward the other can be adjusted by a shape of the projecting piece, and the projecting piece having a simple structure protruding toward the other abuts on the other, so that a predetermined interval can be maintained. Therefore, the clamp can clamp the clamped portion with required clamping force.

Further, as an aspect of the present invention, a tip bent portion bent toward the side away from the other may be provided at a tip of at least one of the metal plate materials arranged at a predetermined interval.

By the present invention, clamping force of the clamping portion is increased, and clamping can be performed in a more stable clamping state.

More specifically, since the clamping portion that clamps the clamped portion formed of parts of the metal plate materials arranged at a predetermined interval also clamps the tip bent portion together, the clamping portion widely opens against biasing force of a spring, the clamping force of the clamping portion increases, and the clamp can perform clamping in a more stable clamping state.

Further, as an aspect of the present invention, a recessed portion that has a recessed shape toward an opposing direction may be provided at the center in the width direction of the tip bent portion.

By the present invention, at the time of attachment to the base body of the electrical connection box, a peripheral component can pass through the recessed portion provided in the tip bent portion, and interference with the peripheral component can be prevented.

Further, as an aspect of the present invention, the clamped portion may be a protruding direction bead formed along a protruding direction of the metal plate material.

The protruding direction bead formed along the protruding direction of the metal plate material may be formed in the entire range in the protruding direction of the metal plate material, or may be formed only in the clamped portion that is clamped by the clamping portion in the metal plate material. Further, the protruding direction bead may be formed by bending or extruding the metal plate material in the plate thickness direction, or may be formed by build-up on the metal plate material.

By the present invention, the predetermined thickness can be secured by the protruding direction bead along the protruding direction even in the metal plate material thinner than the predetermined thickness.

Further, even when a clamped position in the protruding direction in the metal plate material by the clamping portion is shifted, the predetermined thickness can be secured.

Further, according to the present invention, there is provided a jump-start terminal provided in a manner protruding from a base portion of a base body in an electrical connection box and clamped by a clamping portion in a clamp of a booster cable, the jump-start terminal including two metal plate materials connected to an electric circuit and laminated in a plate thickness direction, a tip side being a clamped portion clamped by the clamping portion, in which a tip portion of one of two of the metal plate materials is provided with a protruding portion protruding to a side opposite to another one of two of the metal plate materials, and the clamped portion has, with two of the metal plate materials and the protruding portion, predetermined thickness to be clamped by the clamping portion with required clamping force.

By the present invention, the jump-start terminal of the present invention has high durability, and can be clamped by a clamp for stable conduction.

More specifically, by setting thickness of the clamped portion, which is clamped by the clamping portion, to the predetermined thickness by two of the metal plate materials and a protruding portion provided at a tip portion of one of two of the metal plate materials, durability can be improved as compared with a case where a bus bar holding portion made from resin is provided, and the clamping portion can clamp the clamped portion of the metal plate material with required clamping force. Therefore, it is possible to stably perform conduction by clamping with the clamp.

Further, since the metal plate material is clamped by the clamping portion, a contact area between the clamping portion and the metal plate material is increased and conductivity is improved as compared with a case where a holding portion made from resin integrally formed in a case main body and the metal plate material are clamped by the clamping portion. For this reason, it is possible to reduce an amount of heat generation of the jump-start terminal caused by being clamped by the clamping portion and application of large current.

Further, as an aspect of the present invention, the protruding portion may be formed of a tip bent portion obtained by bending a tip of one of two of the metal plate materials to the side opposite to another one of two of the metal plate materials.

By the present invention, since thickness of the clamped portion by the clamping portion is increased and the clamped portion is clamped in a stable clamping state, the tip bent portion can be easily formed.

Further, as an aspect of the present invention, one on which the tip bent portion is provided of two of the metal plate materials may be set to a first metal plate material, another one of the metal plate materials may be set to a second metal plate material, and the first metal plate material may include a first mounting base portion on a mounting base side and a first terminal main body portion having small width protruding from the first mounting base portion, and the second metal plate material may be formed in a substantially band shape with a second terminal main body portion having same width as the first terminal main body portion of the first metal plate material and a second mounting base portion having same width as the second terminal main body portion.

The present invention, the first metal plate material formed of the first mounting base portion having large width and the first terminal main body portion having small width and the second metal plate material formed in a band shape with the second terminal main body portion and the second mounting base portion having the same width can be laminated to form the jump-start terminal having the clamped portion having predetermined thickness that is clamped by the clamping portion with required clamping force.

Further, as an aspect of the present invention, the tip bent portion may be formed to have width corresponding to width of the clamping portion and may be formed to have width smaller than width of the first terminal main body portion.

By the present invention, the tip bent portion that does not protrude in the width direction from the first terminal main body portion can be formed.

According to the present invention, there is provided a jump-start terminal provided in a manner protruding from a base portion of a base body in an electrical connection box and clamped by a clamping portion in a clamp of a booster cable, the jump-start terminal including a metal plate material connected to an electric circuit, in which a reinforcing portion that reinforces a protruding direction of the metal plate material is provided.

The jump-start terminal provided in a manner protruding from the base portion of the base body in the above-described electrical connection box includes an aspect of protruding from another portion inside the electrical connection box, an aspect of protruding by providing a recessed portion around the jump-start terminal without protruding from another portion, an aspect of protruding outside the electrical connection box, an aspect of protruding in the inside so as to be exposed to the outside without protruding outside the electrical connection box, and the like.

The reinforcing portion that reinforces the protruding direction of the metal plate material described above reinforces the metal plate material so as to improve rigidity and strength along the protruding direction of the metal plate material, that is, in the plate thickness direction.

By the present invention, the jump-start terminal of the present invention has high durability, and can be clamped by a clamp for stable conduction.

More specifically, the jump-start terminal provided in a manner protruding from the base portion of the base body in the electrical connection box and clamped by the clamping portion in the clamp of the booster cable is formed of the metal plate material connected to an electric circuit. For this reason, although durability is improved as compared with the jump-start terminal formed of a resin member and a metal plate material, strength in the plate thickness direction is reduced, and there is a possibility that a clamping state by the clamp becomes unstable. On the other hand, strength in the plate thickness direction of the metal plate material can be secured by the reinforcing portion that reinforces the protruding direction of the metal plate material. Therefore, even the jump-start terminal formed of the metal plate material not including a resin member has strength in the plate thickness direction, and a clamping state by the clamp is stabilized, so that conduction can be stably performed.

Further, since the metal plate material is clamped by the clamping portion, a contact area between the clamping portion and the metal plate material is increased and conductivity is improved as compared with a case where a holding portion made from resin integrally formed in a case main body and the metal plate material are clamped by the clamping portion. For this reason, it is possible to reduce an amount of heat generation of the jump-start terminal caused by being clamped by the clamping portion and application of large current.

As an aspect of the present invention, a direction orthogonal to a protruding direction in which the metal plate material protrudes on a main surface of the metal plate material may be defined as a width direction, and the reinforcing portion may be a bent reinforcing portion which is bent in a plate thickness direction along at least one of both end edges in the width direction of the metal plate material.

By the present invention, bending in the plate thickness direction along both end edges in the width direction of the metal plate material can improve strength in the plate thickness direction of the metal plate material and stabilize the clamping state by the clamp.

Further, as an aspect of the present invention, a locking portion that locks the clamping portion that performs clamping may be provided in the bent reinforcing portion.

By the present invention, the clamping portion can firmly clamp the bent reinforcing portion with required holding force.

More specifically, since the bent reinforcing portion is formed only in a part in the width direction of the clamping portion, a contact area between the bent reinforcing portion and the clamping portion is reduced, and a clamping state tends to be unstable. However, the clamping portion is locked to a locking portion provided in the bent reinforcing portion, so that the clamping portion can perform clamping in a stable clamping state.

Furthermore, since the clamped portion to be clamped by the clamping portion in the jump-start terminal can be clearly indicated by the locking portion, a worker can reliably clamp the clamped portion to be clamped by the clamping portion without making a mistake, and the clamp can be stably clamped to the jump-start terminal formed of the metal plate material.

Further, as an aspect of the present invention, a tip bent portion bent toward the side opposite to the bent reinforcing portion in the plate thickness direction may be provided at a tip of the metal plate material.

By the present invention, thickness of the clamped portion by the clamping portion can be further increased, clamping force of the clamping portion is increased, and the clamping portion can perform clamping in a more stable clamping state.

More specifically, since the clamping portion widely opens against biasing force of a spring and clamps the bent reinforcing portion and the tip bent portion bent to the side opposite to the bent reinforcing portion, clamping force of the clamping portion increases, and the clamp can perform clamping in a more stable clamping state.

Further, as an aspect of the present invention, the reinforcing portion may be a protruding direction bead formed along a protruding direction of the metal plate material.

By the present invention, strength in the plate thickness direction can be increased by the protruding direction bead along the protruding direction.

Note that the protruding direction bead formed along the protruding direction of the metal plate material may be formed in the entire range in the protruding direction of the metal plate material, or may be formed only in the clamped portion that is clamped by the clamping portion in the metal plate material.

The protruding direction bead may be formed by bending or extruding the metal plate material in the plate thickness direction, or may be formed by build-up on the metal plate material.

As an aspect of the present invention, another second metal plate material may be laminated on the metal plate material, and the laminated second metal plate material may be the reinforcing portion.

By the present invention, strength in the plate thickness direction can be improved by laminating the second metal plate material functioning as a reinforcing portion as compared with one of the metal plate material. Further, since the second metal plate material is laminated on the metal plate material, power can be stably supplied.

Further, as an aspect of the present invention, interlocking may be performed in the plate thickness direction from the metal plate material toward the second metal plate material that are laminated.

One or a plurality of the above-described interlocking portions may be provided. In a case where a plurality of the interlocking portions are provided, all the interlocking portions may interlock in the same direction, or some of the interlocking portions may interlock in a direction opposite to another one of the interlocking portions.

Further, the interlocking portion may be in an aspect in which the interlocking portion has a projecting shape on a main surface of the metal plate material on one side of the metal plate materials that are laminated and has a recessed shape on a main surface of the metal plate material on another side, or may be in an aspect in which the interlocking portion has a recessed shape on a main surface of the metal plate material on one side and has a projecting shape on a main surface of the metal plate material on another side. Note that the recessed shape includes not only a recess but also an opening and a notch.

By the present invention, since the metal plate material and the second metal plate material that are laminated are integrated by the interlocking portion, the jump-start terminal having high rigidity with increased plate thickness can be formed as compared with a case where the jump-start terminal is formed of one of the metal plate material.

Further, by clamping the interlocking portion with the clamping portion, the clamping portion is locked to the interlocking portion, and a stable clamping state can be obtained.

As an aspect of the present invention, the second metal plate material may be a metal thick plate material having plate thickness larger than that of the metal plate material.

By the present invention, the jump-start terminal having higher rigidity than a case where the second metal plate material having the same thickness as the metal plate material is laminated can be formed.

Further, since a metal thick plate material having plate thickness larger than that of a metal plate material has high conductivity, stable power supply can be performed, plate thickness of the metal thick plate material can be adjusted according to current that is conducted, and an amount of heat generated in the metal thick plate material can be adjusted.

Further, as an aspect of the present invention, in the metal thick plate material, on a base end side in a protruding direction in which the metal plate material protrudes, a fastening hole into which a fixing bolt for fixing a power supply input terminal connected to an electric circuit is fastened may be provided.

By the present invention, the metal thick plate material laminated with the reference plate material can function as a nut for screwing and connecting a fixing bolt for fixing a power supply input terminal connected to the electric circuit such as an automobile round plate terminal (LA terminal), and the power supply input terminal can be stably connected to the jump-start terminal.

Further, according to the present invention, there is provided a jump-start terminal provided in a manner protruding from a base portion of a base body in an electrical connection box and clamped by a clamping portion in a clamp of a booster cable, the jump-start terminal including two metal plate materials connected to an electric circuit and laminated in a plate thickness direction, in which one of two of the metal plate materials reinforces a protruding direction of another one of the metal plate materials.

By the present invention, the jump-start terminal of the present invention has high durability, and can be clamped by a clamp for stable conduction.

More specifically, in the jump-start terminal provided in a manner protruding from the base portion of the base body in the electrical connection box and clamped by the clamping portion in the clamp of the booster cable, one of two of the metal plate materials connected to an electric circuit and laminated in the plate thickness direction reinforces the protruding direction of the other, so that strength in the plate thickness direction can be secured. Therefore, even the jump-start terminal formed of the metal plate material not including a resin member has strength in the plate thickness direction, and a clamping state by the clamp is stabilized, so that conduction can be stably performed.

Further, since the metal plate material is clamped by the clamping portion, a contact area between the clamping portion and the metal plate material is increased and conductivity is improved as compared with a case where a holding portion made from resin integrally formed in a case main body and the metal plate material are clamped by the clamping portion. For this reason, it is possible to reduce an amount of heat generation of the jump-start terminal caused by being clamped by the clamping portion and application of large current.

Further, as an aspect of the present invention, one of two of the metal plate materials may be set to a first metal plate material, another one of the metal plate materials may be set to a second metal plate material, and the first metal plate material may include a first mounting base portion on a mounting base side and a first terminal main body portion having small width protruding in the protruding direction from the first mounting base portion, the second metal plate material may be formed in a substantially band shape with a second terminal main body portion having same width as the first terminal main body portion of the first metal plate material and a second mounting base portion having same width as the second terminal main body portion, and a tip bent portion which is bent toward a side opposite to the second metal plate material may be provided at a tip of the first metal plate material.

By the present invention, since the first metal plate material formed of the first mounting base portion having large width and the first terminal main body portion having small width and the second metal plate material formed in a band shape with the second terminal main body portion and the second mounting base portion having the same width are laminated, the first terminal main body portion and the second terminal main body portion having the same width are laminated, and one of the first terminal main body portion and the second terminal main body portion reinforces the protruding direction of the other, and strength in the plate thickness direction can be secured.

Further, as an aspect of the present invention, the tip bent portion may be formed to have width corresponding to width of the clamping portion and may be formed to have width smaller than width of the first terminal main body portion.

By the present invention, the tip bent portion that does not protrude in the width direction from the first terminal main body portion can be formed.

### Advantageous Effects of Invention

According to the present invention, it is possible to provide a jump-start terminal which can be clamped by a clamp for stable conduction and has high durability.

### BRIEF DESCRIPTION OF DRAWINGS

FIG. 1 is a perspective view of an electrical connection box in an open state.

FIG. 2 is an explanatory view of the electrical connection box in an open state.

FIG. 3 is an explanatory view of a jump-start terminal.

FIG. 4 is an exploded explanatory view of the jump-start terminal.

FIG. 5 is an explanatory view of the jump-start terminal in a clamped state.

FIG. 6 is an explanatory view of the jump-start terminal according to a second embodiment.

FIG. 7 is an explanatory view of the jump-start terminal in a clamped state according to the second embodiment.

FIG. 8 is an explanatory view of the jump-start terminal according to a third embodiment.

FIG. 9 is an explanatory view of the jump-start terminal in a clamped state according to the third embodiment.

FIG. 10 is an explanatory view of the jump-start terminal according to a fourth embodiment.

FIG. 11 is an explanatory view of the jump-start terminal in a clamped state according to the fourth embodiment.

FIG. 12 is an explanatory view of the jump-start terminal according to a fifth embodiment.

FIG. 13 is an explanatory view of the jump-start terminal in a clamped state according to the fifth embodiment.

FIG. 14 is an explanatory view of the jump-start terminal according to a sixth embodiment.

FIG. 15 is an explanatory view of the jump-start terminal in a clamped state according to the sixth embodiment.

FIG. 16 is an explanatory view of the jump-start terminal according to a seventh embodiment.

FIG. 17 is an explanatory view of the jump-start terminal in a clamped state according to the seventh embodiment.

FIG. 18 is an explanatory view of the jump-start terminal according to an eighth embodiment.

FIG. 19 is an explanatory view of the jump-start terminal in a clamped state according to the eighth embodiment.

FIG. 20 is an explanatory view of the jump-start terminal according to a ninth embodiment.

FIG. 21 is an explanatory view of the jump-start terminal in a clamped state according to the ninth embodiment.

FIG. 22 is an explanatory view of the jump-start terminal according to a tenth embodiment.

FIG. 23 is an explanatory view of the jump-start terminal in a clamped state according to the tenth embodiment.

FIG. 24 is an explanatory view of the jump-start terminal according to an eleventh embodiment.

FIG. 25 is an explanatory view of the jump-start terminal in a clamped state according to the eleventh embodiment.

FIG. 26 is an explanatory view of the jump-start terminal according to a twelfth embodiment.

FIG. 27 is an explanatory view of the jump-start terminal in a clamped state according to the twelfth embodiment.

FIG. 28 is an explanatory view of the jump-start terminal according to a thirteenth embodiment.

FIG. 29 is an explanatory view of the jump-start terminal in a clamped state according to the thirteenth embodiment.

FIG. 30 is an explanatory view of the jump-start terminal according to a fourteenth embodiment.

FIG. 31 is an exploded explanatory view of the jump-start terminal according to the fourteenth embodiment.

FIG. 32 is an explanatory view of the jump-start terminal in a clamped state according to the fourteenth embodiment.

### DESCRIPTION OF EMBODIMENTS

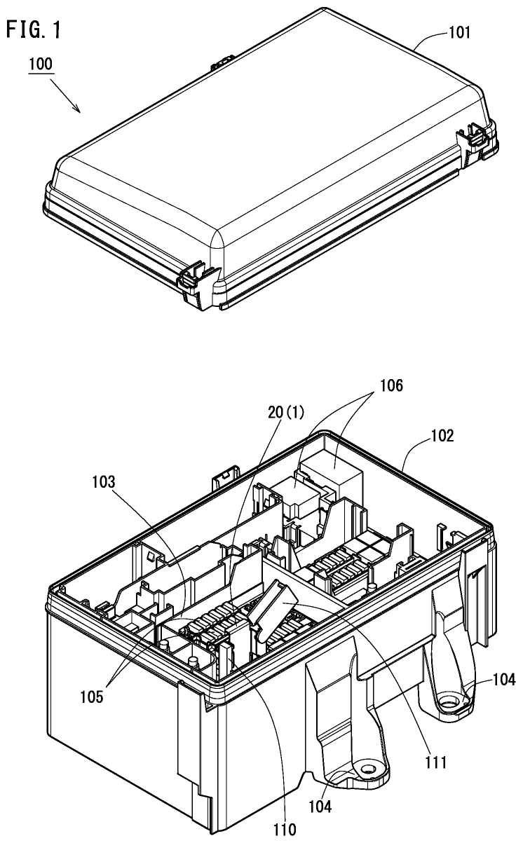

An embodiment of the present invention will be described in detail below with reference to FIGS. 1 to 5.

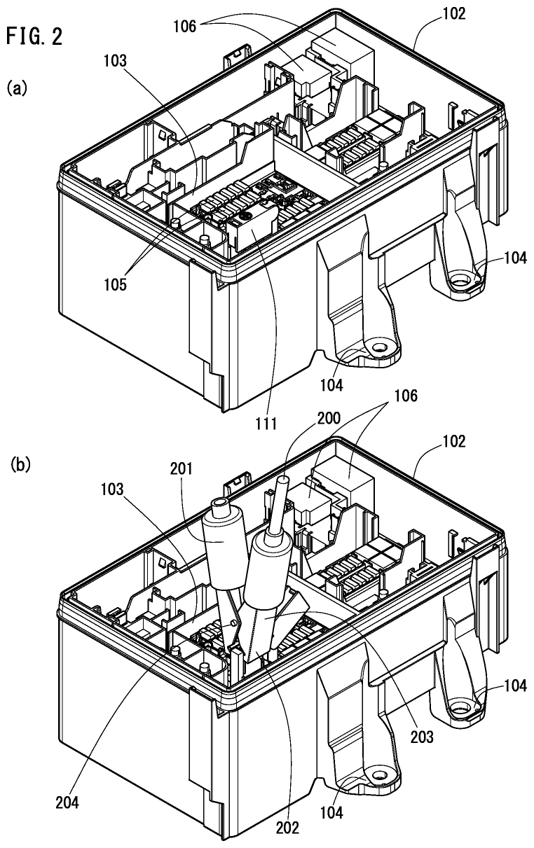

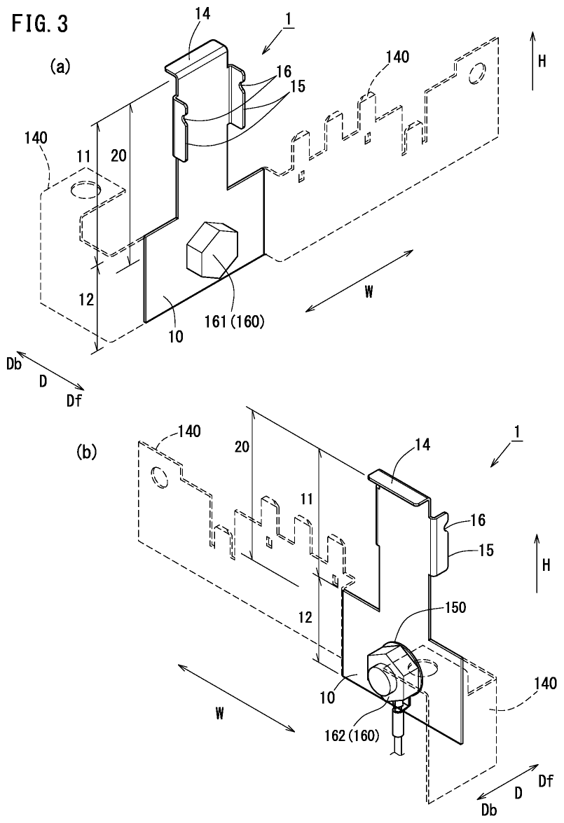

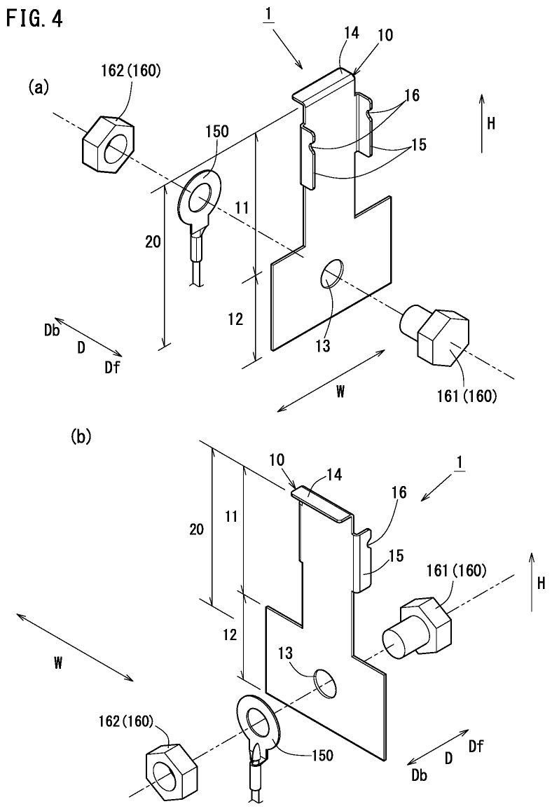

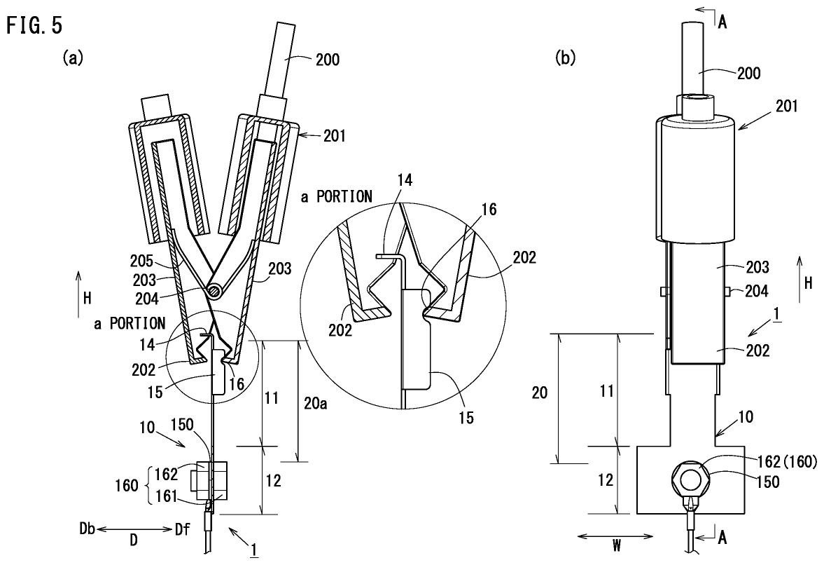

Note that FIG. 1 illustrates a perspective view of an electrical connection box 100 in an open state, FIG. 2 illustrates an explanatory view of the electrical connection box 100 in an open state, FIG. 3 illustrates an explanatory view of a jump-start terminal 1, FIG. 4 illustrates an exploded explanatory view of the jump-start terminal 1, and FIG. 5 illustrates an explanatory view of the jump-start terminal 1 in a clamped state.

More specifically, FIG. 1 is a perspective view of the electrical connection box 100 in a state where a cover 101 is opened, and FIG. 2 is an explanatory view of the electrical connection box 100 in an open state. Specifically, FIG. 2(a) illustrates a perspective view of a state where a terminal cover 111 is closed, and FIG. 2(b) illustrates a perspective view of a state where a clamp 201 is attached to the jump-start terminal 1. Note that in FIG. 2, the illustration of the cover 101 is omitted.

Further, FIG. 3(a) is a diagram illustrating a front view, a left side view, and a plan view of the jump-start terminal 1, and FIG. 3(b) is a diagram illustrating a rear view, a left side view, and a plan view of the jump-start terminal 1.

Note that in FIG. 3, a power supply branch portion 140 integrally molded with the jump-start terminal 1 is indicated by a broken line. Further, the illustration of the power supply branch portion 140 is omitted in the following drawings in the present description.

FIG. 4(a) is a diagram illustrating a front view, a left side view, and a plan view of the jump-start terminal 1 in a state where a power supply input terminal 150, a fixing bolt 161, and a nut 162 are disassembled, and FIG. 4(b) is a diagram illustrating a rear view, a left side view, and a plan view of the jump-start terminal 1 in the same state. FIG. 5(a) is a cross-sectional view taken along A-A of FIG. 5(b) of the jump-start terminal 1 in a state of being clamped with a clamping portion 202, and FIG. 5(b) is a front view of the jump-start terminal 1 in the same state.

Note that in FIG. 3, a direction in which a metal plate material 10 constituting the jump-start terminal 1 protrudes from a base portion 103 of a base body 102 of the electrical connection box 100 is defined as a protruding direction H, a width direction of the metal plate material 10 is defined as a width direction W, and a thickness direction of the metal plate material 10 is defined as a plate thickness direction D. Note that the protruding direction H is a direction substantially coinciding with a vertical direction of the electrical connection box 100. Further, in the plate thickness direction D, the front side is defined as a front surface side Df, and the back side is defined as a back surface side Db.

The jump-start terminal 1 is provided in a manner protruding from the base portion 103 of the base body 102 in the electrical connection box 100 arranged at a place accessible from the outside such as an engine room, and is clamped by the clamping portion 202 in the clamp 201 of a booster cable 200.

Further, the jump-start terminal 1 is formed of the metal plate material 10 to which the power supply input terminal 150 such as an automobile round plate terminal (LA terminal) connected to an electric circuit is connected, and a side bent piece 15 functioning as a locking portion for locking the clamping portion 202 that performs clamping is provided in a manner protruding from a main surface of the metal plate material 10.

Hereinafter, the jump-start terminal 1 and the electrical connection box 100 will be described in detail.

The jump-start terminal 1 is a terminal for power supply by being clamped by the clamp 201 provided at a tip of the booster cable 200 when a battery is over-discharged and the battery is dead, and is provided in the electrical connection box 100.

Note that, as illustrated in FIG. 5(a), the clamp 201 provided at a tip of the booster cable 200 is configured such that two clamping pieces 203 are pivotably connected by a pivot fulcrum 204, and a biasing force in a closing direction acts on the clamping portion 202 on the tip side of the clamping piece 203 by a coil spring 205 provided inside. Note that the clamping piece 203 is formed to have a rectangular U-shaped cross section with the inside opened, and the clamping portion 202 at the tip of the clamping piece 203 is pointed inward and has, for example, a saw tooth shape.

The electrical connection box 100 is a box body which is arranged in an engine room which can be easily operated by the user or a mechanic and includes the base body 102 whose upper surface is opened and the cover 101 which closes an opening of the base body 102, and a harness (not illustrated) is connected to the electrical connection box 100. Note that the electrical connection box 100 is fixed to a vehicle body by a fixing portion 104 provided on the side of the base body 102.

Inside the base body 102, the base portion 103 to which various electronic components such as a fuse 105 and a relay 106 are mounted is provided, and the jump-start terminal 1 is provided in the base portion 103.

Specifically, the jump-start terminal 1 is arranged along a terminal holder 110 with which a terminal cover 111 described later is engaged so as to protrude to the opened upper side of the base body 102. Note that a direction of the jump-start terminal 1 protruding upward is defined as the protruding direction H.

The terminal holder 110 is provided with the terminal cover 111 that is openable and closable, and as illustrated in FIG. 2(a), the terminal cover 111 is engaged with the terminal holder 110 and closed in a normal state. In a state where the terminal cover 111 is closed as described above, the jump-start terminal 1 held by the terminal holder 110 is configured not to be exposed.

Note that, as will be described later, in a state where the terminal cover 111 is opened, in the jump-start terminal 1 held by the terminal holder 110, a clamped portion 20 clamped by the clamping portion 202 at a tip of the clamp 201 is exposed.

In order to receive power when a battery is dead by using the jump-start terminal 1 configured to protrude in the base portion 103 of the electrical connection box 100 configured as described above, as illustrated in FIG. 1, the cover 101 is removed and the terminal cover 111 is opened to expose the jump-start terminal 1 held by the terminal holder 110.

Then, as illustrated in FIG. 2(b), the clamped portion 20 of the jump-start terminal 1 is clamped by the clamping portion 202 of the clamp 201 provided at a tip of the booster cable 200. By this, electrical connection to a battery and a jump-start terminal clamped by the clamping portions 202 provided at both ends of the booster cable 200 is established, and it is possible to supply power to the battery connected via the power supply input terminal 150 and to supply power from the battery to another vehicle.

The jump-start terminal 1 held by the terminal holder 110 in this manner will be described with reference to FIGS. 3 to 5.

The jump-start terminal 1 is formed of, for example, the metal plate material 10 having appropriate thickness formed in a substantially inverted T shape in a front view. In the present embodiment, the metal plate material 10 is a plate material made from a copper alloy having thickness of about 1 mm. Note that the metal plate material 10 may have a substantially L shape in front view, or may be formed in a substantially inverted T shape in front view by overlapping the metal plate material 10 having a substantially L shape and the metal plate material 10 having a substantially inverted L shape.

More specifically, the metal plate material 10 is formed in a substantially inverted T shape by a terminal main body portion 11 extending in the protruding direction H and a mounting base portion 12 extending in the width direction W on the base end side of the terminal main body portion 11.

Although not illustrated, the power supply branch portion 140 is integrally molded with a broken line in FIG. 3 at a tip of the mounting base portion 12, but the power supply branch portion 140 does not need to be provided.

Then, the terminal main body portion 11 is formed to have length in the width direction W corresponding to width of the clamping portion 202 of the clamp 201 and has a band shape long in the protruding direction H, and the power supply input terminal 150 is attached to the vicinity of the center in the protruding direction H of the mounting base portion 12 by a fastening body 160.

Specifically, as illustrated in FIG. 4, a bolt hole 13 is provided in the vicinity of the center in the protruding direction H of the mounting base portion 12. The fastening body 160 for attaching the power supply input terminal 150 connected to a battery (not illustrated) to the bolt hole 13 of the mounting base portion 12 includes a fixing bolt 161 passing through the bolt hole 13 and a nut 162 screwed with the fixing bolt 161.

Note that the power supply input terminal 150 and the fastening body 160 may be arranged at appropriate positions in both the protruding direction H and the width direction W without limitation to the vicinity of the center in the protruding direction H of the mounting base portion 12.

In order to attach the power supply input terminal 150 to the jump-start terminal 1 by using the fastening body 160 configured as described above, the power supply input terminal 150 is arranged with respect to the bolt hole 13, a shaft portion of the fixing bolt 161 is inserted into the bolt hole 13 and the power supply input terminal 150, and the nut 162 and the fixing bolt 161 are screwed on the opposite side, so that the power supply input terminal 150 can be attached and fixed to the jump-start terminal 1.

As described above, a tip bent portion 14 bent toward the back surface side Db is provided at a tip in the protruding direction H of the terminal main body portion 11 to which the power supply input terminal 150 is attached at a base end portion.

Further, on both sides in the width direction W of the terminal main body portion 11, the side bent pieces 15 bent toward the front surface side Df are provided, and locking recessed portions 16 in the side bent pieces 15 are provided.

Specifically, in the terminal main body portion 11, a portion between the mounting base portion 12 and the tip bent portion 14 in the protruding direction H, more specifically, a portion having length of about ⅓ to ½ of the tip side of the terminal main body portion 11 is bent toward the front surface side Df to form the side bent piece 15.

Then, the side bent piece 15 extending in the protruding direction H along both sides in the width direction W of the terminal main body portion 11 is a flat surface along the protruding direction H and the plate thickness direction D, and the locking recessed portion 16 is provided at height of about ⅓ in the protruding direction H on the front surface side Df of the side bent piece 15.

Note that length of the tip bent portion 14 protruding toward the back surface side Db with respect to the terminal main body portion 11 is substantially the same as length of the side bent piece 15 protruding toward the front surface side Df, is about five times the thickness of the metal plate material 10 forming the jump-start terminal 1, and is formed to have predetermined thickness of about 5 mm.

Further, the locking recessed portion 16 that has a recessed shape from an end edge toward the terminal main body portion 11 on the front surface side Df of the side bent piece 15 has a recessed shape formed at depth of about ¼ with respect to length in the plate thickness direction D of the side bent piece 15.

A side in the protruding direction H of the terminal main body portion 11 of the jump-start terminal 1 configured as described above is defined as the clamped portion 20 clamped by the clamping portion 202 of the clamp 201.

Therefore, the clamped portion 20 includes a part of the terminal main body portion 11, the tip bent portion 14 protruding further to the back surface side Db than the terminal main body portion 11, and the side bent piece 15 protruding to the front surface side Df from the terminal main body portion 11.

As illustrated in FIG. 1, the jump-start terminal 1 configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20 penetrates the base portion 103 and protrudes in the protruding direction H from the base portion 103.

Then, as described above, when the terminal cover 111 is opened, the clamped portion 20 of the terminal main body portion 11 is exposed as illustrated in FIG. 1, and the jump-start terminal 1 arranged along the terminal holder 110 can be clamped by the clamping portion 202 of the clamp 201. At this time, as illustrated in FIG. 5(a), the clamping portion 202 sandwiches the tip bent portion 14 and the side bent piece 15, and clamps them in a manner biting into the locking recessed portion 16.

As described above, the jump-start terminal 1 provided in a manner protruding from the base portion 103 of the base body 102 in the electrical connection box 100 and clamped by the clamping portion 202 of the clamp 201 of the booster cable 200 is formed of the metal plate material 10 connected to an electric circuit via the power supply input terminal 150, and the locking recessed portion 16 of the side bent piece 15 for locking the clamping portion 202 that performs clamping is provided so as to protrude with respect to a main surface of the metal plate material 10. For this reason, the jump-start terminal 1 has high durability, and can achieve a main effect of enabling stable conduction by being clamped by the clamp 201.

More specifically, since the jump-start terminal 1 provided in a manner protruding from the base portion 103 of the base body 102 in the electrical connection box 100 and clamped by the clamping portion 202 in the clamp 201 of the booster cable 200 is formed of the metal plate material 10 connected to the electric circuit, it is possible to improve durability such as heat resistance against heat generated by conduction or the like and weather resistance as compared with a jump-start terminal partially formed of a resin member.

Further, in the jump-start terminal 1 formed of the metal plate material 10, since the locking recessed portion 16 of the side bent piece 15 that locks the clamping portion 202 that performs clamping is provided in a manner protruding with respect to a main surface of the metal plate material 10, a clamping state of the clamp 201 can be stabilized with respect to the metal plate material 10. For this reason, it is possible to stably perform conduction via the jump-start terminal 1 clamped by the clamp 201.

Furthermore, since the clamped portion 20 to be clamped by the clamping portion 202 in the jump-start terminal 1 can be clearly indicated by the locking recessed portion 16, a worker can reliably clamp the clamped portion 20 to be clamped by the clamping portion 202 without making a mistake, and the clamp 201 can be stably clamped to the metal plate material 10.

Further, since the metal plate material 10 is clamped by the clamping portion 202, a contact area between the clamping portion 202 and the metal plate material 10 is increased and conductivity is improved as compared with a case where a holding portion made from resin integrally formed on the base body 102 and the metal plate material 10 are clamped by the clamping portion 202. For this reason, it is possible to reduce an amount of heat generation of the jump-start terminal 1 caused by being clamped by the clamping portion 202 and application of large current.

Further, the clamping portion 202 that clamps the metal plate material 10 is closed by a spring in a normal state, and the clamping portion 202 is opened against biasing force of the coil spring 205 to clamp the metal plate material 10. Therefore, clamping force for clamping the metal plate material 10 is biasing force of the coil spring 205 of the clamp 201, where biasing force of the coil spring 205 is larger when the clamping portion 202 is opened, and clamping force for clamping the metal plate material 10 is also larger. For this reason, by setting thickness of the clamped portion 20 clamped by the clamping portion 202 to predetermined thickness, durability can be improved as compared with a case where a bus bar holding portion made from resin is included, and the clamping portion 202 can clamp the clamped portion 20 of the metal plate material 10 with required clamping force. Therefore, it is possible to stably perform conduction by clamping with the clamp 201.

Note that the required clamping force is force capable of maintaining a clamping state in which electrical conduction can be performed stably without the clamping portion 202 coming off even when unintended force such as unintentional contact is applied by a worker in a state where the clamped portion 20 is clamped by the clamping portion 202.

In the present description, the required clamping force required for clamping and supplying power by the clamping portion 202 of the clamp 201 when a battery of a hybrid vehicle is dead is about 0.5 kgf or more, and more preferably about 1.0 kgf or more. Further, predetermined thickness of the clamped portion 20 required to be clamped with the required clamping force is about 5 mm or more, and more preferably, the predetermined thickness is about 5 mm or more and 20 mm or less. Note that, in a case where the predetermined thickness is smaller than about 5 mm, it is difficult to secure 0.5 kgf or more, which is the required clamping force described above, and when the predetermined thickness is larger than 20 mm, 1.0 kgf or more, which is the more preferable required clamping force described above, can be secured, but there is a possibility that operability of the clamp 201 for clamping the jump-start terminal 1 by the clamping portion 202 deteriorates.

Furthermore, since the jump-start terminal 1 is formed of the metal plate material 10 connected to an electric circuit, durability is improved as compared with a jump-start terminal formed of a resin member and a metal plate material, but strength in the plate thickness direction D decreases, and there is a possibility that a clamping state by the clamp 201 becomes unstable. On the other hand, strength in the plate thickness direction D of the metal plate material 10 can be secured by the side bent pieces 15 reinforcing the protruding direction H of the metal plate material 10. Therefore, even the jump-start terminal 1 formed of the metal plate material 10 not including a resin member has strength in the plate thickness direction D, and a clamping state by the clamp 201 is stabilized, so that conduction can be stably performed.

Further, since the locking recessed portions 16 are provided at positions corresponding to both end portions in the width direction W in the clamping portion 202 formed to have a rectangular U-shaped cross section, the locking recessed portion 16 can be reliably clamped by the clamping portion 202. Further, since the locking recessed portions 16 are provided at positions corresponding to both end portions in the width direction W of the clamping portion 202 in the metal plate material 10, machining can be performed efficiently and easily as compared with a case where a locking recessed portion is provided in the entire width direction W.

Further, since the locking recessed portion 16 has a recessed shape with respect to an end edge on the front surface side Df of the side bent piece 15 protruding from a main surface to the front surface side Df, a tip of the clamping portion 202 bites into and is locked with respect to the locking recessed portion 16 having a recessed shape, so that a clamping state by the clamping portion 202 with respect to the metal plate material 10 is not unintentionally released, and a stable clamping state can be achieved.

Further, on a main surface of the metal plate material 10, a direction orthogonal to the protruding direction H in which the metal plate material 10 protrudes is defined as the width direction W, and the clamped portion 20 has the side bent pieces 15 bent in the plate thickness direction D along both end edges in the width direction W of the metal plate material 10. For this reason, even in a case where the metal plate material 10 is thinner than predetermined thickness, it can be bent in the plate thickness direction D along both end edges in the width direction W of the metal plate material 10 to form the side bent pieces 15 in which apparent thickness of the metal plate material 10 is predetermined thickness. Therefore, weight can be reduced as compared with the metal plate material 10 formed to have predetermined thickness as a whole.

Further, since the tip bent portion 14 bent to the side opposite to the side bent piece 15 in the plate thickness direction D is provided at a tip of the metal plate material 10, apparent thickness of the clamped portion 20 clamped by the clamping portion 202 further increases, so that clamping force of the clamping portion 202 increases, and clamping can be performed in a more stable clamping state.

More specifically, the clamping portion 202 widely opens against biasing force of the coil spring 205 to clamp the side bent piece 15 and the tip bent portion 14 bent to the side opposite to the side bent piece 15, so that clamping force of the clamping portion 202 increases and the clamp 201 can perform clamping in a more stable clamping state.

Further, on a main surface of the metal plate material 10, a direction orthogonal to the protruding direction H in which the metal plate material 10 protrudes is defined as the width direction W, and the side bent pieces 15 are bent in the plate thickness direction D along both end edges in the width direction W of the metal plate material 10. Therefore, strength in the plate thickness direction D of the metal plate material 10 can be improved, and a clamping state by the clamp 201 can be stabilized.

As described above, the jump-start terminal 1 provided in a manner protruding from the base portion 103 of the base body 102 in the electrical connection box 100 and clamped by the clamping portion 202 in the clamp 201 of the booster cable 200 is formed of the metal plate material 10 connected to an electric circuit and has the clamped portion 20 on the tip side clamped by the clamping portion 202, and at least the clamped portion 20 has predetermined thickness clamped by the clamping portion 202 with required clamping force, that is, has thickness clamped by the clamping portion 202 by application of clamping force that stabilizes a clamping state by the clamping portion 202. For this reason, the jump-start terminal 1 has high durability, and can achieve a main effect of enabling stable conduction by being clamped by the clamp 201.

More specifically, the clamping portion 202 that clamps the metal plate material 10 is closed by the coil spring 205 in a normal state, and the clamping portion 202 is opened against biasing force of the coil spring 205 to clamp the metal plate material 10. Therefore, clamping force for clamping the metal plate material 10 is biasing force of the coil spring 205 of the clamp 201, where biasing force of the coil spring 205 is larger when the clamping portion 202 is opened, and clamping force for clamping the metal plate material 10 is also larger. For this reason, by setting thickness of the clamped portion 20 clamped by the clamping portion 202 to predetermined thickness, durability can be improved as compared with a case where a bus bar holding portion made from resin is included, and the clamping portion 202 can clamp the clamped portion 20 of the metal plate material 10 with required clamping force. Therefore, it is possible to stably perform conduction by clamping with the clamp 201.

In the present description, the required clamping force required for clamping and supplying power by the clamping portion 202 of the clamp 201 when a battery of a hybrid vehicle is dead is about 0.5 kgf or more, and more preferably about 1.0 kgf or more. Further, predetermined thickness of the clamped portion 20 required to be clamped with the required clamping force is about 5 mm or more, and more preferably, the predetermined thickness is about 5 mm or more and 20 mm or less. Note that, in a case where the predetermined thickness is smaller than about 5 mm, it is difficult to secure 0.5 kgf or more, which is the required clamping force described above, and when the predetermined thickness is larger than 20 mm, 1.0 kgf or more, which is the more preferable required clamping force described above, can be secured, but there is a possibility that operability of the clamp 201 for clamping the jump-start terminal 1 by the clamping portion 202 deteriorates.

Further, since the metal plate material 10 is clamped by the clamping portion 202, a contact area between the clamping portion 202 and the metal plate material 10 is increased and conductivity is improved as compared with a case where a holding portion made from resin integrally formed on the base body 102 and the metal plate material 10 are clamped by the clamping portion 202. For this reason, it is possible to reduce an amount of heat generation of the jump-start terminal 1 caused by being clamped by the clamping portion 202 and application of large current.

Further, in the jump-start terminal 1 formed of the metal plate material 10, since the locking recessed portion 16 of the side bent piece 15 that locks the clamping portion 202 that performs clamping is provided in a manner protruding with respect to a main surface of the metal plate material 10, a clamping state of the clamp 201 can be stabilized with respect to the metal plate material 10. For this reason, it is possible to stably perform conduction via the jump-start terminal 1 clamped by the clamp 201.

Furthermore, since the clamped portion 20 to be clamped by the clamping portion 202 in the jump-start terminal 1 can be clearly indicated by the locking recessed portion 16, a worker can reliably clamp the clamped portion 20 to be clamped by the clamping portion 202 without making a mistake, and the clamp 201 can be stably clamped to the metal plate material 10.

Furthermore, since the jump-start terminal 1 is formed of the metal plate material 10 connected to an electric circuit, durability is improved as compared with the jump-start terminal 1 formed of a resin member and a metal plate material, but strength in the plate thickness direction D decreases, and there is a possibility that a clamping state by the clamp 201 becomes unstable. On the other hand, strength in the plate thickness direction D of the metal plate material 10 can be secured by the side bent pieces 15 reinforcing the protruding direction H of the metal plate material 10. Therefore, even the jump-start terminal 1 formed of the metal plate material 10 not including a resin member has strength in the plate thickness direction D, and a clamping state by the clamp 201 is stabilized, so that conduction can be stably performed.

Further, on a main surface of the metal plate material 10, a direction orthogonal to the protruding direction H in which the metal plate material 10 protrudes is defined as the width direction W, and the clamped portion 20 has the side bent pieces 15 bent in the plate thickness direction D along both end edges in the width direction W of the metal plate material 10. For this reason, even in a case where the metal plate material 10 is thinner than predetermined thickness, it can be bent in the plate thickness direction D along both end edges in the width direction W of the metal plate material 10 to form the side bent pieces 15 in which apparent thickness of the metal plate material 10 is predetermined thickness. Therefore, weight can be reduced as compared with the metal plate material 10 formed to have predetermined thickness as a whole.

Further, since the locking recessed portion 16 for locking the clamping portion 202 that performs clamping is provided in the side bent piece 15, the clamping portion 202 can be stably clamped with required clamping force.

More specifically, since the side bent piece 15 is formed only in a part in the width direction W of the clamping portion 202, a contact area between the side bent piece 15 and the clamping portion 202 is reduced, and a clamping state tends to be unstable. However, by locking the clamping portion 202 to the locking recessed portion 16 provided in the side bent piece 15, clamping can be performed in a stable clamping state.

Further, since the tip bent portion 14 bent to the side opposite to the side bent piece 15 in the plate thickness direction D is provided at a tip of the metal plate material 10, apparent thickness of the clamped portion 20 clamped by the clamping portion 202 further increases, so that clamping force of the clamping portion 202 increases, and clamping can be performed in a more stable clamping state.

More specifically, the clamping portion 202 widely opens against biasing force of the coil spring 205 to clamp the side bent piece 15 and the tip bent portion 14 bent to the side opposite to the side bent piece 15, so that clamping force of the clamping portion 202 increases and the clamp 201 can perform clamping in a more stable clamping state.

Further, since the locking recessed portions 16 are provided at positions corresponding to both end portions in the width direction W in the clamping portion 202 formed to have a rectangular U-shaped cross section, the locking recessed portion 16 can be reliably clamped by the clamping portion 202. Further, since the locking recessed portions 16 are provided at positions corresponding to both end portions in the width direction W of the clamping portion 202 in the metal plate material 10, machining can be performed efficiently and easily as compared with a case where a locking recessed portion is provided in the entire width direction W.

Further, since the locking recessed portion 16 has a recessed shape with respect to an end edge on the front surface side Df of the side bent piece 15 protruding from a main surface to the front surface side Df, a tip of the clamping portion 202 bites into and is locked with respect to the locking recessed portion 16 having a recessed shape, so that a clamping state by the clamping portion 202 with respect to the metal plate material 10 is not unintentionally released, and a stable clamping state can be achieved.

As described above, the jump-start terminal 1 provided in a manner protruding from the base portion 103 of the base body 102 in the electrical connection box 100 and clamped by the clamping portion 202 of the clamp 201 of the booster cable 200 is formed of the metal plate material 10 connected to an electric circuit via the power supply input terminal 150, and the side bent piece 15 for reinforcing the protruding direction H of the metal plate material 10 is provided. For this reason, the jump-start terminal 1 has high durability, and can achieve a main effect of enabling stable conduction by being clamped by the clamp 201.

More specifically, the jump-start terminal 1 provided in a manner protruding from the base portion 103 of the base body 102 in the electrical connection box 100 and clamped by the clamping portion 202 in the clamp 201 of the booster cable 200 is formed of the metal plate material 10 connected to an electric circuit. For this reason, although durability is improved as compared with the jump-start terminal 1 formed of a resin member and a metal plate material, strength in the plate thickness direction D is reduced, and there is a possibility that a clamping state by the clamp 201 becomes unstable. On the other hand, strength in the plate thickness direction D of the metal plate material 10 can be secured by the side bent pieces 15 reinforcing the protruding direction H of the metal plate material 10. Therefore, even the jump-start terminal 1 formed of the metal plate material 10 not including a resin member has strength in the plate thickness direction D, and a clamping state by the clamp 201 is stabilized, so that conduction can be stably performed.

Further, since the metal plate material 10 is clamped by the clamping portion 202, a contact area between the clamping portion 202 and the metal plate material 10 is increased and conductivity is improved as compared with a case where a holding portion made from resin integrally formed on the base body 102 and the metal plate material 10 are clamped by the clamping portion 202. For this reason, it is possible to reduce an amount of heat generation of the jump-start terminal 1 caused by being clamped by the clamping portion 202 and application of large current.

Furthermore, in the jump-start terminal 1 formed of the metal plate material 10, since the locking recessed portion 16 of the side bent piece 15 that locks the clamping portion 202 that performs clamping is provided in a manner protruding with respect to a main surface of the metal plate material 10, a clamping state of the clamp 201 can be stabilized with respect to the metal plate material 10. For this reason, it is possible to stably perform conduction via the jump-start terminal 1 clamped by the clamp 201.

Furthermore, since the clamped portion 20 to be clamped by the clamping portion 202 in the jump-start terminal 1 can be clearly indicated by the locking recessed portion 16, a worker can reliably clamp the clamped portion 20 to be clamped by the clamping portion 202 without making a mistake, and the clamp 201 can be stably clamped to the metal plate material 10.

Further, the clamping portion 202 that clamps the metal plate material 10 is closed by the coil spring 205 in a normal state, and the clamping portion 202 is opened against biasing force of the coil spring 205 to clamp the metal plate material 10. Therefore, clamping force for clamping the metal plate material 10 is biasing force of the coil spring 205 of the clamp 201, where biasing force of the coil spring 205 is larger when the clamping portion 202 is opened, and clamping force for clamping the metal plate material 10 is also larger. For this reason, by setting thickness of the clamped portion 20 clamped by the clamping portion 202 to predetermined thickness, durability can be improved as compared with a case where a bus bar holding portion made from resin is included, and the clamping portion 202 can clamp the clamped portion 20 of the metal plate material 10 with required clamping force. Therefore, it is possible to stably perform conduction by clamping with the clamp 201.

Note that the required clamping force is force capable of maintaining a clamping state in which electrical conduction can be performed stably without the clamping portion 202 coming off even when unintended force such as unintentional contact is applied by a worker in a state where the clamped portion 20 is clamped by the clamping portion 202.

In the present description, the required clamping force required for clamping and supplying power by the clamping portion 202 of the clamp 201 when a battery of a hybrid vehicle is dead is about 0.5 kdf or more, and more preferably about 1.0 kdf or more. Further, predetermined thickness of the clamped portion 20 required to be clamped with the required clamping force is about 5 mm or more, and more preferably, the predetermined thickness is about 5 mm or more and 20 mm or less. Note that, in a case where the predetermined thickness is smaller than about 5 mm, it is difficult to secure 0.5 kdf or more, which is the required clamping force described above, and when the predetermined thickness is larger than 20 mm, 1.0 kdf or more, which is the more preferable required clamping force described above, can be secured, but there is a possibility that operability of the clamp 201 for clamping the jump-start terminal 1 by the clamping portion 202 deteriorates.

Further, on a main surface of the metal plate material 10, a direction orthogonal to the protruding direction H in which the metal plate material 10 protrudes is defined as the width direction W, and the side bent pieces 15 are bent in the plate thickness direction D along both end edges in the width direction W of the metal plate material 10. Therefore, strength in the plate thickness direction D of the metal plate material 10 can be improved, and a clamping state by the clamp 201 can be stabilized.

Further, since the locking recessed portion 16 for locking the clamping portion 202 that performs clamping is provided in the side bent piece 15, the clamping portion 202 can firmly clamp the side bent piece 15 with required clamping force.

More specifically, since the side bent piece 15 is formed only in a part in the width direction W of the clamping portion 202, a contact area between the side bent piece 15 and the clamping portion 202 is reduced, and a clamping state tends to be unstable. However, by locking the clamping portion 202 to the locking recessed portion 16 provided in the side bent piece 15, clamping can be performed in a stable clamping state.

Further, since the tip bent portion 14 bent to the back surface side Db which is the side opposite to the side bent piece 15 in the plate thickness direction D is provided at a tip of the metal plate material 10, apparent thickness of the clamped portion 20 clamped by the clamping portion 202 further increases, so that clamping force of the clamping portion 202 increases, and clamping can be performed in a more stable clamping state.

More specifically, the clamping portion 202 widely opens against biasing force of the coil spring 205 to clamp the side bent piece 15 and the tip bent portion 14 bent toward the back surface side Db which is the side opposite to the side bent piece 15, so that clamping force of the clamping portion 202 increases and the clamp 201 can perform clamping in a more stable clamping state.

Further, since the locking recessed portions 16 are provided at positions corresponding to both end portions in the width direction W in the clamping portion 202 formed to have a rectangular U-shaped cross section, the locking recessed portion 16 can be reliably clamped by the clamping portion 202. Further, since the locking recessed portions 16 are provided at positions corresponding to both end portions in the width direction W of the clamping portion 202 in the metal plate material 10, machining can be performed efficiently and easily as compared with a case where a locking recessed portion is provided in the entire width direction W.

Further, since the locking recessed portion 16 has a recessed shape with respect to an end edge on the front surface side Df of the side bent piece 15 protruding from a main surface to the front surface side Df, a tip of the clamping portion 202 bites into and is locked with respect to the locking recessed portion 16 having a recessed shape, so that a clamping state by the clamping portion 202 with respect to the metal plate material 10 is not unintentionally released, and a stable clamping state can be achieved.

Further, on a main surface of the metal plate material 10, a direction orthogonal to the protruding direction H in which the metal plate material 10 protrudes is defined as the width direction W, and the clamped portion 20 has the side bent pieces 15 bent in the plate thickness direction D along both end edges in the width direction W of the metal plate material 10. For this reason, even in a case where the metal plate material 10 is thinner than predetermined thickness, it can be bent in the plate thickness direction D along both end edges in the width direction W of the metal plate material 10 to form the side bent pieces 15 in which apparent thickness of the metal plate material 10 is predetermined thickness. Therefore, weight can be reduced as compared with the metal plate material 10 formed to have predetermined thickness as a whole.

### Second Embodiment

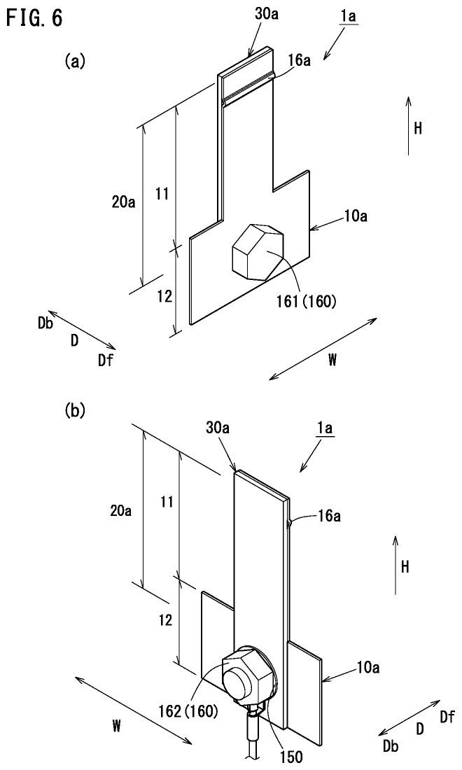

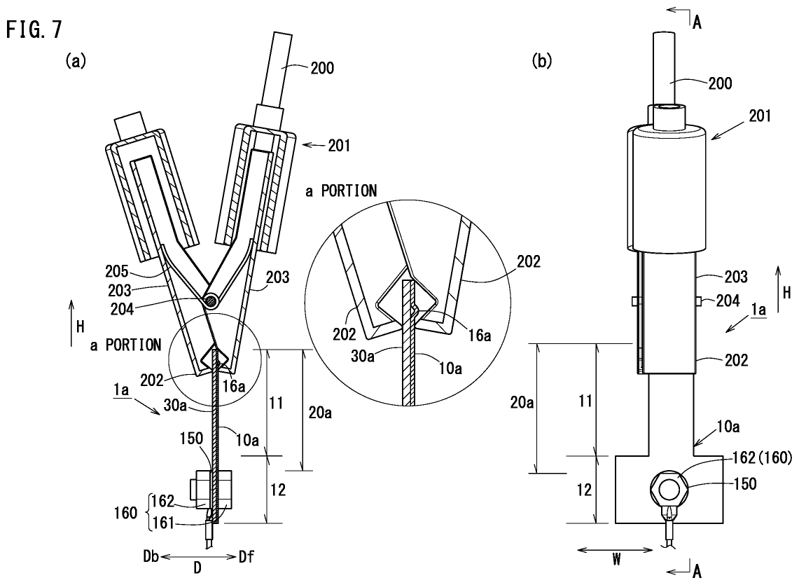

Subsequently, a jump-start terminal 1a of a second embodiment will be described in detail below with reference to FIGS. 6 and 7.

Note that in description below, configurations similar to those described above are denoted by the same reference numerals, and will be omitted from description.

Further, FIGS. 6 and 7 are explanatory views of the jump-start terminal 1a of the second embodiment. Specifically, FIG. 6(a) is a diagram illustrating a front view, a left side view, and a plan view of the jump-start terminal 1a, FIG. 6(b) is a diagram illustrating a rear view, a left side view, and a plan view of the jump-start terminal 1a, FIG. 7(a) is a cross-sectional view taken along A-A of FIG. 7(b) of the jump-start terminal 1a in a state of being clamped by the clamping portion 202, and FIG. 7(b) is a front view of the jump-start terminal 1a in the same state.

Unlike the jump-start terminal 1 described above, the jump-start terminal 1a of the second embodiment illustrated in FIGS. 6 and 7 is formed by laminating two metal plate materials.

Specifically, the jump-start terminal 1a is formed by laminating, in the plate thickness direction D, a metal plate material 10a formed in a substantially inverted T shape and formed of the terminal main body portion 11 and the mounting base portion 12 and a second metal plate material 30a formed separately.

The metal plate material 10a is a plate material made from a copper alloy having thickness of about 1 mm.

The second metal plate material 30a has a band shape formed to have the same width as the terminal main body portion 11 of the metal plate material 10a, and is formed to have the same length as length in the protruding direction H of the terminal main body portion 11 and the mounting base portion 12, and has a bolt hole (not illustrated) provided at a position corresponding to a bolt hole in the metal plate material 10a.

The second metal plate material 30a is formed of a metal thick plate material thicker than the metal plate material 10a. Specifically, in the present embodiment, while the metal plate material 10a is a plate material made from a copper alloy having thickness of about 1 mm, the second metal plate material 30a is a plate material made from a copper alloy having thickness of about 3 mm. By this, a clamped portion 20a of the jump-start terminal 1a including a bead 16a to be described later has predetermined thickness of about 5 mm.

Unlike the metal plate material 10 provided with the tip bent portion 14 and the side bent piece 15 having the locking recessed portion 16, the metal plate material 10a is not provided with the tip bent portion 14 or the side bent piece 15, but is provided with the bead 16a at the clamped portion 20a on the tip side in the protruding direction H of the terminal main body portion 11.

The bead 16a is formed so as to be extruded in a semicircular shape in the plate thickness direction D and extend in the width direction W in the clamped portion 20a on the tip side in the protruding direction H in the terminal main body portion 11 formed of the metal plate material 10a, and is a bead protruding to the front surface side Df with respect to a main surface of the terminal main body portion 11. Note that the bead 16a is formed with a protrusion amount of about two to four times the plate thickness of the metal plate material 10a.

The clamped portion 20a including the bead 16a provided on the metal plate material 10a laminated with the second metal plate material 30a is formed to have predetermined thickness including the bead 16a.

Similarly to the jump-start terminal 1 described above, the jump-start terminal 1a configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20a penetrates the base portion 103 and protrudes in the protruding direction H from the base portion 103.

Then, as described above, in the jump-start terminal 1a arranged along the terminal holder 110, the clamped portion 20a is exposed as the terminal cover 111 is opened, and the clamped portion 20a of the jump-start terminal 1a can be clamped by the clamping portion 202 of the clamp 201. At this time, as illustrated in FIG. 7(a), the clamping portion 202 clamps in a manner sandwiching the bead 16a.

As described above, since the jump-start terminal 1a is formed of the metal plate material 10a connected to an electric circuit, durability such as heat resistance against heat generated by conduction or the like and weather resistance can be improved as compared with a jump-start terminal partially formed of a resin member.

Further, in the jump-start terminal 1a formed of the metal plate material 10a, since the bead 16a that locks the clamping portion 202 that performs clamping is provided in a manner protruding from a main surface of the metal plate material 10a, a clamping state of the clamp 201 can be stabilized with respect to the metal plate material 10a. For this reason, it is possible to stably perform conduction via the jump-start terminal 1a clamped by the clamp 201.

Furthermore, since the clamped portion 20a to be clamped by the clamping portion 202 in the jump-start terminal 1a can be clearly indicated by the bead 16a, a worker can reliably clamp the clamped portion 20a to be clamped by the clamping portion 202 without making a mistake, and the clamp 201 can be stably clamped to the metal plate material 10a.

Further, by setting thickness of the clamped portion 20a clamped by the clamping portion 202 to predetermined thickness, durability can be improved as compared with a case where a bus bar holding portion made from resin is included, and the clamping portion 202 can clamp the clamped portion 20a of the metal plate material 10a with required clamping force. Therefore, it is possible to stably perform conduction by clamping with the clamp 201.

Furthermore, the jump-start terminal 1a can ensure strength in the plate thickness direction D of the metal plate material 10a by the second metal plate material 30a reinforcing the protruding direction H of the metal plate material 10a connected to an electric circuit. Therefore, even the jump-start terminal 1a formed of the metal plate material 10a not including a resin member has strength in the plate thickness direction D, and a clamping state by the clamp 201 is stabilized, so that conduction can be stably performed.

Further, since the bead 16a is formed to have width corresponding to width of the clamping portion 202, the clamping portion 202 can be reliably locked to the bead 16a formed to have width corresponding to width of the clamping portion 202, and a clamping state of the clamp 201 can be further stabilized.

Further, since the bead 16a has a projecting shape with respect to a main surface, the bead 16a having a projecting shape bites into and is locked to a tooth portion of the clamping portion 202, so that a clamping state by the clamping portion 202 with respect to the metal plate material 10a is not unintentionally released, and a stable clamping state can be obtained.

Further, since the metal plate materials 10a and 30a are laminated in the plate thickness direction D, and the bead 16a is provided on a main surface of the metal plate material 10a in a laminated state, it is possible to easily perform machining of providing the bead 16a on the metal plate material 10a to be laminated and form the bead 16a with high accuracy as compared with a case of providing a bead by machining a metal plate material having the same plate thickness as thickness of the metal plate materials 10a and 30a laminated.

Further, since the second metal plate material 30a is a metal plate material having plate thickness larger than that of the metal plate material 10a, the jump-start terminal 1a having higher rigidity than a case where the metal plate materials 10a having the same thickness are laminated can be formed.

Further, in a case where the bead 16a is formed on the metal plate material 10a, since machinability is higher than that of the second metal plate material 30a, the bead 16a with high accuracy can be formed by easy machining.

Furthermore, since the second metal plate material 30a having plate thickness larger than that of the metal plate material 10a has high conductivity, stable power supply can be performed, plate thickness of the second metal plate material 30a can be adjusted according to current that is conducted, and an amount of heat generated in the second metal plate material 30a can be adjusted.

Further, since another one of the second metal plate material 30a is laminated on at least the clamped portion 20a of the metal plate material 10a to form predetermined thickness including the bead 16a, the clamped portion 20a can be clamped by the clamp 201 and stable conduction can be performed.

More specifically, since the metal plate material 10a having the bead 16a and the second metal plate material 30a are laminated, thickness of the clamped portion 20a clamped by the clamping portion 202 can be set to predetermined thickness, and the clamping portion 202 can clamp the clamped portion 20a of the metal plate material 10a with required clamping force.

Further, since the second metal plate material 30a is a metal plate material having plate thickness larger than that of the metal plate material 10a, the jump-start terminal 1a having higher rigidity than a case where the metal plate materials 10a having the same thickness are laminated can be formed.

Further, since the second metal plate material 30a laminated on the metal plate material 10a is a metal thick plate material, the strength in the plate thickness direction D can be improved by laminating the second metal plate material 30a functioning as a reinforcing portion as compared with one sheet of the metal plate material 10a. Further, since the second metal plate material 30a is laminated on the metal plate material 10a, power can be stably supplied.

Note that the bead 16a may be provided on the second metal plate material 30a so as to protrude toward the back surface side Db, or the bead 16a may be provided on each of the metal plate material 10a and the second metal plate material 30a. Note that in a case where the bead 16a is provided on each of the metal plate material 10a and the second metal plate material 30a, the second metal plate material 30a may have the same thickness as the metal plate material 10a. In a case where the bead 16a is provided on each of the metal plate material 10a and the second metal plate material 30a, the bead 16a provided on the metal plate material 10a and the bead 16a provided on the second metal plate material 30a may be provided at the same position in the protruding direction H, or may be provided at different positions in the protruding direction H.

Further, the second metal plate material 30a may be arranged on the front surface side Df of the metal plate material 10a and laminated.

More specifically, by setting thickness of the clamped portion 20a clamped by the clamping portion 202 to predetermined thickness, durability can be improved as compared with a case where a bus bar holding portion made from resin is included, and the clamping portion 202 can clamp the clamped portion 20a of the metal plate material 10a with required clamping force. Therefore, it is possible to stably perform conduction by clamping with the clamp 201.

Further, in the jump-start terminal 1a formed of the metal plate material 10a, since the bead 16a that locks the clamping portion 202 that performs clamping is provided in a manner protruding from a main surface of the metal plate material 10a, a clamping state of the clamp 201 can be stabilized with respect to the metal plate material 10a. For this reason, it is possible to stably perform conduction via the jump-start terminal 1a clamped by the clamp 201.

Furthermore, since the clamped portion 20a to be clamped by the clamping portion 202 in the jump-start terminal 1a can be clearly indicated by the bead 16a, a worker can reliably clamp the clamped portion 20a to be clamped by the clamping portion 202 without making a mistake, and the clamp 201 can be stably clamped to the metal plate material 10a.

Further, the jump-start terminal 1a can ensure strength in the plate thickness direction D of the metal plate material 10a by the second metal plate material 30a reinforcing the protruding direction H of the metal plate material 10a connected to an electric circuit. Therefore, even the jump-start terminal 1a formed of the metal plate material 10a not including a resin member has strength in the plate thickness direction D, and a clamping state by the clamp 201 is stabilized, so that conduction can be stably performed.

Further, since another one of the second metal plate material 30a is laminated on at least the clamped portion 20a of the metal plate material 10a to form predetermined thickness including the bead 16a, the clamped portion 20a can be clamped by the clamp 201 and stable conduction can be performed.

More specifically, since the metal plate material 10a having the bead 16a and the second metal plate material 30a are laminated, thickness of the clamped portion 20a clamped by the clamping portion 202 can be set to predetermined thickness, and the clamping portion 202 can clamp the clamped portion 20a of the metal plate material 10a with required clamping force.

Further, since the second metal plate material 30a is a metal plate material having plate thickness larger than that of the metal plate material 10a, the jump-start terminal 1a having higher rigidity than a case where the metal plate materials 10a having the same thickness are laminated can be formed.

Further, since the second metal plate material 30a having plate thickness larger than that of the metal plate material 10a has high conductivity, stable power supply can be performed, plate thickness of the second metal plate material 30a can be adjusted according to current that is conducted, and an amount of heat generated in the second metal plate material 30a can be adjusted.

Further, since the bead 16a is formed to have width corresponding to width of the clamping portion 202, the clamping portion 202 can be reliably locked to the bead 16a formed to have width corresponding to width of the clamping portion 202, and a clamping state of the clamp 201 can be further stabilized.

Further, since the bead 16a has a projecting shape with respect to a main surface, the bead 16a having a projecting shape bites into and is locked to a tooth portion of the clamping portion 202, so that a clamping state by the clamping portion 202 with respect to the metal plate material 10a is not unintentionally released, and a stable clamping state can be obtained.

Further, since the metal plate materials 10a and 30a are laminated in the plate thickness direction D, and the bead 16a is provided on a main surface of the metal plate material 10a in a laminated state, it is possible to easily perform machining of providing the bead 16a on the metal plate material 10a to be laminated and form the bead 16a with high accuracy as compared with a case of providing the bead 16a by machining a metal plate material having the same plate thickness as thickness of the metal plate materials 10a and 30a laminated.

Further, since the second metal plate material 30a is a metal plate material having plate thickness larger than that of the metal plate material 10a, the jump-start terminal 1a having higher rigidity than a case where the metal plate materials 10a having the same thickness are laminated can be formed.

Further, in a case where the bead 16a is formed on the metal plate material 10a, since machinability is higher than that of the second metal plate material 30a, the bead 16a with high accuracy can be formed by easy machining.

Further, since the second metal plate material 30a laminated on the metal plate material 10a is a metal thick plate material, the strength in the plate thickness direction D can be improved by laminating the second metal plate material 30a functioning as a reinforcing portion as compared with one sheet of the metal plate material 10a. Further, since the second metal plate material 30a is laminated on the metal plate material 10a, power can be stably supplied.

Note that the bead 16a may be provided on the second metal plate material 30a so as to protrude toward the back surface side Db, or the bead 16a may be provided on each of the metal plate material 10a and the second metal plate material 30a. Note that in a case where the bead 16a is provided on each of the metal plate material 10a and the second metal plate material 30a, the second metal plate material 30a may have the same thickness as the metal plate material 10a. In a case where the bead 16a is provided on each of the metal plate material 10a and the second metal plate material 30a, the bead 16a provided on the metal plate material 10a and the bead 16a provided on the second metal plate material 30a may be provided at the same position in the protruding direction H, or may be provided at different positions in the protruding direction H.

Further, the second metal plate material 30a may be arranged on the front surface side Df of the metal plate material 10a and laminated.

More specifically, the jump-start terminal 1a can ensure strength in the plate thickness direction D of the metal plate material 10a by the second metal plate material 30a reinforcing the protruding direction H of the metal plate material 10a connected to an electric circuit. Therefore, even the jump-start terminal 1a formed of the metal plate material 10a not including a resin member has strength in the plate thickness direction D, and a clamping state by the clamp 201 is stabilized, so that conduction can be stably performed.

Further, in the jump-start terminal 1a formed of the metal plate material 10a, since the bead 16a that locks the clamping portion 202 that performs clamping is provided in a manner protruding from a main surface of the metal plate material 10a, a clamping state of the clamp 201 can be stabilized with respect to the metal plate material 10a. For this reason, it is possible to stably perform conduction via the jump-start terminal 1a clamped by the clamp 201.

Furthermore, since the clamped portion 20a to be clamped by the clamping portion 202 in the jump-start terminal 1a can be clearly indicated by the bead 16a, a worker can reliably clamp the clamped portion 20a to be clamped by the clamping portion 202 without making a mistake, and the clamp 201 can be stably clamped to the metal plate material 10a.

Further, by setting thickness of the clamped portion 20a clamped by the clamping portion 202 to predetermined thickness, durability can be improved as compared with a case where a bus bar holding portion made from resin is included, and the clamping portion 202 can clamp the clamped portion 20a of the metal plate material 10a with required clamping force. Therefore, it is possible to stably perform conduction by clamping with the clamp 201.

Further, since the second metal plate material 30a laminated on the metal plate material 10a is a metal thick plate material, the strength in the plate thickness direction D can be improved by laminating the second metal plate material 30a functioning as a reinforcing portion as compared with one sheet of the metal plate material 10a. Further, since the second metal plate material 30a is laminated on the metal plate material 10a, power can be stably supplied.

Further, since the second metal plate material 30a is a metal plate material having plate thickness larger than that of the metal plate material 10a, the jump-start terminal 1a having higher rigidity than a case where the second metal plate materials having the same thickness as the metal plate material 10a are laminated can be formed.

Further, since the second metal plate material 30a having plate thickness larger than that of the metal plate material 10a has high conductivity, stable power supply can be performed, plate thickness of the second metal plate material 30a can be adjusted according to current that is conducted, and an amount of heat generated in the second metal plate material 30a can be adjusted.

Further, since the bead 16a is formed to have width corresponding to width of the clamping portion 202, the clamping portion 202 can be reliably locked to the bead 16a formed to have width corresponding to width of the clamping portion 202, and a clamping state of the clamp 201 can be further stabilized.

Further, since the bead 16a has a projecting shape with respect to a main surface, the bead 16a having a projecting shape bites into and is locked to a tooth portion of the clamping portion 202, so that a clamping state by the clamping portion 202 with respect to the metal plate material 10a is not unintentionally released, and a stable clamping state can be obtained.

Further, since the metal plate materials 10a and 30a are laminated in the plate thickness direction D, and the bead 16a is provided on a main surface of the metal plate material 10a in a laminated state, it is possible to easily perform machining of providing the bead 16a on the metal plate material 10a to be laminated and form the bead 16a with high accuracy as compared with a case of providing the bead 16a by machining a metal plate material having the same plate thickness as thickness of the metal plate materials 10a and 30a laminated.

Further, since the second metal plate material 30a is a metal plate material having plate thickness larger than that of the metal plate material 10a, the jump-start terminal 1a having higher rigidity than a case where the metal plate materials 10a having the same thickness are laminated can be formed.

Further, in a case where the bead 16a is formed on the metal plate material 10a, since machinability is higher than that of the second metal plate material 30a, the bead 16a with high accuracy can be formed by easy machining.

Further, since another one of the second metal plate material 30a is laminated on at least the clamped portion 20a of the metal plate material 10a to form predetermined thickness including the bead 16a, the clamped portion 20a can be clamped by the clamp 201 and stable conduction can be performed.

More specifically, since the metal plate material 10a having the bead 16a and the second metal plate material 30a are laminated, thickness of the clamped portion 20a clamped by the clamping portion 202 can be set to predetermined thickness, and the clamping portion 202 can clamp the clamped portion 20a of the metal plate material 10a with required clamping force.

Note that the bead 16a may be provided on the second metal plate material 30a so as to protrude toward the back surface side Db, or the bead 16a may be provided on each of the metal plate material 10a and the second metal plate material 30a. Note that in a case where the bead 16a is provided on each of the metal plate material 10a and the second metal plate material 30a, the second metal plate material 30a may have the same thickness as the metal plate material 10a. In a case where the bead 16a is provided on each of the metal plate material 10a and the second metal plate material 30a, the bead 16a provided on the metal plate material 10a and the bead 16a provided on the second metal plate material 30a may be provided at the same position in the protruding direction H, or may be provided at different positions in the protruding direction H.

Further, the second metal plate material 30a may be arranged on the front surface side Df of the metal plate material 10a and laminated.

### Third Embodiment

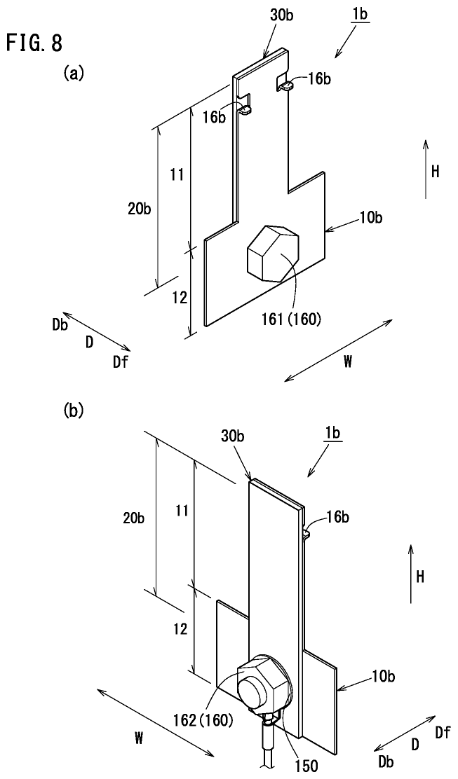

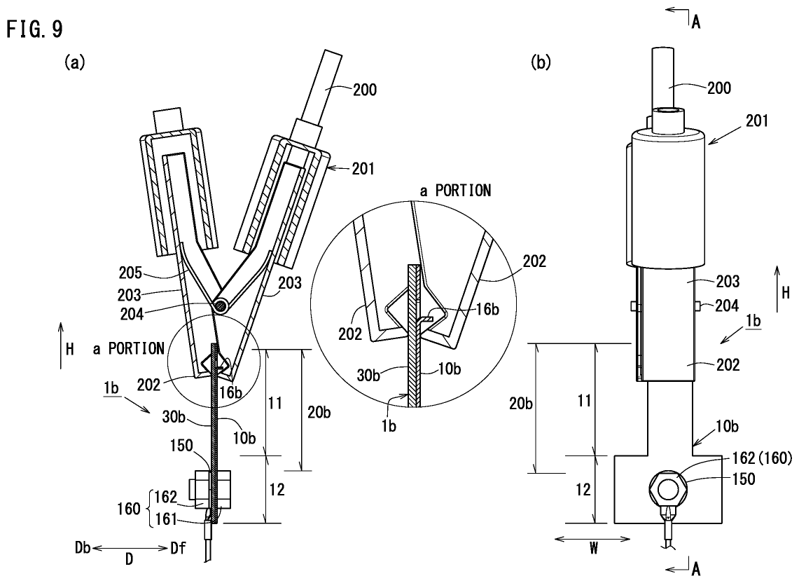

Subsequently, a jump-start terminal 1b of a third embodiment will be described in detail below with reference to FIGS. 8 and 9.

FIGS. 8 and 9 are explanatory views of the jump-start terminal 1b according to the third embodiment. Specifically, FIG. 8(a) is a diagram illustrating a front view, a left side view, and a plan view of the jump-start terminal 1b, FIG. 8(b) is a diagram illustrating a rear view, a left side view, and a plan view of the jump-start terminal 1b, FIG. 9(a) is a cross-sectional view taken along A-A of FIG. 9(b) of the jump-start terminal 1b in a state of being clamped by the clamping portion 202, and FIG. 9(b) is a front view of the jump-start terminal 1b in the same state.

The jump-start terminal 1b of the third embodiment illustrated in FIGS. 8 and 9 is configured by laminating two metal plate materials similarly to the jump-start terminal 1a described above.

Specifically, similarly to the jump-start terminal 1a, the jump-start terminal 1b is formed by laminating, in the plate thickness direction D, a metal plate material 10b formed in a substantially inverted T shape and formed of the terminal main body portion 11 and the mounting base portion 12 and a second metal plate material 30b formed separately.

The metal plate material 10b is a plate material made from a copper alloy having thickness of about 1 mm.

Note that since the second metal plate material 30b has the same configuration as the second metal plate material 30a of the jump-start terminal 1a, will be omitted from description.

In the metal plate material 10b, folded pieces 16b protruding toward the front surface side Df along both edges in the width direction W are provided in a clamped portion 20b.

The clamped portion 20b having the folded piece 16b provided on the metal plate material 10b laminated with the second metal plate material 30b is formed to have predetermined thickness including the folded piece 16b.

The folded piece 16b is formed by cutting out a part of both edges in the width direction W of the terminal main body portion 11 in the metal plate material 10b and folding back the part toward the front surface side Df. Note that the folded piece 16b is formed with a protrusion amount of about two to four times the plate thickness of the metal plate material 10b.

Similarly to the jump-start terminal 1 and the like described above, the jump-start terminal 1b configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20b penetrates the base portion 103 and protrudes in the protruding direction H from the base portion 103.

Then, as described above, in the jump-start terminal 1a arranged along the terminal holder 110, the clamped portion 20b is exposed as the terminal cover 111 is opened, and the clamped portion 20b of the jump-start terminal 1a can be clamped by the clamping portion 202 of the clamp 201. At this time, as illustrated in FIG. 9(a), the clamping portion 202 clamps in a manner sandwiching the folded piece 16b.

As described above, the above-described jump-start terminal 1b in which the folded piece 16b for locking the clamping portion 202 that performs clamping is provided in a manner protruding from a main surface of the metal plate material 10b can achieve the same main effect as the main effect of the jump-start terminal 1 of the first embodiment.

More specifically, in the jump-start terminal 1b formed of the metal plate material 10b, since the folded piece 16b for locking the clamping portion 202 that performs clamping is provided in a manner protruding from a main surface of the metal plate material 10b, a clamping state of the clamp 201 can be stabilized with respect to the metal plate material 10b. For this reason, it is possible to stably perform conduction via the jump-start terminal 1b clamped by the clamp 201.

Furthermore, since the clamped portion 20b to be clamped by the clamping portion 202 in the jump-start terminal 1b can be clearly indicated by the folded piece 16b, a worker can reliably clamp the clamped portion 20b to be clamped by the clamping portion 202 without making a mistake, and the clamp 201 can be stably clamped to the metal plate material 10b.

Further, by setting thickness of the clamped portion 20b clamped by the clamping portion 202 to predetermined thickness, durability can be improved as compared with a case where a bus bar holding portion made from resin is included, and the clamping portion 202 can clamp the clamped portion 20b of the metal plate material 10b with required clamping force. Therefore, it is possible to stably perform conduction by clamping with the clamp 201.

Further, the jump-start terminal 1b can ensure strength in the plate thickness direction D of the metal plate material 10b by the second metal plate material 30b reinforcing the protruding direction H of the metal plate material 10b connected to an electric circuit. Therefore, even the jump-start terminal 1b formed of the metal plate material 10b not including a resin member has strength in the plate thickness direction D, and a clamping state by the clamp 201 is stabilized, so that conduction can be stably performed.

Further, since the folded pieces 16b are provided at positions corresponding to both end portions in the width direction W in the clamping portion 202 formed to have a rectangular U-shaped cross section, the folded piece 16b can be reliably clamped by the clamping portion 202. Further, since the folded pieces 16b are provided at positions corresponding to both end portions in the width direction W of the clamping portion 202 in the metal plate material 10b, it is possible to efficiently and easily perform machining.

Further, since the folded piece 16b has a projecting shape toward the front surface side Df with respect to a main surface, the folded piece 16b having a projecting shape bites into and is locked to a tooth portion of the clamping portion 202, so that a clamping state by the clamping portion 202 with respect to the metal plate material 10b is not unintentionally released, and a stable clamping state can be achieved.

Further, since the metal plate materials 10b and 30b are laminated in the plate thickness direction D, and the folded piece 16b is provided on a main surface of the metal plate material 10b in a laminated state, the folded piece 16b can be formed with high accuracy by easily performing machining of providing the folded piece 16b to any of the laminated metal plate materials 10b as compared with a case where the folded piece 16b is provided by machining the metal plate material 10b having the same plate thickness as thickness of the metal plate materials 10b and 30b laminated.

Further, since one of a plurality of laminated metal plate materials is the metal plate material 10b, another metal plate material is the second metal plate material 30b, and the folded piece 16b is provided on the metal plate material 10b, the folded piece 16b that does not penetrate the laminated metal plate materials in the plate thickness direction D can be easily formed.

Further, since the second metal plate material 30b is a metal plate material having plate thickness larger than that of the metal plate material 10b, the jump-start terminal 1b having higher rigidity than a case where the metal plate materials 10b having the same thickness are laminated can be formed.

Further, in a case where the folded piece 16b is formed on the metal plate material 10b, since machinability is higher than that of the second metal plate material 30b, the folded piece 16b with high accuracy can be formed by easy machining.

Furthermore, since the second metal plate material 30b having plate thickness larger than that of the metal plate material 10b has high conductivity, stable power supply can be performed, plate thickness of the second metal plate material 30b can be adjusted according to current that is conducted, and an amount of heat generated in the second metal plate material 30b can be adjusted.

Further, since another piece, the second metal plate material 30b, is laminated on the clamped portion 20b having the folded piece 16b in the metal plate material 10b to form predetermined thickness, stable conduction can be performed by clamping with the clamp 201.

More specifically, since the metal plate material 10b having the folded piece 16b and the second metal plate material 30b are laminated, thickness of the clamped portion 20b clamped by the clamping portion 202 can be set to predetermined thickness, and the clamping portion 202 can clamp the clamped portion 20b of the metal plate material 10b with required clamping force.

Further, since the second metal plate material 30b is a metal plate material having plate thickness larger than that of the metal plate material 10b, the jump-start terminal 1b having higher rigidity than a case where the metal plate materials 10b having the same thickness are laminated can be formed.

Further, since another piece, the second metal plate material 30b, is laminated on the metal plate material 10b, and the laminated second metal plate material 30b is a metal thick plate material, strength in the plate thickness direction D can be improved by laminating the second metal plate material 30b functioning as a reinforcing portion as compared with one sheet of the metal plate material 10b. Further, since the second metal plate material 30b is laminated on the metal plate material 10b, power can be stably supplied.

Note that the folded piece 16b may be provided on the second metal plate material 30b in a manner protruding to the back surface side Db, or the folded piece 16b may be provided on each of the metal plate material 10b and the second metal plate material 30b. Note that in a case where the folded piece 16b is provided on each of the metal plate material 10b and the second metal plate material 30b, the second metal plate material 30b may have the same thickness as the metal plate material 10b. In a case where the folded piece 16b is provided on each of the metal plate material 10b and the second metal plate material 30b, the folded piece 16b provided on the metal plate material 10b and the folded piece 16b provided on the second metal plate material 30b may be provided at the same position in the protruding direction H, or may be provided at different positions in the protruding direction H.

Further, the second metal plate material 30b may be arranged on the front surface side Df of the metal plate material 10b and laminated.

More specifically, by setting thickness of the clamped portion 20b clamped by the clamping portion 202 to predetermined thickness, durability can be improved as compared with a case where a bus bar holding portion made from resin is included, and the clamping portion 202 can clamp the clamped portion 20b of the metal plate material 10b with required clamping force. Therefore, it is possible to stably perform conduction by clamping with the clamp 201.

Further, in the jump-start terminal 1b formed of the metal plate material 10b, since the folded piece 16b for locking the clamping portion 202 that performs clamping is provided in a manner protruding from a main surface of the metal plate material 10b, a clamping state of the clamp 201 can be stabilized with respect to the metal plate material 10b. For this reason, it is possible to stably perform conduction via the jump-start terminal 1b clamped by the clamp 201.

Furthermore, since the clamped portion 20b to be clamped by the clamping portion 202 in the jump-start terminal 1b can be clearly indicated by the folded piece 16b, a worker can reliably clamp the clamped portion 20b to be clamped by the clamping portion 202 without making a mistake, and the clamp 201 can be stably clamped to the metal plate material 10b.

Further, the jump-start terminal 1b can ensure strength in the plate thickness direction D of the metal plate material 10b by the second metal plate material 30b reinforcing the protruding direction H of the metal plate material 10b connected to an electric circuit. Therefore, even the jump-start terminal 1b formed of the metal plate material 10b not including a resin member has strength in the plate thickness direction D, and a clamping state by the clamp 201 is stabilized, so that conduction can be stably performed.

Further, since another piece, the second metal plate material 30b, is laminated on the clamped portion 20b having the folded piece 16b in the metal plate material 10b to form predetermined thickness, stable conduction can be performed by clamping with the clamp 201.

More specifically, since the metal plate material 10b having the folded piece 16b and the second metal plate material 30b are laminated, thickness of the clamped portion 20b clamped by the clamping portion 202 can be set to predetermined thickness, and the clamping portion 202 can clamp the clamped portion 20b of the metal plate material 10b with required clamping force.

Further, since the second metal plate material 30b is a metal plate material having plate thickness larger than that of the metal plate material 10b, the jump-start terminal 1b having higher rigidity than a case where the metal plate materials 10b having the same thickness are laminated can be formed.

Further, since the second metal plate material 30b having plate thickness larger than that of the metal plate material 10b has high conductivity, stable power supply can be performed, plate thickness of the second metal plate material 30b can be adjusted according to current that is conducted, and an amount of heat generated in the second metal plate material 30b can be adjusted.

Further, since the folded pieces 16b are provided at positions corresponding to both end portions in the width direction W in the clamping portion 202 formed to have a rectangular U-shaped cross section, the folded piece 16b can be reliably clamped by the clamping portion 202. Further, since the folded pieces 16b are provided at positions corresponding to both end portions in the width direction W of the clamping portion 202 in the metal plate material 10b, it is possible to efficiently and easily perform machining.

Further, since the folded piece 16b has a projecting shape toward the front surface side Df with respect to a main surface, the folded piece 16b having a projecting shape bites into and is locked to a tooth portion of the clamping portion 202, so that a clamping state by the clamping portion 202 with respect to the metal plate material 10b is not unintentionally released, and a stable clamping state can be achieved.

Further, since the metal plate materials 10b and 30b are laminated in the plate thickness direction D, and the folded piece 16b is provided on a main surface of the metal plate material 10b in a laminated state, the folded piece 16b can be formed with high accuracy by easily performing machining of providing the folded piece 16b to any of the laminated metal plate materials 10b as compared with a case where the folded piece 16b is provided by machining the metal plate material 10b having the same plate thickness as thickness of the metal plate materials 10b and 30b laminated.

Further, since one of a plurality of laminated metal plate materials is the metal plate material 10b, another metal plate material is the second metal plate material 30b, and the folded piece 16b is provided on the metal plate material 10b, the folded piece 16b that does not penetrate the laminated metal plate materials in the plate thickness direction D can be easily formed.

Further, since the second metal plate material 30b is a metal plate material having plate thickness larger than that of the metal plate material 10b, the jump-start terminal 1b having higher rigidity than a case where the metal plate materials 10b having the same thickness are laminated can be formed.

Further, in a case where the folded piece 16b is formed on the metal plate material 10b, since machinability is higher than that of the second metal plate material 30b, the folded piece 16b with high accuracy can be formed by easy machining.

Further, since another piece, the second metal plate material 30b, is laminated on the metal plate material 10b, and the laminated second metal plate material 30b is a metal thick plate material, strength in the plate thickness direction D can be improved by laminating the second metal plate material 30b functioning as a reinforcing portion as compared with one sheet of the metal plate material 10b. Further, since the second metal plate material 30b is laminated on the metal plate material 10b, power can be stably supplied.

Note that the folded piece 16b may be provided on the second metal plate material 30b in a manner protruding to the back surface side Db, or the folded piece 16b may be provided on each of the metal plate material 10b and the second metal plate material 30b. Note that in a case where the folded piece 16b is provided on each of the metal plate material 10b and the second metal plate material 30b, the second metal plate material 30b may have the same thickness as the metal plate material 10b. In a case where the folded piece 16b is provided on each of the metal plate material 10b and the second metal plate material 30b, the folded piece 16b provided on the metal plate material 10b and the folded piece 16b provided on the second metal plate material 30b may be provided at the same position in the protruding direction H, or may be provided at different positions in the protruding direction H.

Further, the second metal plate material 30b may be arranged on the front surface side Df of the metal plate material 10b and laminated.

More specifically, the jump-start terminal 1b can ensure strength in the plate thickness direction D of the metal plate material 10b by the second metal plate material 30b reinforcing the protruding direction H of the metal plate material 10b connected to an electric circuit. Therefore, even the jump-start terminal 1b formed of the metal plate material 10b not including a resin member has strength in the plate thickness direction D, and a clamping state by the clamp 201 is stabilized, so that conduction can be stably performed.

Further, in the jump-start terminal 1b formed of the metal plate material 10b, since the folded piece 16b for locking the clamping portion 202 that performs clamping is provided in a manner protruding from a main surface of the metal plate material 10b, a clamping state of the clamp 201 can be stabilized with respect to the metal plate material 10b. For this reason, it is possible to stably perform conduction via the jump-start terminal 1b clamped by the clamp 201.

Furthermore, since the clamped portion 20b to be clamped by the clamping portion 202 in the jump-start terminal 1b can be clearly indicated by the folded piece 16b, a worker can reliably clamp the clamped portion 20b to be clamped by the clamping portion 202 without making a mistake, and the clamp 201 can be stably clamped to the metal plate material 10b.

Further, by setting thickness of the clamped portion 20b clamped by the clamping portion 202 to predetermined thickness, durability can be improved as compared with a case where a bus bar holding portion made from resin is included, and the clamping portion 202 can clamp the clamped portion 20b of the metal plate material 10b with required clamping force. Therefore, it is possible to stably perform conduction by clamping with the clamp 201.

Further, since another piece, the second metal plate material 30b, is laminated on the metal plate material 10b, and the laminated second metal plate material 30b is a metal thick plate material, strength in the plate thickness direction D can be improved by laminating the second metal plate material 30b functioning as a reinforcing portion as compared with one sheet of the metal plate material 10b. Further, since the second metal plate material 30b is laminated on the metal plate material 10b, power can be stably supplied.

Further, since the second metal plate material 30b is a metal plate material having plate thickness larger than that of the metal plate material 10b, the jump-start terminal 1b having higher rigidity than a case where the second metal plate materials having the same thickness as the metal plate material 10b are laminated can be formed.

Further, since the second metal plate material 30b having plate thickness larger than that of the metal plate material 10b has high conductivity, stable power supply can be performed, plate thickness of the second metal plate material 30b can be adjusted according to current that is conducted, and an amount of heat generated in the second metal plate material 30b can be adjusted.

Further, since the folded pieces 16b are provided at positions corresponding to both end portions in the width direction W in the clamping portion 202 formed to have a rectangular U-shaped cross section, the folded piece 16b can be reliably clamped by the clamping portion 202. Further, since the folded pieces 16b are provided at positions corresponding to both end portions in the width direction W of the clamping portion 202 in the metal plate material 10b, it is possible to efficiently and easily perform machining.

Further, since the folded piece 16b has a projecting shape toward the front surface side Df with respect to a main surface, the folded piece 16b having a projecting shape bites into and is locked to a tooth portion of the clamping portion 202, so that a clamping state by the clamping portion 202 with respect to the metal plate material 10b is not unintentionally released, and a stable clamping state can be achieved.

Further, since the metal plate materials 10b and 30b are laminated in the plate thickness direction D, and the folded piece 16b is provided on a main surface of the metal plate material 10b in a laminated state, the folded piece 16b can be formed with high accuracy by easily performing machining of providing the folded piece 16b to any of the laminated metal plate materials 10b as compared with a case where the folded piece 16b is provided by machining the metal plate material 10b having the same plate thickness as thickness of the metal plate materials 10b and 30b laminated.

Further, since one of a plurality of laminated metal plate materials is the metal plate material 10b, another metal plate material is the second metal plate material 30b, and the folded piece 16b is provided on the metal plate material 10b, the folded piece 16b that does not penetrate the laminated metal plate materials in the plate thickness direction D can be easily formed.

Further, since the second metal plate material 30b is a metal plate material having plate thickness larger than that of the metal plate material 10b, the jump-start terminal 1b having higher rigidity than a case where the metal plate materials 10b having the same thickness are laminated can be formed.

Further, in a case where the folded piece 16b is formed on the metal plate material 10b, since machinability is higher than that of the second metal plate material 30b, the folded piece 16b with high accuracy can be formed by easy machining.

Furthermore, since the second metal plate material 30b having plate thickness larger than that of the metal plate material 10b has high conductivity, stable power supply can be performed, plate thickness of the second metal plate material 30b can be adjusted according to current that is conducted, and an amount of heat generated in the second metal plate material 30b can be adjusted.

Further, since another piece, the second metal plate material 30b, is laminated on the clamped portion 20b having the folded piece 16b in the metal plate material 10b to form predetermined thickness, stable conduction can be performed by clamping with the clamp 201.

More specifically, since the metal plate material 10b having the folded piece 16b and the second metal plate material 30b are laminated, thickness of the clamped portion 20b clamped by the clamping portion 202 can be set to predetermined thickness, and the clamping portion 202 can clamp the clamped portion 20b of the metal plate material 10b with required clamping force.

Note that the folded piece 16b may be provided on the second metal plate material 30b in a manner protruding to the back surface side Db, or the folded piece 16b may be provided on each of the metal plate material 10b and the second metal plate material 30b. Note that in a case where the folded piece 16b is provided on each of the metal plate material 10b and the second metal plate material 30b, the second metal plate material 30b may have the same thickness as the metal plate material 10b. In a case where the folded piece 16b is provided on each of the metal plate material 10b and the second metal plate material 30b, the folded piece 16b provided on the metal plate material 10b and the folded piece 16b provided on the second metal plate material 30b may be provided at the same position in the protruding direction H, or may be provided at different positions in the protruding direction H.

Further, the second metal plate material 30b may be arranged on the front surface side Df of the metal plate material 10b and laminated.

### Fourth Embodiment

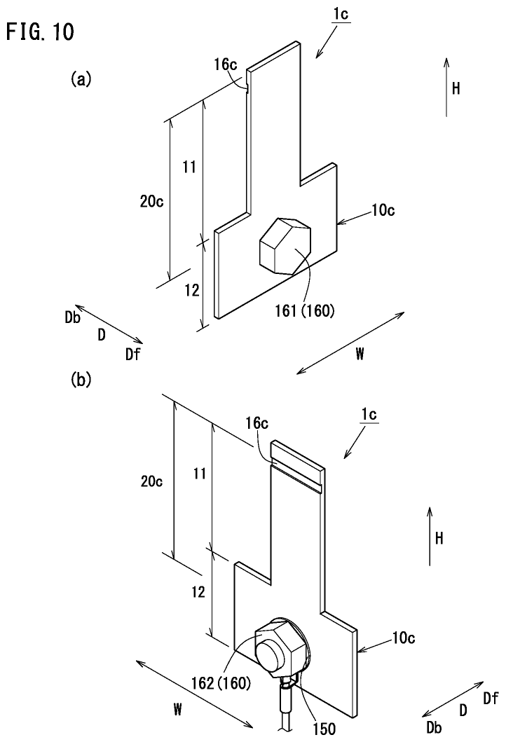

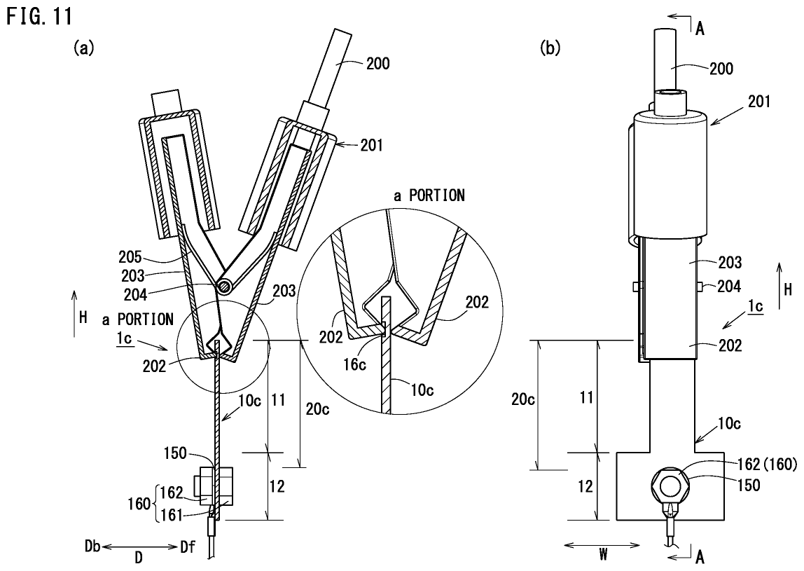

Subsequently, a jump-start terminal 1c of a fourth embodiment will be described in detail below together with FIGS. 10 and 11.

FIGS. 10 and 11 are explanatory views of the jump-start terminal 1c according to the fourth embodiment. Specifically, FIG. 10(a) is a diagram illustrating a front view, a left side view, and a plan view of the jump-start terminal 1c, FIG. 10(b) is a diagram illustrating a rear view, a left side view, and a plan view of the jump-start terminal 1c, FIG. 11(a) is a cross-sectional view taken along A-A of FIG. 11(b) of the jump-start terminal 1c in a state of being clamped by the clamping portion 202, and FIG. 11(b) is a front view of the jump-start terminal 1c in the same state.

The jump-start terminal 1c of the fourth embodiment illustrated in FIGS. 10 and 11 is formed of only a metal plate material 10c similarly to the above-described jump-start terminal 1a. However, unlike the metal plate material 10 of the jump-start terminal 1, the metal plate material 10c is formed of a metal thick plate material having predetermined thickness which is about 5 mm. For this reason, a clamped portion 20c is formed to have predetermined thickness.

The metal plate material 10c is provided with an engagement recessed portion 16c that has a recessed shape with respect to a main surface in an upper portion in the protruding direction H on the back surface side Db of the terminal main body portion 11.

Specifically, the engagement recessed portion 16c is provided along the width direction W on a main surface on the back surface side Db of the terminal main body portion 11. The engagement recessed portion 16c has a rectangular groove shape having depth of about ⅓ of the plate thickness in the terminal main body portion 11 of the metal plate material 10c formed of a metal thick plate material. Note that groove width along the protruding direction H of the engagement recessed portion 16c is formed to have length (width) slightly larger than plate thickness of the metal thick plate material.

Similarly to the jump-start terminal 1 and the like described above, the jump-start terminal 1c configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20c penetrates the base portion 103 and protrudes in the protruding direction H from the base portion 103.

Then, as described above, in the jump-start terminal 1c arranged along the terminal holder 110, the clamped portion 20c is exposed as the terminal cover 111 is opened, and the clamped portion 20c of the jump-start terminal 1c can be clamped by the clamping portion 202 of the clamp 201. At this time, as illustrated in FIG. 11(a), the clamping portion 202 performs clamping in a manner being fitted into the engagement recessed portion 16c.

As described above, the above-described jump-start terminal 1c in which the engagement recessed portion 16c for locking the clamping portion 202 that performs clamping is provided on the metal plate material 10c can achieve the same main effect as the main effect of the jump-start terminal 1 of the first embodiment.

More specifically, in the jump-start terminal 1c formed of the metal plate material 10c, the engagement recessed portion 16c for locking the clamping portion 202 that performs clamping is provided so as to have a recessed shape with respect to a main surface of the metal plate material 10c, so that a clamping state of the clamp 201 with respect to the metal plate material 10c can be stabilized. For this reason, it is possible to stably perform conduction via the jump-start terminal 1c clamped by the clamp 201.

Furthermore, since the clamped portion 20c to be clamped by the clamping portion 202 in the jump-start terminal 1c can be clearly indicated by the engagement recessed portion 16c, a worker can reliably clamp the clamped portion 20c to be clamped by the clamping portion 202 without making a mistake, and the clamp 201 can be stably clamped to the metal plate material 10c.

Further, by setting thickness of the clamped portion 20c clamped by the clamping portion 202 to predetermined thickness, durability can be improved as compared with a case where a bus bar holding portion made from resin is included, and the clamping portion 202 can clamp the clamped portion 20c of the metal plate material 10c with required clamping force. Therefore, it is possible to stably perform conduction by clamping with the clamp 201.

Further, since the engagement recessed portion 16c is formed over width corresponding to width of the clamping portion 202, that is, over the entire width in the width direction W in the terminal main body portion 11, the clamping portion 202 can be reliably locked to the engagement recessed portion 16c formed to have width corresponding to width of the clamping portion 202, and a clamping state of the clamp 201 can be further stabilized.

Further, since the engagement recessed portion 16c has a recessed shape with respect to a main surface, a tip of the clamping portion 202 bites into and is locked to the engagement recessed portion 16c having a recessed shape, so that a clamping state by the clamping portion 202 with respect to the metal plate material 10c is not unintentionally released, and a stable clamping state can be obtained.

Further, since the engagement recessed portion 16c has a recessed shape formed to have depth of a part of plate thickness of the metal plate material 10c, it is possible to suppress decrease in member strength and achieve durability and a stable clamping state as compared with the engagement recessed portion 16c penetrating in the plate thickness direction D of the metal plate material 10c. Further, it is possible to suppress decrease in conductivity as compared with the engagement recessed portion 16c penetrating in the plate thickness direction D of the metal plate material 10c.

Note that the engagement recessed portion 16c may be provided in a main surface on the front surface side Df of the terminal main body portion 11, or the engagement recessed portion 16c may be provided on each of a main surface on the front surface side Df and a main surface on the back surface side Db of the terminal main body portion 11 of the metal plate material 10c. In a case where the engagement recessed portion 16c is provided on each of a main surface on the front surface side Df and a main surface on the back surface side Db of the terminal main body portion 11 of the metal plate material 10c, the engagement recessed portion 16c provided on a main surface on the front surface side Df and the engagement recessed portion 16c provided on a main surface on the back surface side Db of the terminal main body portion 11 may be provided at the same position in the protruding direction H, or may be provided at different positions in the protruding direction H.

More specifically, by setting thickness of the clamped portion 20c clamped by the clamping portion 202 to predetermined thickness, durability can be improved as compared with a case where a bus bar holding portion made from resin is included, and the clamping portion 202 can clamp the clamped portion 20c of the metal plate material 10c with required clamping force. Therefore, it is possible to stably perform conduction by clamping with the clamp 201.

Further, in the jump-start terminal 1c formed of the metal plate material 10c, the engagement recessed portion 16c for locking the clamping portion 202 that performs clamping is provided so as to have a recessed shape with respect to a main surface of the metal plate material 10c, so that a clamping state of the clamp 201 with respect to the metal plate material 10c can be stabilized. For this reason, it is possible to stably perform conduction via the jump-start terminal 1c clamped by the clamp 201.

Note that the engagement recessed portion 16c may be provided in a main surface on the front surface side Df of the terminal main body portion 11, or the engagement recessed portion 16c may be provided on each of a main surface on the front surface side Df and a main surface on the back surface side Db of the terminal main body portion 11 of the metal plate material 10c. In a case where the engagement recessed portion 16c is provided on each of a main surface on the front surface side Df and a main surface on the back surface side Db of the terminal main body portion 11 of the metal plate material 10c, the engagement recessed portion 16c provided on a main surface on the front surface side Df and the engagement recessed portion 16c provided on a main surface on the back surface side Db of the terminal main body portion 11 may be provided at the same position in the protruding direction H, or may be provided at different positions in the protruding direction H.

### Fifth Embodiment

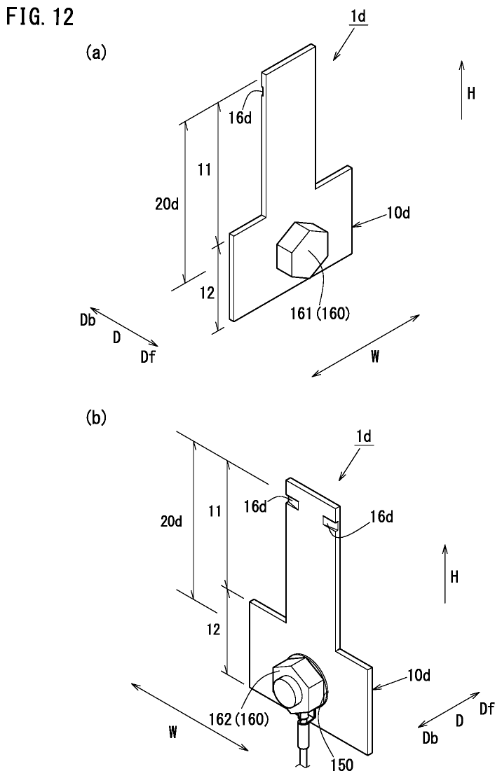

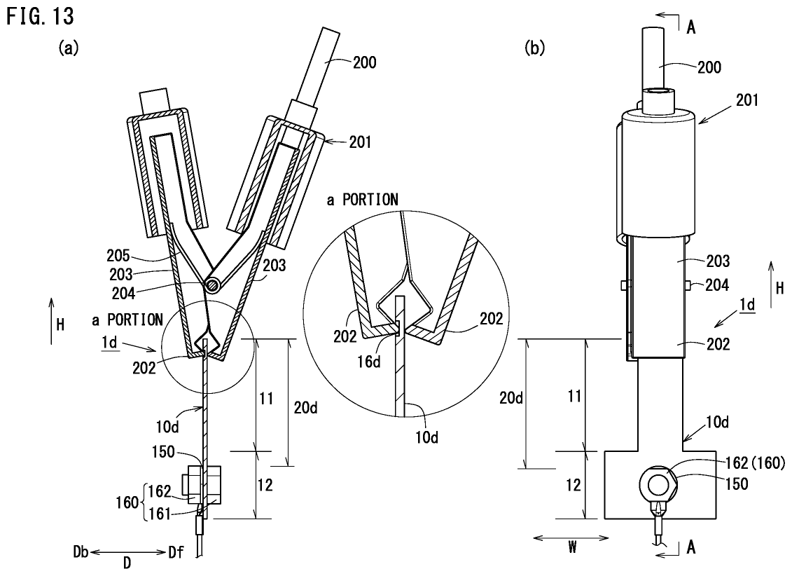

Subsequently, a jump-start terminal 1d of a fifth embodiment will be described in detail below together with FIGS. 12 and 13.

FIGS. 12 and 13 are explanatory views of the jump-start terminal 1d of the fifth embodiment. Specifically, FIG. 12(a) is a diagram illustrating a front view, a left side view, and a plan view of the jump-start terminal 1d, FIG. 12(b) is a diagram illustrating a rear view, a left side view, and a plan view of the jump-start terminal 1d, FIG. 13(a) is a cross-sectional view taken along A-A of FIG. 13(b) of the jump-start terminal 1d in a state of being clamped by the clamping portion 202, and FIG. 13(b) is a front view of the jump-start terminal 1d in the same state.

The jump-start terminal 1d of the fifth embodiment illustrated in FIGS. 12 and 13 is formed of a metal plate material 10d which is one metal thick plate material, similarly to the jump-start terminal 1c described above.

The metal plate material 10d is formed of a metal thick plate material having thickness of about 5 mm, which is the same as the metal plate material 10c of the jump-start terminal 1c described above. For this reason, a clamped portion 20d is formed to have predetermined thickness.

In the metal plate material 10d, engagement recessed portions 16d having a recessed shape with respect to a main surface are provided in an upper portion in the protruding direction H of the back surface side Db of the terminal main body portion 11 in a manner extending inward in the width direction W from both edges in the width direction W.

Specifically, the engagement recessed portion 16d is provided on a main surface on the back surface side Db of the terminal main body portion 11 such that the engagement recessed portion 16d having larger width than plate thickness forming the clamping portion 202 extends inward in the width direction W from both edges. In the present embodiment, the engagement recessed portion 16d is formed to have length of about ¼ with respect to length in the width direction W of the terminal main body portion 11.

The engagement recessed portion 16d has a rectangular groove shape in which groove depth gradually decreases from the outer side in the width direction W toward the center in the width direction W, and is formed to have depth of about ⅓ with respect to plate thickness in the terminal main body portion 11 of the metal plate material 10d formed of a metal thick plate material at a deepest portion on the outer side in the width direction W. Note that groove width along the protruding direction H of the engagement recessed portion 16d is formed to have length (width) slightly larger than plate thickness of the metal thick plate material.

Similarly to the jump-start terminal 1 and the like described above, the jump-start terminal 1d configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20d penetrates the base portion 103 and protrudes in the protruding direction H from the base portion 103.

Then, as described above, in the jump-start terminal 1d arranged along the terminal holder 110, the clamped portion 20d is exposed as the terminal cover 111 is opened, and the clamped portion 20d of the jump-start terminal 1d can be clamped by the clamping portion 202 of the clamp 201. At this time, as illustrated in FIG. 13(b), a part of the clamping portion 202 is clamped by the clamping portion 202 in a manner being fitted into the engagement recessed portion 16d.

As described above, the above-described jump-start terminal 1d in which the engagement recessed portion 16d for locking the clamping portion 202 that performs clamping is provided so as to have a recessed shape with respect to a main surface of the metal plate material 10d can achieve the same main effect as the main effect of the jump-start terminal 1 of the first embodiment.

More specifically, in the jump-start terminal 1d formed of the metal plate material 10d, the engagement recessed portion 16d for locking the clamping portion 202 that performs clamping is provided so as to have a recessed shape with respect to a main surface of the metal plate material 10d, so that a clamping state of the clamp 201 with respect to the metal plate material 10d can be stabilized. For this reason, it is possible to stably perform conduction via the jump-start terminal 1d clamped by the clamp 201.

Furthermore, since the clamped portion 20d to be clamped by the clamping portion 202 in the jump-start terminal 1d can be clearly indicated by the engagement recessed portion 16d, a worker can reliably clamp the clamped portion 20d to be clamped by the clamping portion 202 without making a mistake, and the clamp 201 can be stably clamped to the metal plate material 10d.

Further, by setting thickness of the clamped portion 20d clamped by the clamping portion 202 to predetermined thickness, durability can be improved as compared with a case where a bus bar holding portion made from resin is included, and the clamping portion 202 can clamp the clamped portion 20d of the metal plate material 10d with required clamping force. Therefore, it is possible to stably perform conduction by clamping with the clamp 201.

Further, since the engagement recessed portion 16d is formed to have width corresponding to width of the clamping portion 202, the clamping portion 202 can be reliably locked to the engagement recessed portion 16d formed to have width corresponding to width of the clamping portion 202, and a clamping state of the clamp 201 can be further stabilized.

Further, since the engagement recessed portions 16d are provided at positions corresponding to both end portions in the width direction W in the clamping portion 202 formed to have a rectangular U-shaped cross section, the engagement recessed portion 16d can be reliably clamped by the clamping portion 202.

Further, since the engagement recessed portions 16d are provided at positions corresponding to both end portions in the width direction W of the clamping portion 202 in the metal plate material 10d, machining can be performed efficiently and easily as compared with a case where the engagement recessed portion 16d is provided in the entire width direction W.

Further, since the engagement recessed portion 16d has a recessed shape with respect to a main surface, a tip of the clamping portion 202 bites into and is locked to the engagement recessed portion 16d having a recessed shape, so that a clamping state by the clamping portion 202 with respect to the metal plate material 10d is not unintentionally released, and a stable clamping state can be obtained.

Further, since the engagement recessed portion 16d has a recessed shape formed to have depth of a part of plate thickness of the metal plate material 10d, it is possible to suppress decrease in member strength and achieve durability and a stable clamping state as compared with the engagement recessed portion 16d penetrating in the plate thickness direction D of the metal plate material 10d. Further, it is possible to suppress decrease in conductivity as compared with the engagement recessed portion 16d penetrating in the plate thickness direction D of the metal plate material 10d.

Further, since the engagement recessed portion 16d has a rectangular groove shape in which groove depth gradually decreases from the outer side in the width direction W toward the center in the width direction W, a cross-sectional defect is small as compared with a case where the engagement recessed portion is formed of a recessed portion having uniform depth, and it is possible to suppress decrease in rigidity of the metal plate material 10d due to provision of the engagement recessed portion 16d.

Note that the engagement recessed portion 16d may be provided in a main surface on the front surface side Df of the terminal main body portion 11, or the engagement recessed portion 16d may be provided on each of a main surface on the front surface side Df and a main surface on the back surface side Db of the terminal main body portion 11 of the metal plate material 10d. In a case where the engagement recessed portion 16d is provided on each of a main surface on the front surface side Df and a main surface on the back surface side Db of the terminal main body portion 11 of the metal plate material 10d, the engagement recessed portion 16d provided on a main surface on the front surface side Df and the engagement recessed portion 16d provided on a main surface on the back surface side Db of the terminal main body portion 11 may be provided at the same position in the protruding direction H, or may be provided at different positions in the protruding direction H.

More specifically, by setting thickness of the clamped portion 20d clamped by the clamping portion 202 to predetermined thickness, durability can be improved as compared with a case where a bus bar holding portion made from resin is included, and the clamping portion 202 can clamp the clamped portion 20d of the metal plate material 10d with required clamping force. Therefore, it is possible to stably perform conduction by clamping with the clamp 201.

Further, in the jump-start terminal 1d formed of the metal plate material 10d, the engagement recessed portion 16d for locking the clamping portion 202 that performs clamping is provided so as to have a recessed shape with respect to a main surface of the metal plate material 10d, so that a clamping state of the clamp 201 with respect to the metal plate material 10d can be stabilized. For this reason, it is possible to stably perform conduction via the jump-start terminal 1d clamped by the clamp 201.

Furthermore, since the clamped portion 20d to be clamped by the clamping portion 202 in the jump-start terminal 1d can be clearly indicated by the engagement recessed portion 16d, a worker can reliably clamp the clamped portion 20d to be clamped by the clamping portion 202 without making a mistake, and the clamp 201 can be stably clamped to the metal plate material 10d.

Note that the engagement recessed portion 16d may be provided in a main surface on the front surface side Df of the terminal main body portion 11, or the engagement recessed portion 16d may be provided on each of a main surface on the front surface side Df and a main surface on the back surface side Db of the terminal main body portion 11 of the metal plate material 10d. In a case where the engagement recessed portion 16d is provided on each of a main surface on the front surface side Df and a main surface on the back surface side Db of the terminal main body portion 11 of the metal plate material 10d, the engagement recessed portion 16d provided on a main surface on the front surface side Df and the engagement recessed portion 16d provided on a main surface on the back surface side Db of the terminal main body portion 11 may be provided at the same position in the protruding direction H, or may be provided at different positions in the protruding direction H.

### Sixth Embodiment

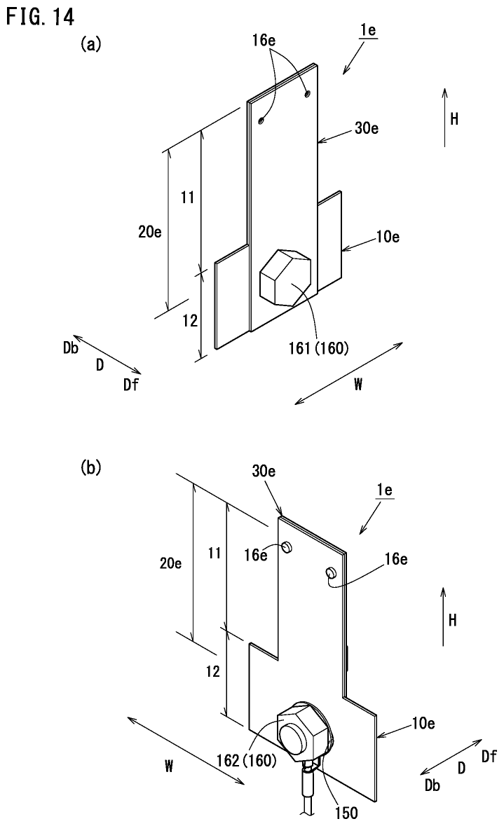

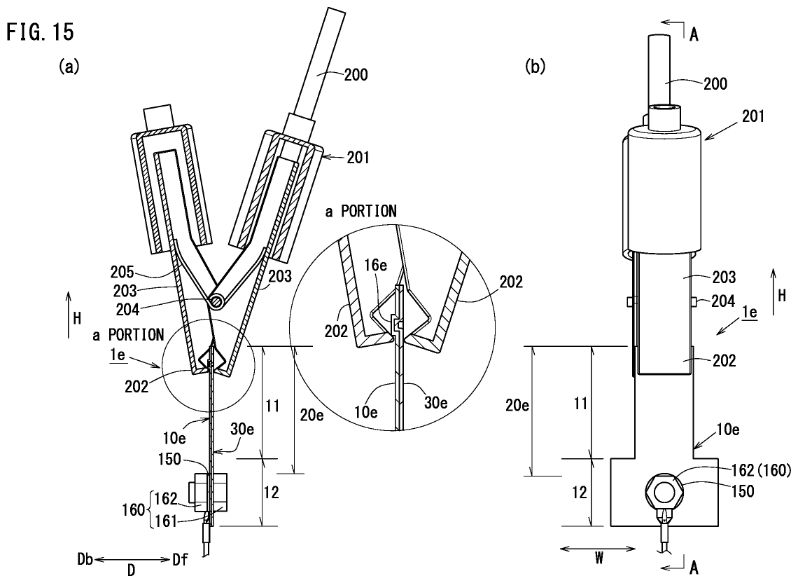

Subsequently, a jump-start terminal 1e of a sixth embodiment will be described in detail below together with FIGS. 14 and 15.

FIGS. 14 and 15 are explanatory views of the jump-start terminal 1e of the sixth embodiment. Specifically, FIG. 14(a) is a diagram illustrating a front view, a left side view, and a plan view of the jump-start terminal 1e, FIG. 14(b) is a diagram illustrating a rear view, a left side view, and a plan view of the jump-start terminal 1e, FIG. 15(a) is a cross-sectional view taken along A-A of FIG. 15(b) of the jump-start terminal 1e in a state of being clamped by the clamping portion 202, and FIG. 15(b) is a front view of the jump-start terminal 1e in the same state.

The jump-start terminal 1e of the sixth embodiment illustrated in FIGS. 14 and 15 is configured by laminating two metal plate materials similarly to the jump-start terminals 1a and 1b described above.

Specifically, similarly to the jump-start terminal 1a, the jump-start terminal 1e is formed by laminating, in the plate thickness direction D, a metal plate material 10e formed in a substantially inverted T shape and formed of the terminal main body portion 11 and the mounting base portion 12 and a second metal plate material 30e formed separately.

The metal plate material 10e is a plate material made from a copper alloy having thickness of about 1 mm.

The second metal plate material 30e has a band shape formed to have the same width as the terminal main body portion 11 of the metal plate material 10e, and is formed to have the same length as length in the protruding direction H of the terminal main body portion 11 and the mounting base portion 12, and has a bolt hole provided at a position corresponding to a bolt hole in the metal plate material 10a.

The second metal plate material 30e is formed to have thickness equivalent to that of the metal plate material 10e, unlike the second metal plate material 30 formed of a metal thick plate material.

The second metal plate material 30e configured as described above is arranged so as to be laminated with the terminal main body portion 11 in the plate thickness direction D on the front surface side Df of the metal plate material 10e.

Then, the terminal main body portion 11 of the metal plate material 10e and the second metal plate material 30e arranged on the front surface side Df are integrated by an interlocking portion 16e that interlocks.

More specifically, the metal plate material 10e and the second metal plate material 30e that are laminated are interlocked in the plate thickness direction D from the second metal plate material 30e toward the metal plate material 10e to form the interlocking portion 16e.

For this reason, the interlocking portion 16e has a recessed shape with respect to a main surface in the second metal plate material 30e, and has a projecting shape with respect to a main surface on the back surface side Db of the metal plate material 10e.

Note that since the interlocking portion 16e protrudes from a main surface on the back surface side Db of the metal plate material 10e toward the back surface side Db by the same height as plate thickness of the metal plate material 10e, thickness of a main surface on the front surface side Df of the second metal plate material 30e and a top portion on the back surface side Db of the interlocking portion 16e in a clamped portion 20e is predetermined thickness.

As described above, two of the interlocking portions 16e having a projecting shape with respect to a main surface on the back surface side Db of the metal plate material 10e are arranged at a predetermined interval in the width direction W with respect to the terminal main body portion 11 of the metal plate material 10e.

Note that an interval between the interlocking portions 16e is an interval corresponding to width of the clamping portion 202 of the clamp 201.

Similarly to the jump-start terminal 1 and the like described above, the jump-start terminal 1e configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20e penetrates the base portion 103 and protrudes in the protruding direction H from the base portion 103.

Then, as described above, in the jump-start terminal 1e arranged along the terminal holder 110, the clamped portion 20e is exposed as the terminal cover 111 is opened, and the clamped portion 20e of the jump-start terminal 1e can be clamped by the clamping portion 202 of the clamp 201. At this time, as illustrated in FIG. 15(a), the clamping portion 202 clamps in a manner sandwiching the interlocking portion 16e.

As described above, the above-described jump-start terminal 1e in which the interlocking portion 16e for locking the clamping portion 202 that performs clamping is provided in a manner protruding from a main surface of the metal plate material 10e can achieve the same main effect as the main effect of the jump-start terminal 1 of the first embodiment.

More specifically, in the jump-start terminal 1e formed of the metal plate material 10e, since the interlocking portion 16e for locking the clamping portion 202 that performs clamping is provided in a manner protruding from a main surface of the metal plate material 10e, a clamping state of the clamp 201 can be stabilized with respect to the metal plate material 10e. For this reason, it is possible to stably perform conduction via the jump-start terminal 1e clamped by the clamp 201.

Furthermore, since the clamped portion 20e to be clamped by the clamping portion 202 in the jump-start terminal 1e can be clearly indicated by the interlocking portion 16e, a worker can reliably clamp the clamped portion 20e to be clamped by the clamping portion 202 without making a mistake, and the clamp 201 can be stably clamped to the metal plate material 10e.

Further, by setting thickness of the clamped portion 20e clamped by the clamping portion 202 to predetermined thickness by the interlocking portion 16e, durability can be improved as compared with a case where a bus bar holding portion made from resin is included, and the clamping portion 202 can clamp the clamped portion 20e of the metal plate material 10e with required clamping force. Therefore, it is possible to stably perform conduction by clamping with the clamp 201.

Further, the jump-start terminal 1e can ensure strength in the plate thickness direction D of the metal plate material 10e by the second metal plate material 30e reinforcing the protruding direction H of the metal plate material 10e connected to an electric circuit. Therefore, even the jump-start terminal 1e formed of the metal plate material 10e not including a resin member has strength in the plate thickness direction D, and a clamping state by the clamp 201 is stabilized, so that conduction can be stably performed.

Further, since the interlocking portions 16e are provided at positions corresponding to both end portions in the width direction W in the clamping portion 202 formed to have a rectangular U-shaped cross section, the interlocking portion 16e can be reliably clamped by the clamping portion 202. Further, since the interlocking portions 16e are provided at positions corresponding to both end portions in the width direction W of the clamping portion 202 in the metal plate material 10e, machining can be performed efficiently and easily as compared with a case where the interlocking portion 16e is provided in the entire width direction W.

Further, since the interlocking portion 16e has a projecting shape with respect to a main surface on the back surface side Db of the metal plate material 10e, the interlocking portion 16e having a projecting portion bites into and is locked to a tooth portion of the clamping portion 202, so that a state of clamping the metal plate material 10e by the clamping portion 202 is not unintentionally released, and a stable clamping state can be achieved.

Further, a plurality of metal plate materials are laminated in the plate thickness direction D, and the interlocking portion 16e interlocks in the plate thickness direction D from the laminated second metal plate material 30e toward the metal plate material 10e. For this reason, the metal plate material 10e and the second metal plate material 30e laminated are integrated by the interlocking portion 16e, and the jump-start terminal 1e having high rigidity can be formed with increased plate thickness as compared with a case where a jump-start terminal is formed of one sheet of the metal plate material 10e.

Further, since the interlocking portion 16e that interlocks and integrates the laminated metal plate materials 10e functions as a locking portion, a clamping state of the clamp 201 can be stabilized with respect to the laminated and integrated metal plate materials 10e and 30e without provision of a separate locking portion.

Further, another piece, the second metal plate material 30e, is laminated on at least the clamped portion 20e in the metal plate material 10e and is integrated by the interlocking portion 16e, and thickness in the plate thickness direction D of a portion of the interlocking portion 16e is predetermined thickness. For this reason, it is possible to stably perform conduction by clamping with the clamp 201.

More specifically, since the metal plate material 10e and the second metal plate material 30e are laminated, thickness of the clamped portion 20e clamped by the clamping portion 202 can be set to predetermined thickness by the interlocking portion 16e, and the clamping portion 202 can clamp the clamped portion 20e of the metal plate material 10e with required clamping force.

Further, since the laminated metal plate materials 10e and 30e are integrated by the interlocking portion 16e that interlocks in the plate thickness direction D from the metal plate material 10e toward the second metal plate material 30e, the jump-start terminal 1e having high rigidity can be formed with increased plate thickness as compared with a case where a jump-start terminal is formed of one sheet of the metal plate material 10e.

Further, by clamping the interlocking portion 16e with the clamping portion 202, the clamping portion 202 is locked to the interlocking portion 16e, and a stable clamping state can be obtained.

Note that in the interlocking portion 16e, as described above, two of the interlocking portions 16e arranged at a predetermined interval in the width direction W interlock in a manner protruding to the back surface side Db of the terminal main body portion 11, but the interlocking portion 16e may interlock in a manner protruding to the front surface side Df, or the interlocking portions 16e may interlock in a manner that one of two of the interlocking portions 16e protrudes to the back surface side Db and the other protrudes to the front surface side Df. Furthermore, a plurality of two of the interlocking portions 16e arranged at a predetermined interval in the width direction W may be arranged at a predetermined interval in the protruding direction H.

Further, the second metal plate material 30e may be laminated on the back surface side Db of the metal plate material 10e to be integrated.

More specifically, by setting thickness of the clamped portion 20e clamped by the clamping portion 202 to predetermined thickness by the interlocking portion 16e, durability can be improved as compared with a case where a bus bar holding portion made from resin is included, and the clamping portion 202 can clamp the clamped portion 20e of the metal plate material 10e with required clamping force. Therefore, it is possible to stably perform conduction by clamping with the clamp 201.

Further, in the jump-start terminal 1e formed of the metal plate material 10e, since the interlocking portion 16e for locking the clamping portion 202 that performs clamping is provided in a manner protruding from a main surface of the metal plate material 10e, a clamping state of the clamp 201 can be stabilized with respect to the metal plate material 10e. For this reason, it is possible to stably perform conduction via the jump-start terminal 1e clamped by the clamp 201.

Furthermore, since the clamped portion 20e to be clamped by the clamping portion 202 in the jump-start terminal 1e can be clearly indicated by the interlocking portion 16e, a worker can reliably clamp the clamped portion 20e to be clamped by the clamping portion 202 without making a mistake, and the clamp 201 can be stably clamped to the metal plate material 10e.

Further, the jump-start terminal 1e can ensure strength in the plate thickness direction D of the metal plate material 10e by the second metal plate material 30e reinforcing the protruding direction H of the metal plate material 10e connected to an electric circuit. Therefore, even the jump-start terminal 1e formed of the metal plate material 10e not including a resin member has strength in the plate thickness direction D, and a clamping state by the clamp 201 is stabilized, so that conduction can be stably performed.

Further, another piece, the second metal plate material 30e, is laminated on at least the clamped portion 20e in the metal plate material 10e and is integrated by the interlocking portion 16e, and thickness in the plate thickness direction D of a portion of the interlocking portion 16e is predetermined thickness. For this reason, it is possible to stably perform conduction by clamping with the clamp 201.

More specifically, since the metal plate material 10e and the second metal plate material 30e are laminated, thickness of the clamped portion 20e clamped by the clamping portion 202 can be set to predetermined thickness by the interlocking portion 16e, and the clamping portion 202 can clamp the clamped portion 20e of the metal plate material 10e with required clamping force.

Further, since the laminated metal plate materials 10e and 30e are integrated by the interlocking portion 16e that interlocks in the plate thickness direction D from the metal plate material 10e toward the second metal plate material 30e, the jump-start terminal 1e having high rigidity can be formed with increased plate thickness as compared with a case where a jump-start terminal is formed of one sheet of the metal plate material 10e.

Further, by clamping the interlocking portion 16e with the clamping portion 202, the clamping portion 202 is locked to the interlocking portion 16e, and a stable clamping state can be obtained.

Further, since the interlocking portions 16e are provided at positions corresponding to both end portions in the width direction W in the clamping portion 202 formed to have a rectangular U-shaped cross section, the interlocking portion 16e can be reliably clamped by the clamping portion 202. Further, since the interlocking portions 16e are provided at positions corresponding to both end portions in the width direction W of the clamping portion 202 in the metal plate material 10e, machining can be performed efficiently and easily as compared with a case where the interlocking portion 16e is provided in the entire width direction W.

Further, since the interlocking portion 16e has a projecting shape with respect to a main surface on the back surface side Db of the metal plate material 10e, the interlocking portion 16e having a projecting portion bites into and is locked to a tooth portion of the clamping portion 202, so that a state of clamping the metal plate material 10e by the clamping portion 202 is not unintentionally released, and a stable clamping state can be achieved.

Further, a plurality of metal plate materials are laminated in the plate thickness direction D, and the interlocking portion 16e interlocks in the plate thickness direction D from the laminated second metal plate material 30e toward the metal plate material 10e. For this reason, the metal plate material 10e and the second metal plate material 30e laminated are integrated by the interlocking portion 16e, and the jump-start terminal 1e having high rigidity can be formed with increased plate thickness as compared with a case where a jump-start terminal is formed of one sheet of the metal plate material 10e.

Further, since the interlocking portion 16e that interlocks and integrates the laminated metal plate materials 10e functions as a locking portion, a clamping state of the clamp 201 can be stabilized with respect to the laminated and integrated metal plate materials 10e and 30e without provision of a separate locking portion.

Note that in the interlocking portion 16e, as described above, two of the interlocking portions 16e arranged at a predetermined interval in the width direction W interlock in a manner protruding to the back surface side Db of the terminal main body portion 11, but the interlocking portion 16e may interlock in a manner protruding to the front surface side Df, or the interlocking portions 16e may interlock in a manner that one of two of the interlocking portions 16e protrudes to the back surface side Db and the other protrudes to the front surface side Df. Furthermore, a plurality of two of the interlocking portions 16e arranged at a predetermined interval in the width direction W may be arranged at a predetermined interval in the protruding direction H.

Further, the second metal plate material 30e may be laminated on the back surface side Db of the metal plate material 10e to be integrated.

More specifically, the jump-start terminal 1e can ensure strength in the plate thickness direction D of the metal plate material 10e by the second metal plate material 30e reinforcing the protruding direction H of the metal plate material 10e connected to an electric circuit. Therefore, even the jump-start terminal 1e formed of the metal plate material 10e not including a resin member has strength in the plate thickness direction D, and a clamping state by the clamp 201 is stabilized, so that conduction can be stably performed.

Further, in the jump-start terminal 1e formed of the metal plate material 10e, since the interlocking portion 16e for locking the clamping portion 202 that performs clamping is provided in a manner protruding from a main surface of the metal plate material 10e, a clamping state of the clamp 201 can be stabilized with respect to the metal plate material 10e. For this reason, it is possible to stably perform conduction via the jump-start terminal 1e clamped by the clamp 201.

Furthermore, since the clamped portion 20e to be clamped by the clamping portion 202 in the jump-start terminal 1e can be clearly indicated by the interlocking portion 16e, a worker can reliably clamp the clamped portion 20e to be clamped by the clamping portion 202 without making a mistake, and the clamp 201 can be stably clamped to the metal plate material 10e.

More specifically, by setting thickness of the clamped portion 20e clamped by the clamping portion 202 to predetermined thickness by the interlocking portion 16e, durability can be improved as compared with a case where a bus bar holding portion made from resin is included, and the clamping portion 202 can clamp the clamped portion 20e of the metal plate material 10e with required clamping force. Therefore, it is possible to stably perform conduction by clamping with the clamp 201.

Further, since another piece, the second metal plate material 30e, is laminated on the metal plate material 10e, and the laminated second metal plate material 30e is the second metal plate material 30e, strength in the plate thickness direction D can be improved by laminating the second metal plate material 30e functioning as the second metal plate material 30e as compared with one sheet of the metal plate material 10e. Further, since the second metal plate material 30e is laminated on the metal plate material 10e, power can be stably supplied.

Further, since the metal plate material 10e and the second metal plate material 30e that are laminated are integrated by the interlocking portion 16e by interlocking in the plate thickness direction D from the metal plate material 10e toward the second metal plate material 30e that are laminated, the jump-start terminal 1e having high rigidity can be formed with increased plate thickness as compared with a case where a jump-start terminal is formed of one sheet of the metal plate material 10e.

Further, by clamping the interlocking portion 16e with the clamping portion 202, the clamping portion 202 is locked to the interlocking portion 16e, and a stable clamping state can be obtained.

Further, since the interlocking portions 16e are provided at positions corresponding to both end portions in the width direction W in the clamping portion 202 formed to have a rectangular U-shaped cross section, the interlocking portion 16e can be reliably clamped by the clamping portion 202. Further, since the interlocking portions 16e are provided at positions corresponding to both end portions in the width direction W of the clamping portion 202 in the metal plate material 10e, machining can be performed efficiently and easily as compared with a case where the interlocking portion 16e is provided in the entire width direction W.

Further, since the interlocking portion 16e has a projecting shape with respect to a main surface on the back surface side Db of the metal plate material 10e, the interlocking portion 16e having a projecting portion bites into and is locked to a tooth portion of the clamping portion 202, so that a state of clamping the metal plate material 10e by the clamping portion 202 is not unintentionally released, and a stable clamping state can be achieved.

Further, a plurality of metal plate materials are laminated in the plate thickness direction D, and the interlocking portion 16e interlocks in the plate thickness direction D from the laminated second metal plate material 30e toward the metal plate material 10e. For this reason, the metal plate material 10e and the second metal plate material 30e laminated are integrated by the interlocking portion 16e, and the jump-start terminal 1e having high rigidity can be formed with increased plate thickness as compared with a case where a jump-start terminal is formed of one sheet of the metal plate material 10e.

Further, since the interlocking portion 16e that interlocks and integrates the laminated metal plate materials 10e functions as a locking portion, a clamping state of the clamp 201 can be stabilized with respect to the laminated and integrated metal plate materials 10e and 30e without provision of a separate locking portion.

Further, another piece, the second metal plate material 30e, is laminated on at least the clamped portion 20e in the metal plate material 10e and is integrated by the interlocking portion 16e, and thickness in the plate thickness direction D of a portion of the interlocking portion 16e is predetermined thickness. For this reason, it is possible to stably perform conduction by clamping with the clamp 201.

More specifically, since the metal plate material 10e and the second metal plate material 30e are laminated, thickness of the clamped portion 20e clamped by the clamping portion 202 can be set to predetermined thickness by the interlocking portion 16e, and the clamping portion 202 can clamp the clamped portion 20e of the metal plate material 10e with required clamping force.

Note that in the interlocking portion 16e, as described above, two of the interlocking portions 16e arranged at a predetermined interval in the width direction W interlock in a manner protruding to the back surface side Db of the terminal main body portion 11, but the interlocking portion 16e may interlock in a manner protruding to the front surface side Df, or the interlocking portions 16e may interlock in a manner that one of two of the interlocking portions 16e protrudes to the back surface side Db and the other protrudes to the front surface side Df. Furthermore, a plurality of two of the interlocking portions 16e arranged at a predetermined interval in the width direction W may be arranged at a predetermined interval in the protruding direction H.

Further, the second metal plate material 30e may be laminated on the back surface side Db of the metal plate material 10e to be integrated.

### Seventh Embodiment

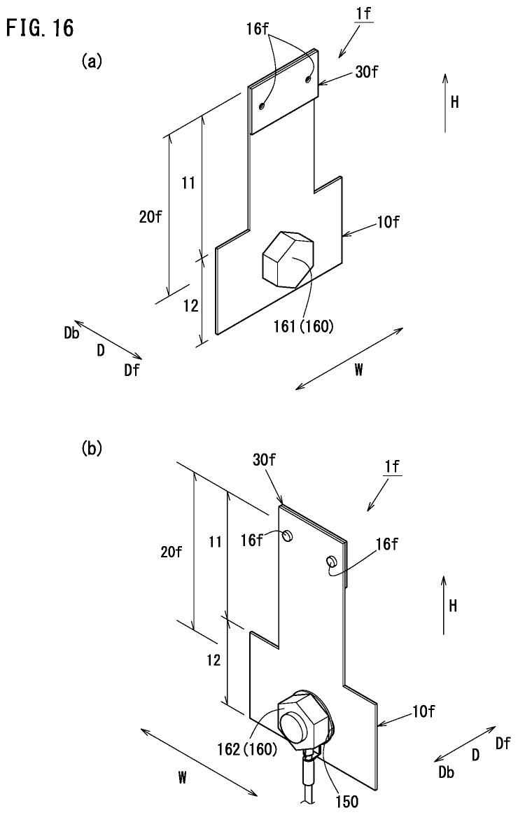

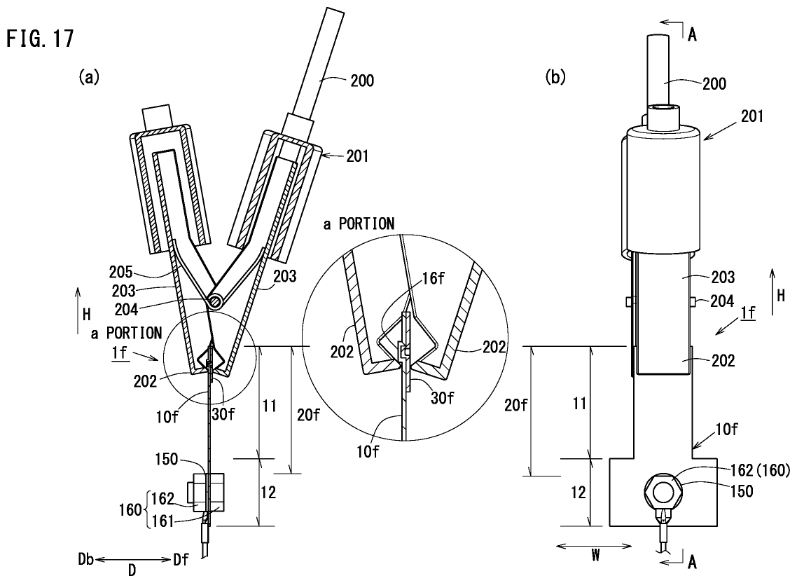

Subsequently, a jump-start terminal if of a seventh embodiment will be described in detail below together with FIGS. 16 and 17.

FIGS. 16 and 17 are explanatory views of the jump-start terminal if of the seventh embodiment. Specifically, FIG. 16(a) is a diagram illustrating a front view, a left side view, and a plan view of the jump-start terminal 1f, FIG. 16(b) is a diagram illustrating a rear view, a left side view, and a plan view of the jump-start terminal 1f, FIG. 17(a) is a cross-sectional view taken along A-A of FIG. 17(b) of the jump-start terminal if in a state of being clamped by the clamping portion 202, and FIG. 17(b) is a front view of the jump-start terminal if in the same state.

The jump-start terminal if of the seventh embodiment illustrated in FIGS. 16 and 17 is configured by laminating two metal plate materials similarly to the jump-start terminal 1e described above.

Specifically, the jump-start terminal if is formed by laminating, in the plate thickness direction D, a metal plate material 10f formed in a substantially inverted T shape and formed of the terminal main body portion 11 and the mounting base portion 12 and a second metal plate material 30f formed separately.

The metal plate material 10f has the same configuration as the metal plate material 10e described above, and is omitted from description, but the metal plate material 10f is a plate material made from a copper alloy having thickness of about 1 mm.

The second metal plate material 30f is formed to have length in the protruding direction H in which the terminal main body portion 11 and the mounting base portion 12 are combined in the metal plate material 10f, and the second metal plate material 30f is formed to have length to be laminated on a part of the tip side of the terminal main body portion 11 in the protruding direction H, and is integrated by an interlocking portion 16f.

The second metal plate material 30f is formed to have length of about ⅓ of the terminal main body portion 11 of the metal plate material 10f, and is formed to have thickness equivalent to that of the metal plate material 10f.

The second metal plate material 30f configured as described above is arranged so as to be laminated in the plate thickness direction D with respect to a part of the tip side of the terminal main body portion 11 on the front surface side Df of the metal plate material 10f.

Then, a part of the tip side of the terminal main body portion 11 of the metal plate material 10f and the second metal plate material 30f arranged on the front surface side Df are integrated by the interlocking portion 16f that interlocks.

Note that two of the interlocking portions 16f that have a projecting shape with respect to a main surface on the back surface side Db of the metal plate material 10f are arranged at a predetermined interval in the width direction W corresponding to width of the clamping portion 202 of the clamp 201 with respect to the terminal main body portion 11 of the metal plate material 10f.

Note that since the interlocking portion 16f protrudes from a main surface on the back surface side Db of the metal plate material 10f toward the back surface side Db by the same height as plate thickness of the metal plate material 10f, thickness of a main surface on the front surface side Df of the second metal plate material 30f and a top portion on the back surface side Db of the interlocking portion 16f in a clamped portion 20f is predetermined thickness.

Similarly to the jump-start terminal 1 and the like described above, the jump-start terminal if configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20f penetrates the base portion 103 and protrudes in the protruding direction H from the base portion 103.

Then, as described above, in the jump-start terminal if arranged along the terminal holder 110, the clamped portion 20f is exposed as the terminal cover 111 is opened, and the clamped portion 20f of the jump-start terminal if can be clamped by the clamping portion 202 of the clamp 201. At this time, as illustrated in FIG. 17(a), the clamping portion 202 clamps the interlocking portion 16f, and clamping is performed in a manner that the clamping portion 202 is locked to an end portion on the base end side of the second metal plate material 30f formed to have length of about ⅓ of the terminal main body portion 11.

As described above, the above-described jump-start terminal if in which the interlocking portion 16f for locking the clamping portion 202 that performs clamping is provided in a manner protruding from a main surface of the metal plate material 10f and the second metal plate material 30f can achieve the same main effect as the main effect of the jump-start terminal 1 of the first embodiment.

More specifically, in the jump-start terminal if formed of the metal plate material 10f and the second metal plate material 30f, the interlocking portion 16f for locking the clamping portion 202 that performs clamping is provided in a manner protruding from a main surface of the metal plate material 10f, and clamping is performed in a manner that the interlocking portion 16f is clamped and the clamping portion 202 is locked at an end portion on the base end side of the second metal plate material 30f formed to have length of about ⅓ of the terminal main body portion 11. For this reason, a clamping state of the clamp 201 can be stabilized with respect to the metal plate material 10f and the second metal plate material 30f. For this reason, it is possible to stably perform conduction via the jump-start terminal if clamped by the clamp 201.

Furthermore, since the clamped portion 20f to be clamped by the clamping portion 202 in the jump-start terminal if can be clearly indicated by the interlocking portion 16f, a worker can reliably clamp the clamped portion 20f to be clamped by the clamping portion 202 without making a mistake, and the clamp 201 can be stably clamped to the metal plate material 10f and the second metal plate material 30f.

Further, by setting thickness of the clamped portion 20f clamped by the clamping portion 202 to predetermined thickness by the interlocking portion 16f, durability can be improved as compared with a case where a bus bar holding portion made from resin is included, and the clamping portion 202 can clamp the clamped portion 20f of the metal plate material 10f and the second metal plate material 30f with required clamping force. Therefore, it is possible to stably perform conduction by clamping with the clamp 201.

Further, since the interlocking portions 16f are provided at positions corresponding to both end portions in the width direction W in the clamping portion 202 formed to have a rectangular U-shaped cross section, the interlocking portion 16f can be reliably clamped by the clamping portion 202. Further, since the interlocking portions 16f are provided at positions corresponding to both end portions in the width direction W of the clamping portion 202 in the metal plate material 10f and the second metal plate material 30f, machining can be performed efficiently and easily as compared with a case where the interlocking portion 16f is provided in the entire width direction W.

Further, since the interlocking portion 16f has a projecting shape with respect to a main surface of the metal plate material 10f, the interlocking portion 16f having a projecting shape bites into and is locked to a tooth portion of the clamping portion 202, so that a state of clamping the metal plate material 10f and the second metal plate material 30f by the clamping portion 202 is not unintentionally released, and a stable clamping state can be achieved.

Further, a plurality of metal plate materials are laminated in the plate thickness direction D, and the interlocking portion 16f interlocks in the plate thickness direction D from the laminated second metal plate material 30f toward the metal plate material 10f. For this reason, a plurality of the metal plate material 10f and the second metal plate material 30f laminated are integrated by the interlocking portion 16f, and the jump-start terminal if having high rigidity can be formed with increased plate thickness as compared with a case where a jump-start terminal is formed of one sheet of a metal plate material.

Further, since the interlocking portion 16f that interlocks and integrates the laminated metal plate materials 10f and second metal plate material 30f functions as a locking portion, a clamping state of the clamp 201 can be stabilized with respect to the laminated and integrated metal plate materials 10f and second metal plate material 30f without provision of a separate locking portion.

Further, one of a plurality of laminated metal plate materials is the metal plate material 10f, another metal plate material is the second metal plate material 30f, the second metal plate material 30f is shorter than the metal plate material 10f, and the second metal plate material 30f is laminated on the clamped portion 20f clamped by the clamping portion 202 in the metal plate material 10f. For this reason, the jump-start terminal if that can be stably clamped by the clamping portion 202 can be reduced in weight as compared with a case where the second metal plate material 30f is laminated on the entire metal plate material 10f. Further, a step portion formed by the second metal plate material 30f shorter than the metal plate material 10f can also function as the interlocking portion 16f.

Further, another piece, the second metal plate material 30f, is laminated on at least the clamped portion 20f in the metal plate material 10f, and predetermined thickness is formed by the interlocking portion 16f that integrates the metal plate material 10f and the second metal plate material 30f. For this reason, it is possible to stably perform conduction by clamping with the clamp 201.

More specifically, since the metal plate material 10f and the second metal plate material 30f are laminated, thickness of the clamped portion 20f clamped by the clamping portion 202 can be set to predetermined thickness by the interlocking portion 16f, and the clamping portion 202 can clamp the clamped portion 20f of the metal plate material 10f and the second metal plate material 30f with required clamping force.

Note that in the interlocking portion 16f, as described above, two of the interlocking portions 16f arranged at a predetermined interval in the width direction W interlock in a manner protruding to the back surface side Db of the terminal main body portion 11, but the interlocking portion 16f may interlock in a manner protruding to the front surface side Df, or the interlocking portions 16f may interlock in a manner that one of two of the interlocking portions 16f protrudes to the back surface side Db and the other protrudes to the front surface side Df. Furthermore, a plurality of two of the interlocking portions 16f arranged at a predetermined interval in the width direction W may be arranged at a predetermined interval in the protruding direction H.

Further, the second metal plate material 30f may be laminated on the back surface side Db of the metal plate material 10f to be integrated.

More specifically, by setting thickness of the clamped portion 20f clamped by the clamping portion 202 to predetermined thickness by the interlocking portion 16f, durability can be improved as compared with a case where a bus bar holding portion made from resin is included, and the clamping portion 202 can clamp the clamped portion 20f of the metal plate material 10f and the second metal plate material 30f with required clamping force. Therefore, it is possible to stably perform conduction by clamping with the clamp 201.

Further, in the jump-start terminal if formed of the metal plate material 10f and the second metal plate material 30f, the interlocking portion 16f for locking the clamping portion 202 that performs clamping is provided in a manner protruding from a main surface of the metal plate material 10f, and clamping is performed in a manner that the interlocking portion 16f is clamped and the clamping portion 202 is locked at an end portion on the base end side of the second metal plate material 30f formed to have length of about ⅓ of the terminal main body portion 11. For this reason, a clamping state of the clamp 201 can be stabilized with respect to the metal plate material 10f and the second metal plate material 30f. For this reason, it is possible to stably perform conduction via the jump-start terminal if clamped by the clamp 201.

Furthermore, since the clamped portion 20f to be clamped by the clamping portion 202 in the jump-start terminal if can be clearly indicated by the interlocking portion 16f, a worker can reliably clamp the clamped portion 20f to be clamped by the clamping portion 202 without making a mistake, and the clamp 201 can be stably clamped to the metal plate material 10f and the second metal plate material 30f.

Further, another piece, the second metal plate material 30f, is laminated on at least the clamped portion 20f in the metal plate material 10f, and predetermined thickness is formed by the interlocking portion 16f that integrates the metal plate material 10f and the second metal plate material 30f. For this reason, it is possible to stably perform conduction by clamping with the clamp 201.

More specifically, since the metal plate material 10f and the second metal plate material 30f are laminated, thickness of the clamped portion 20f clamped by the clamping portion 202 can be set to predetermined thickness by the interlocking portion 16f, and the clamping portion 202 can clamp the clamped portion 20f of the metal plate material 10f and the second metal plate material 30f with required clamping force.

Further, since the interlocking portions 16f are provided at positions corresponding to both end portions in the width direction W in the clamping portion 202 formed to have a rectangular U-shaped cross section, the interlocking portion 16f can be reliably clamped by the clamping portion 202. Further, since the interlocking portions 16f are provided at positions corresponding to both end portions in the width direction W of the clamping portion 202 in the metal plate material 10f and the second metal plate material 30f, machining can be performed efficiently and easily as compared with a case where the interlocking portion 16f is provided in the entire width direction W.

Further, since the interlocking portion 16f has a projecting shape with respect to a main surface of the metal plate material 10f, the interlocking portion 16f having a projecting shape bites into and is locked to a tooth portion of the clamping portion 202, so that a state of clamping the metal plate material 10f and the second metal plate material 30f by the clamping portion 202 is not unintentionally released, and a stable clamping state can be achieved.

Further, a plurality of metal plate materials are laminated in the plate thickness direction D, and the interlocking portion 16f interlocks in the plate thickness direction D from the laminated second metal plate material 30f toward the metal plate material 10f. For this reason, a plurality of the metal plate material 10f and the second metal plate material 30f laminated are integrated by the interlocking portion 16f, and the jump-start terminal if having high rigidity can be formed with increased plate thickness as compared with a case where a jump-start terminal is formed of one sheet of a metal plate material.

Further, since the interlocking portion 16f that interlocks and integrates the laminated metal plate materials 10f and second metal plate material 30f functions as a locking portion, a clamping state of the clamp 201 can be stabilized with respect to the laminated and integrated metal plate materials 10f and second metal plate material 30f without provision of a separate locking portion.

Further, one of a plurality of laminated metal plate materials is the metal plate material 10f, another metal plate material is the second metal plate material 30f, the second metal plate material 30f is shorter than the metal plate material 10f, and the second metal plate material 30f is laminated on the clamped portion 20f clamped by the clamping portion 202 in the metal plate material 10f. For this reason, the jump-start terminal if that can be stably clamped by the clamping portion 202 can be reduced in weight as compared with a case where the second metal plate material 30f is laminated on the entire metal plate material 10f. Further, a step portion formed by the second metal plate material 30f shorter than the metal plate material 10f can also function as the interlocking portion 16f.

Note that in the interlocking portion 16f, as described above, two of the interlocking portions 16f arranged at a predetermined interval in the width direction W interlock in a manner protruding to the back surface side Db of the terminal main body portion 11, but the interlocking portion 16f may interlock in a manner protruding to the front surface side Df, or the interlocking portions 16f may interlock in a manner that one of two of the interlocking portions 16f protrudes to the back surface side Db and the other protrudes to the front surface side Df. Furthermore, a plurality of two of the interlocking portions 16f arranged at a predetermined interval in the width direction W may be arranged at a predetermined interval in the protruding direction H.

Further, the second metal plate material 30f may be laminated on the back surface side Db of the metal plate material 10f to be integrated.

### Eighth Embodiment

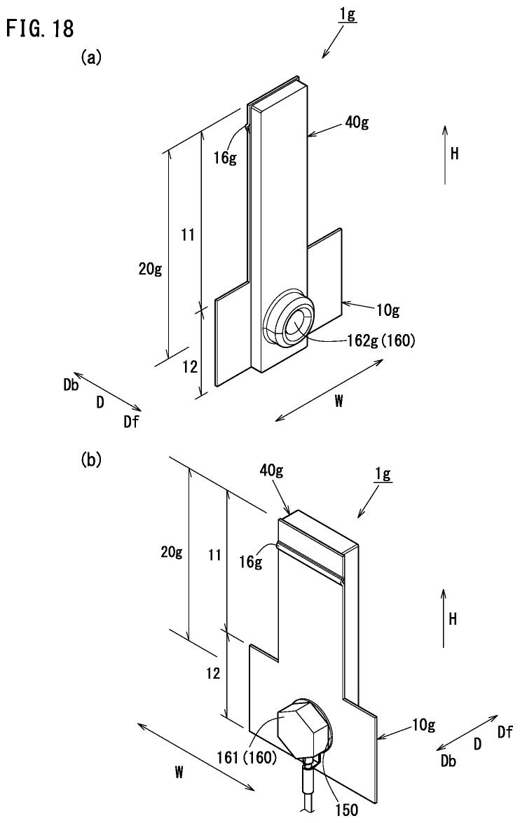

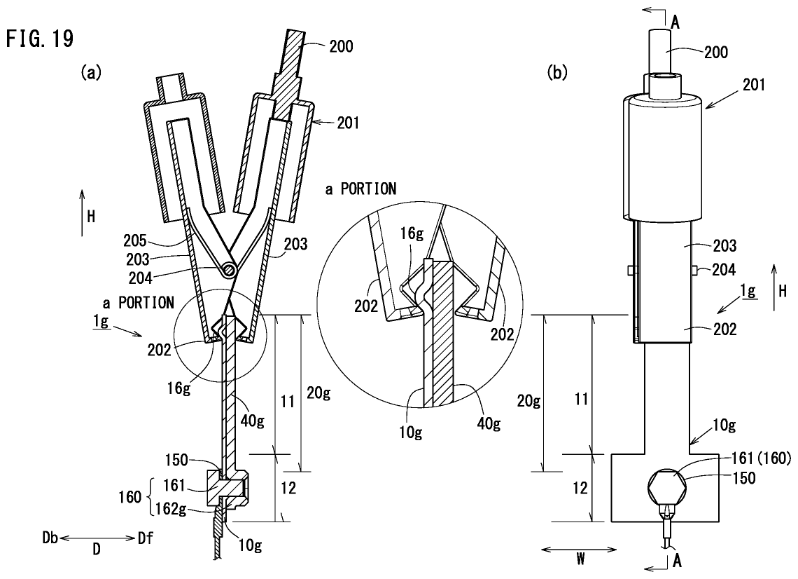

Subsequently, a jump-start terminal 1g of an eighth embodiment will be described in detail below together with FIGS. 18 and 19.

FIGS. 18 and 19 are explanatory views of the jump-start terminal 1g of the eighth embodiment. Specifically, FIG. 18(a) is a diagram illustrating a front view, a left side view, and a plan view of the jump-start terminal 1g, FIG. 18(b) is a diagram illustrating a rear view, a left side view, and a plan view of the jump-start terminal 1g, FIG. 19(a) is a cross-sectional view taken along A-A of FIG. 19(b) of the jump-start terminal 1g in a state of being clamped by the clamping portion 202, and FIG. 19(b) is a front view of the jump-start terminal 1g in the same state.

The jump-start terminal 1g of the eighth embodiment illustrated in FIGS. 18 and 19 includes a metal plate material 10g described above and a thick plate nut 40g.

Specifically, the jump-start terminal 1g includes the metal plate material 10g formed in a substantially inverted T shape including the terminal main body portion 11 and the mounting base portion 12, and a thick plate nut 40g having a nut portion 162g.

The metal plate material 10g is formed in a substantially inverted T shape with the terminal main body portion 11 extending in the protruding direction H and the mounting base portion 12 extending in the width direction W on the base end side of the terminal main body portion 11, and a bolt hole is provided near the center in the protruding direction H of the mounting base portion 12. In the present embodiment, the metal plate material 10g is a plate material made from a copper alloy having thickness of about 1 mm.

In the metal plate material 10g, a bead 16g is provided in a clamped portion 20g on the tip side in the protruding direction H of the terminal main body portion 11.

The bead 16g is formed so as to be extruded in a semicircular shape in the plate thickness direction D and extend in the width direction W in the clamped portion 20g on the tip side in the protruding direction H in the terminal main body portion 11 formed of the metal plate material 10g, and is a bead protruding to the front surface side Df with respect to a main surface of the terminal main body portion 11. Note that the bead 16g is formed by a protrusion amount of about plate thickness of a thick plate nut 40g described later.

The thick plate nut 40g has a band shape formed to have the same width as the terminal main body portion 11 of the metal plate material 10g, and is formed to have the same length as length in the protruding direction H of the terminal main body portion 11 and the mounting base portion 12, and has the nut portion 162g provided at a position corresponding to a bolt hole in the metal plate material 10g. The nut portion 162g is provided in a manner protruding from a main surface on the front surface side Df of the thick plate nut 40g, and is provided with a screw hole into which the fixing bolt 161 for fixing the power supply input terminal 150 is provided at the center in a front view.

The thick plate nut 40g is formed of a metal thick plate material thicker than the metal plate material 10g. Specifically, in the present embodiment, for the metal plate material 10g which is a plate material made from a copper alloy having thickness of about 1 mm, the thick plate nut 40g is a plate material made from a carbon steel alloy having thickness of about 3 mm.

The clamped portion 20g having the bead 16g provided on the metal plate material 10g laminated on the thick plate nut 40g is formed to have predetermined thickness including the bead 16g.

In the jump-start terminal 1g configured as described above, the thick plate nut 40g is arranged on the front surface side Df of the metal plate material 10g. At this time, the thick plate nut 40g is arranged in a manner that the nut portion 162g of the thick plate nut 40g communicates with a bolt hole of the mounting base portion 12. Then, the power supply input terminal 150 is arranged with respect to the bolt hole, a shaft portion of the fixing bolt 161 is inserted into the bolt hole and the power supply input terminal 150, and the nut portion 162g is screwed with the fixing bolt 161 on the opposite side, so that the power supply input terminal 150 can be attached and fixed to the jump-start terminal 1.

Similarly to the jump-start terminal 1 and the like described above, the jump-start terminal 1g configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20g penetrates the base portion 103 and protrudes in the protruding direction H from the base portion 103.

Then, as described above, in the jump-start terminal 1g held by the terminal holder 110, the clamped portion 20g is exposed as the terminal cover 111 is opened, and the clamped portion 20g of the jump-start terminal 1g can be clamped by the clamping portion 202 of the clamp 201. At this time, as illustrated in FIG. 19(a), the clamping portion 202 clamps in a manner sandwiching the terminal main body portion 11 of the metal plate material 10g and the thick plate nut 40g together.

As described above, the above-described jump-start terminal 1g in which the bead 16g for locking the clamping portion 202 that performs clamping is provided in a manner protruding from a main surface of the metal plate material 10g can achieve the same main effect as the main effect of the jump-start terminal 1 of the first embodiment.

More specifically, in the jump-start terminal 1g formed of the metal plate material 10g, since the bead 16g for locking the clamping portion 202 that performs clamping is provided in a manner protruding from a main surface of the metal plate material 10g, a clamping state of the clamp 201 can be stabilized with respect to the metal plate material 10g. For this reason, it is possible to stably perform conduction via the jump-start terminal 1g clamped by the clamp 201.

Furthermore, since the clamped portion 20g to be clamped by the clamping portion 202 in the jump-start terminal 1g can be clearly indicated by the bead 16g, a worker can reliably clamp the clamped portion 20g to be clamped by the clamping portion 202 without making a mistake, and the clamp 201 can be stably clamped to the metal plate material 10g.

Note that in the jump-start terminal 1g, the bead 16g is provided so as to stabilize a clamping state of the clamp 201 with respect to the metal plate material 10g. However, the configuration may be such that, instead of the bead 16g, the tip bent portion 14, the folded piece 16b, or a longitudinal bead 16i or a lattice bead 16j to be described later is provided on the metal plate material 10g so as to stabilize a clamping state of the clamp 201 with respect to the metal plate material 10g.

Further, by setting thickness of the clamped portion 20g clamped by the clamping portion 202 to predetermined thickness, durability can be improved as compared with a case where a bus bar holding portion made from resin is included, and the clamping portion 202 can clamp the clamped portion 20g of the metal plate material 10g with required clamping force. Therefore, it is possible to stably perform conduction by clamping with the clamp 201.

Further, the jump-start terminal 1g can ensure strength in the plate thickness direction D of the metal plate material 10g by the thick plate nut 40g reinforcing the protruding direction H of the metal plate material 10g connected to an electric circuit. Therefore, even the jump-start terminal 1g formed of the metal plate material 10g not including a resin member has strength in the plate thickness direction D, and a clamping state by the clamp 201 is stabilized, so that conduction can be stably performed.

Further, in the thick plate nut 40g, the nut portion 162g to which the fixing bolt 161 for fixing the power supply input terminal 150 connected to an electric circuit is fastened is provided on the base end side in the protruding direction H where the metal plate material 10g protrudes. For this reason, the thick plate nut 40g laminated on the metal plate material 10g can function as a nut for screwing and connecting the fixing bolt 161 for fixing the power supply input terminal 150 connected to an electric circuit, and the power supply input terminal 150 can be stably connected to the jump-start terminal 1g.

Further, since another piece, the thick plate nut 40g, is laminated on the clamped portion 20g having the bead 16g in the metal plate material 10g to form predetermined thickness, it is possible to stably perform conduction by clamping with the clamp 201.

More specifically, since the metal plate material 10g having the bead 16g and the thick plate nut 40g are laminated, thickness of the clamped portion 20g clamped by the clamping portion 202 can be set to predetermined thickness, and the clamping portion 202 can clamp the clamped portion 20g of the metal plate material 10g with required clamping force.

Further, since the thick plate nut 40g has plate thickness thicker than that of the metal plate material 10g, the jump-start terminal 1g having higher rigidity than a case where the metal plate materials 10g having the same thickness are laminated can be formed.

Further, the thick plate nut 40g having plate thickness thicker than that of the metal plate material 10g absorbs heat of the metal plate material 10g, and an entire heat generation amount can be adjusted.

Further, since another piece, the thick plate nut 40g, is laminated on the metal plate material 10g, and the laminated thick plate nut 40g is a metal thick plate material having the nut portion 162g, strength in the plate thickness direction D can be improved by laminating the thick plate nut 40g functioning as a reinforcing portion as compared with one sheet of the metal plate material 10g. Further, since the thick plate nut 40g is laminated on the metal plate material 10g, power can be stably supplied.

More specifically, by setting thickness of the clamped portion 20g clamped by the clamping portion 202 to predetermined thickness, durability can be improved as compared with a case where a bus bar holding portion made from resin is included, and the clamping portion 202 can clamp the clamped portion 20g of the metal plate material 10g with required clamping force. Therefore, it is possible to stably perform conduction by clamping with the clamp 201.

Further, in the jump-start terminal 1g formed of the metal plate material 10g, since the bead 16g for locking the clamping portion 202 that performs clamping is provided in a manner protruding from a main surface of the metal plate material 10g, a clamping state of the clamp 201 can be stabilized with respect to the metal plate material 10g. For this reason, it is possible to stably perform conduction via the jump-start terminal 1g clamped by the clamp 201.

Furthermore, since the clamped portion 20g to be clamped by the clamping portion 202 in the jump-start terminal 1g can be clearly indicated by the bead 16g, a worker can reliably clamp the clamped portion 20g to be clamped by the clamping portion 202 without making a mistake, and the clamp 201 can be stably clamped to the metal plate material 10g.

Note that in the jump-start terminal 1g, the bead 16g is provided so as to stabilize a clamping state of the clamp 201 with respect to the metal plate material 10g. However, the configuration may be such that, instead of the bead 16g, the tip bent portion 14, the folded piece 16b, or a longitudinal bead 16i or a lattice bead 16j to be described later is provided on the metal plate material 10g so as to stabilize a clamping state of the clamp 201 with respect to the metal plate material 10g.

Further, the jump-start terminal 1g can ensure strength in the plate thickness direction D of the metal plate material 10g by the thick plate nut 40g reinforcing the protruding direction H of the metal plate material 10g connected to an electric circuit. Therefore, even the jump-start terminal 1g formed of the metal plate material 10g not including a resin member has strength in the plate thickness direction D, and a clamping state by the clamp 201 is stabilized, so that conduction can be stably performed.

Further, since another piece, the thick plate nut 40g, is laminated on the clamped portion 20g having the bead 16g in the metal plate material 10g to form predetermined thickness, it is possible to stably perform conduction by clamping with the clamp 201.

More specifically, since the metal plate material 10g having the bead 16g and the thick plate nut 40g are laminated, thickness of the clamped portion 20g clamped by the clamping portion 202 can be set to predetermined thickness, and the clamping portion 202 can clamp the clamped portion 20g of the metal plate material 10g with required clamping force.

Further, since the thick plate nut 40g has plate thickness thicker than that of the metal plate material 10g, the jump-start terminal 1g having higher rigidity than a case where the metal plate materials 10g having the same thickness are laminated can be formed.

Further, the thick plate nut 40g having plate thickness thicker than that of the metal plate material 10g absorbs heat of the metal plate material 10g, and an entire heat generation amount can be adjusted.

Further, in the thick plate nut 40g, the nut portion 162g to which the fixing bolt 161 for fixing the power supply input terminal 150 connected to an electric circuit is fastened is provided on the base end side in the protruding direction H where the metal plate material 10g protrudes. For this reason, the thick plate nut 40g laminated on the metal plate material 10g can function as a nut for screwing and connecting the fixing bolt 161 for fixing the power supply input terminal 150 connected to an electric circuit, and the power supply input terminal 150 can be stably connected to the jump-start terminal 1g.

Further, since another piece, the thick plate nut 40g, is laminated on the metal plate material 10g, and the laminated thick plate nut 40g is a metal thick plate material having the nut portion 162g, strength in the plate thickness direction D can be improved by laminating the thick plate nut 40g functioning as a reinforcing portion as compared with one sheet of the metal plate material 10g. Further, since the thick plate nut 40g is laminated on the metal plate material 10g, power can be stably supplied.

More specifically, the jump-start terminal 1g can ensure strength in the plate thickness direction D of the metal plate material 10g by the thick plate nut 40g reinforcing the protruding direction H of the metal plate material 10g connected to an electric circuit. Therefore, even the jump-start terminal 1g formed of the metal plate material 10g not including a resin member has strength in the plate thickness direction D, and a clamping state by the clamp 201 is stabilized, so that conduction can be stably performed.

Further, in the jump-start terminal 1g formed of the metal plate material 10g, since the bead 16g for locking the clamping portion 202 that performs clamping is provided in a manner protruding from a main surface of the metal plate material 10g, a clamping state of the clamp 201 can be stabilized with respect to the metal plate material 10g. For this reason, it is possible to stably perform conduction via the jump-start terminal 1g clamped by the clamp 201.

Furthermore, since the clamped portion 20g to be clamped by the clamping portion 202 in the jump-start terminal 1g can be clearly indicated by the bead 16g, a worker can reliably clamp the clamped portion 20g to be clamped by the clamping portion 202 without making a mistake, and the clamp 201 can be stably clamped to the metal plate material 10g.

Note that in the jump-start terminal 1g, the bead 16g is provided so as to stabilize a clamping state of the clamp 201 with respect to the metal plate material 10g. However, the configuration may be such that, instead of the bead 16g, the tip bent portion 14, the folded piece 16b, or a longitudinal bead 16i or a lattice bead 16j to be described later is provided on the metal plate material 10g so as to stabilize a clamping state of the clamp 201 with respect to the metal plate material 10g.

Further, by setting thickness of the clamped portion 20g clamped by the clamping portion 202 to predetermined thickness, durability can be improved as compared with a case where a bus bar holding portion made from resin is included, and the clamping portion 202 can clamp the clamped portion 20g of the metal plate material 10g with required clamping force. Therefore, it is possible to stably perform conduction by clamping with the clamp 201.

Further, since another piece, the thick plate nut 40g, is laminated on the metal plate material 10g, and the laminated thick plate nut 40g is a metal thick plate material having the nut portion 162g, strength in the plate thickness direction D can be improved by laminating the thick plate nut 40g functioning as a reinforcing portion as compared with one sheet of the metal plate material 10g. Further, since the thick plate nut 40g is laminated on the metal plate material 10g, power can be stably supplied.

Further, since the thick plate nut 40g is a metal thick plate material having the nut portion 162g having plate thickness thicker than that of the metal plate material 10g, the jump-start terminal 1g having higher rigidity than a case where thick plate nuts having the same thickness as the metal plate material 10g are laminated can be formed.

Further, the thick plate nut 40g having plate thickness thicker than that of the metal plate material 10g absorbs heat of the metal plate material 10g, and an entire heat generation amount can be adjusted.

Further, in the thick plate nut 40g, the nut portion 162g to which the fixing bolt 161 for fixing the power supply input terminal 150 connected to an electric circuit is fastened is provided on the base end side in the protruding direction H where the metal plate material 10g protrudes. For this reason, the thick plate nut 40g laminated on the metal plate material 10g can function as a nut for screwing and connecting the fixing bolt 161 for fixing the power supply input terminal 150 connected to an electric circuit, and the power supply input terminal 150 can be stably connected to the jump-start terminal 1g.

Further, since another piece, the thick plate nut 40g, is laminated on the clamped portion 20g having the bead 16g in the metal plate material 10g to form predetermined thickness, it is possible to stably perform conduction by clamping with the clamp 201.

More specifically, since the metal plate material 10g having the bead 16g and the thick plate nut 40g are laminated, thickness of the clamped portion 20g clamped by the clamping portion 202 can be set to predetermined thickness, and the clamping portion 202 can clamp the clamped portion 20g of the metal plate material 10g with required clamping force.

### Ninth Embodiment

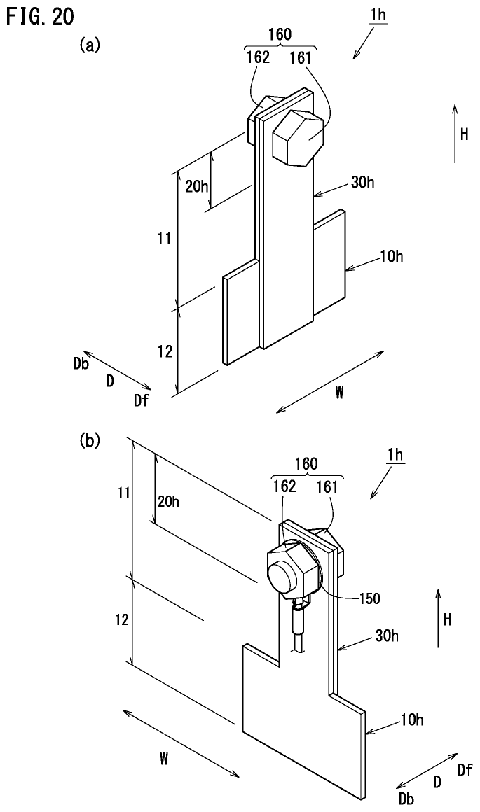

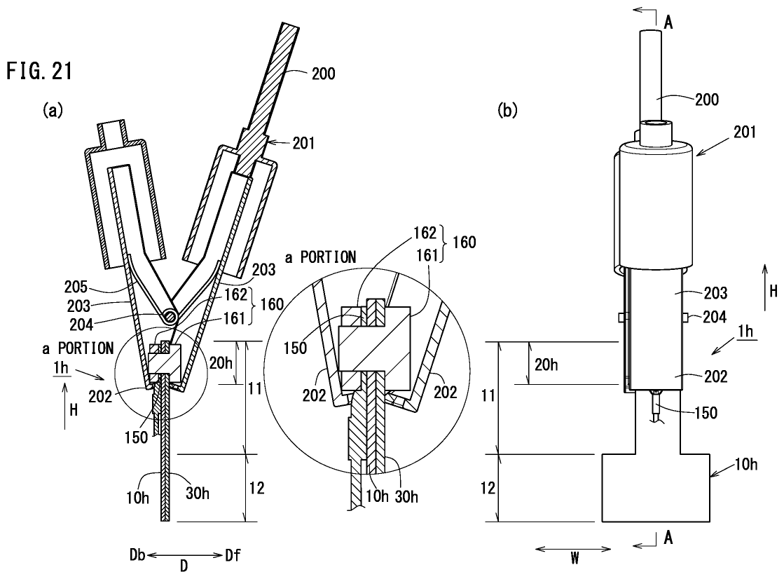

Subsequently, a jump-start terminal 1h of a ninth embodiment will be described in detail below together with FIGS. 20 and 21.

FIGS. 20 and 21 are explanatory views of the jump-start terminal 1h of the ninth embodiment. Specifically, FIG. 20(a) is a diagram illustrating a front view, a left side view, and a plan view of the jump-start terminal 1h, FIG. 20(b) is a diagram illustrating a rear view, a left side view, and a plan view of the jump-start terminal 1h, FIG. 21(a) is a cross-sectional view taken along A-A of FIG. 21(b) of the jump-start terminal 1h in a state of being clamped by the clamping portion 202, and FIG. 21(b) is a front view of the jump-start terminal 1h in the same state.

The jump-start terminal 1h of the ninth embodiment illustrated in FIGS. 20 and 21 is formed by laminating two sheets of metal plate materials.

Specifically, the jump-start terminal 1h is formed by laminating, in the plate thickness direction D, a metal plate material 10h formed in a substantially inverted T shape and formed of the terminal main body portion 11 and the mounting base portion 12 and a second metal plate material 30h formed separately.

The metal plate material 10h has the same configuration as the metal plate material 10g except that a bolt hole is provided in the clamped portion 20h on the tip side of the terminal main body portion 11, and the metal plate material 10h is a plate material made from a copper alloy having thickness of about 1 mm.

The second metal plate material 30h has the same configuration as that of the second metal plate material 30a except that a bolt hole is provided in the clamped portion 20h on the tip side similarly to the metal plate material 10h, and is formed of a metal thick plate material.

In the jump-start terminal 1h configured as described above, the fixing bolt 161 is arranged on the front surface side Df of the metal plate material 10h. At this time, the fixing bolt 161 is arranged such that a bolt hole provided in the clamped portion 20h on the tip side of the terminal main body portion 11 communicates with a bolt hole of the second metal plate material 30h. Then, the power supply input terminal 150 is arranged with respect to the bolt hole, a shaft portion of the fixing bolt 161 is inserted into the bolt hole and the power supply input terminal 150, and the nut 162 is screwed with the fixing bolt 161 on the opposite side, so that the power supply input terminal 150 can be attached and fixed to the jump-start terminal 1h.

Similarly to the jump-start terminal 1 and the like described above, the jump-start terminal 1h configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20h penetrates the base portion 103 and protrudes in the protruding direction H from the base portion 103.

Then, as described above, in the jump-start terminal 1h arranged along the terminal holder 110, the clamped portion 20h is exposed as the terminal cover 111 is opened, and the clamped portion 20h of the jump-start terminal 1h can be clamped by the clamping portion 202 of the clamp 201. At this time, as illustrated in FIG. 21(a), the clamping portion 202 clamps in a manner sandwiching the fastening body 160.

As described above, the above-described jump-start terminal 1h in which the fastening body 160 for locking the clamping portion 202 that performs clamping is provided in a manner protruding from a main surface of the metal plate material 10h can achieve the same main effect as the main effect of the jump-start terminal 1 of the first embodiment.

More specifically, in the jump-start terminal 1h formed of the metal plate material 10h, the fastening body 160 for locking the clamping portion 202 that performs clamping is provided in the clamped portion 20h of the metal plate material 10h. For this reason, a clamping state of the clamp 201 for clamping the clamped portion 20h can be stabilized with respect to the metal plate material 10h. For this reason, it is possible to stably perform conduction via the jump-start terminal 1h clamped by the clamp 201.

Furthermore, since the clamped portion 20h to be clamped by the clamping portion 202 in the jump-start terminal 1h can be clearly indicated by the fastening body 160, the worker can reliably clamp the clamped portion 20h to be clamped by the clamping portion 202 without making a mistake, and the clamp 201 can be stably clamped to the metal plate material 10h.

Further, by setting thickness of the clamped portion 20h clamped by the clamping portion 202 to predetermined thickness, durability can be improved as compared with a case where a bus bar holding portion made from resin is included, and the clamping portion 202 can clamp the clamped portion 20h of the metal plate material 10h with required clamping force. Therefore, it is possible to stably perform conduction by clamping with the clamp 201.

Further, since the fastening body 160 for fastening and fixing the power supply input terminal 150 connected to an electric circuit is provided on the tip side of the metal plate material 10h, the fastening body 160 for fixing the power supply input terminal 150 to the jump-start terminal 1h functions as a locking portion without a locking portion provided separately, and the clamping portion 202 that performs clamping the metal plate material 10h is locked to the fastening body 160, so that a stable clamping state can be maintained.

Further, since another piece, the second metal plate material 30h, is laminated on at least the clamped portion 20h in the metal plate material 10h, it is possible to stably perform conduction by clamping with the clamp 201.

More specifically, the metal plate material 10h and the second metal plate material 30h are laminated, the fastening body 160 is arranged in the clamped portion 20h clamped by the clamping portion 202 to have predetermined thickness, and the clamping portion 202 can clamp the clamped portion 20h of the metal plate material 10h with required clamping force.

Note that the second metal plate material 30h may be arranged on the front surface side Df of the metal plate material 10h and laminated.

More specifically, by setting thickness of the clamped portion 20h clamped by the clamping portion 202 to predetermined thickness, durability can be improved as compared with a case where a bus bar holding portion made from resin is included, and the clamping portion 202 can clamp the clamped portion 20h of the metal plate material 10h with required clamping force. Therefore, it is possible to stably perform conduction by clamping with the clamp 201.

Further, in the jump-start terminal 1h formed of the metal plate material 10h, the fastening body 160 for locking the clamping portion 202 that performs clamping is provided in the clamped portion 20h of the metal plate material 10h. For this reason, a clamping state of the clamp 201 for clamping the clamped portion 20h can be stabilized with respect to the metal plate material 10h. For this reason, it is possible to stably perform conduction via the jump-start terminal 1h clamped by the clamp 201.

Furthermore, since the clamped portion 20h to be clamped by the clamping portion 202 in the jump-start terminal 1h can be clearly indicated by the fastening body 160, the worker can reliably clamp the clamped portion 20h to be clamped by the clamping portion 202 without making a mistake, and the clamp 201 can be stably clamped to the metal plate material 10h.

Further, since another piece, the second metal plate material 30h, is laminated on at least the clamped portion 20h in the metal plate material 10h, it is possible to stably perform conduction by clamping with the clamp 201.

More specifically, the metal plate material 10h and the second metal plate material 30h are laminated, the fastening body 160 is arranged in the clamped portion 20h clamped by the clamping portion 202 to have predetermined thickness, and the clamping portion 202 can clamp the clamped portion 20h of the metal plate material 10h with required clamping force.

Further, since the fastening body 160 for fixing the power supply input terminal 150 connected to an electric circuit is provided in the clamped portion 20h and has predetermined thickness by the fastening body 160 provided in the clamped portion 20h, predetermined thickness can be secured by the fastening body 160 even if the metal plate material 10h is not formed to have predetermined thickness, and thus the clamp 201 can clamp the clamped portion 20h with required clamping force.

Note that the second metal plate material 30h may be arranged on the front surface side Df of the metal plate material 10h and laminated.

### Tenth Embodiment

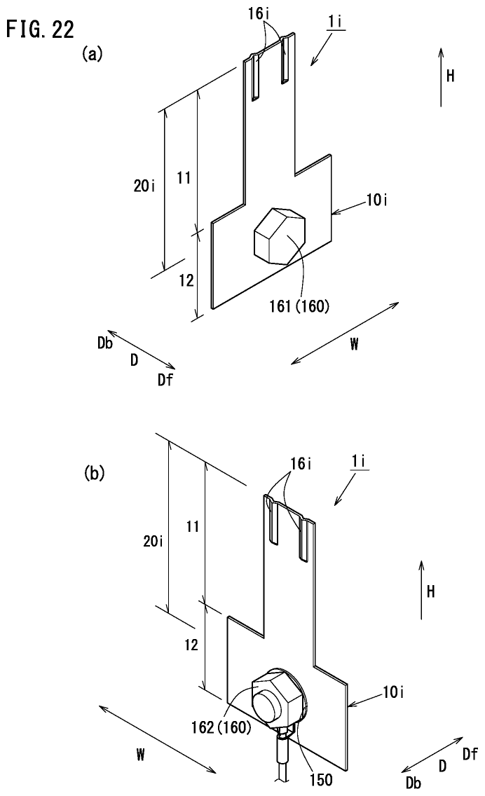

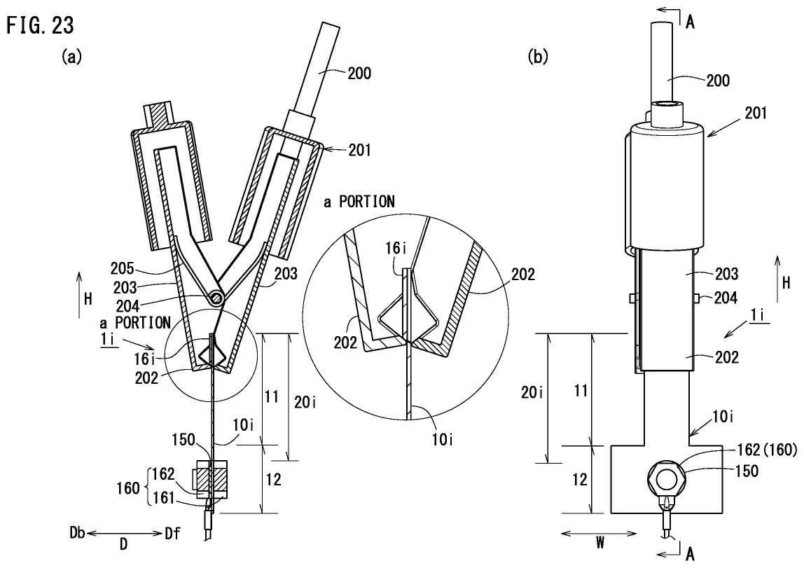

Subsequently, a jump-start terminal 1i of a tenth embodiment will be described in detail below together with FIGS. 22 and 23.

FIGS. 22 and 23 are explanatory views of the jump-start terminal 1i of the tenth embodiment. Specifically, FIG. 22(a) is a diagram illustrating a front view, a left side view, and a plan view of the jump-start terminal 1i, FIG. 22(b) is a diagram illustrating a rear view, a left side view, and a plan view of the jump-start terminal 1i, FIG. 23(a) is a cross-sectional view taken along A-A of FIG. 23(b) of the jump-start terminal 1i in a state of being clamped by the clamping portion 202, and FIG. 23(b) is a front view of the jump-start terminal 1i in the same state.

The jump-start terminal 1i of the tenth embodiment illustrated in FIGS. 22 and 23 is formed of a metal plate material 10i which is formed of the terminal main body portion 11 and the mounting base portion 12 and is formed in a substantially inverted T shape.

The metal plate material 10i is a plate material made from a copper alloy having thickness of about 1 mm. Unlike the metal plate material 10a in which the bead 16a is provided in the clamped portion 20i on the tip side in the protruding direction H, the metal plate material 10i has two of the longitudinal beads 16i along the protruding direction H arranged at a predetermined interval in the width direction W in the clamped portion 20i on the tip side.

The longitudinal bead 16i is formed so as to be extruded in a semicircular shape in the plate thickness direction D and extend in the protruding direction H in the clamped portion 20i on the tip side in the protruding direction H in the terminal main body portion 11 formed of the metal plate material 10i, and is a bead protruding to the back surface side Db with respect to a main surface of the terminal main body portion 11. Note that the longitudinal bead 16i is formed with a protrusion amount of about two to four times the plate thickness of the metal plate material 10i.

Similarly to the jump-start terminal 1 and the like described above, the jump-start terminal 1i configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20i penetrates the base portion 103 and protrudes in the protruding direction H from the base portion 103.

Then, as described above, in the jump-start terminal 1i arranged along the terminal holder 110, the clamped portion 20i is exposed as the terminal cover 111 is opened, and the clamped portion 20i of the jump-start terminal 1i can be clamped by the clamping portion 202 of the clamp 201. At this time, as illustrated in FIG. 23(a), the clamping portion 202 clamps in a manner sandwiching a lower portion of the longitudinal bead 16i.

As described above, the above-described jump-start terminal 1i in which the longitudinal bead 16i for locking the clamping portion 202 that performs clamping is provided in a manner protruding from a main surface of the metal plate material 10i can achieve the same main effect as the main effect of the jump-start terminal 1 of the first embodiment.

Further, in the jump-start terminal 1i formed of the metal plate material 10i, since the longitudinal bead 16i for locking the clamping portion 202 that performs clamping is provided in a manner protruding from a main surface of the metal plate material 10i, a clamping state of the clamp 201 can be stabilized with respect to the metal plate material 10i. For this reason, it is possible to stably perform conduction via the jump-start terminal 1i clamped by the clamp 201.

Furthermore, since the clamped portion 20i to be clamped by the clamping portion 202 in the jump-start terminal 1i can be clearly indicated by the longitudinal bead 16i, a worker can reliably clamp the clamped portion 20i to be clamped by the clamping portion 202 without making a mistake, and the clamp 201 can be stably clamped to the metal plate material 10i.

Further, by setting thickness of the clamped portion 20i clamped by the clamping portion 202 to predetermined thickness, durability can be improved as compared with a case where a bus bar holding portion made from resin is included, and the clamping portion 202 can clamp the clamped portion 20i of the metal plate material 10i with required clamping force. Therefore, it is possible to stably perform conduction by clamping with the clamp 201.

Further, the jump-start terminal 1i can ensure strength in the plate thickness direction D of the metal plate material 10i by the longitudinal bead 16i reinforcing the protruding direction H of the metal plate material 10i connected to an electric circuit. Therefore, even the jump-start terminal 1i formed of the metal plate material 10i not including a resin member has strength in the plate thickness direction D, and a clamping state by the clamp 201 is stabilized, so that conduction can be stably performed.

Further, since the longitudinal bead 16i is formed along the protruding direction H, rigidity along the protruding direction H of the metal plate material 10i, that is, in the plate thickness direction D can be improved, and the longitudinal bead 16i formed along the protruding direction H can bite into and be locked to a tip of the clamping portion 202, and a stable clamping state can be obtained.

Further, in the electrical connection box 100, a hole through which the longitudinal bead 16i passes is required when the jump-start terminal 1i is arranged to penetrate a part of the base portion 103. However, a hole for the longitudinal bead 16i having an uneven shape extending in the protruding direction H to pass through the base portion 103 can be made smaller than a hole for the longitudinal bead 16i having an uneven shape extending in the width direction W to pass through, and the jump-start terminal 1i can be stably attached to the base portion 103.

Further, since the clamped portion 20i has the longitudinal bead 16i formed along the protruding direction H, even if the metal plate material 10i is thinner than predetermined thickness, the predetermined thickness can be secured by the longitudinal bead 16i along the protruding direction H.

Further, even when a clamped position in the protruding direction H in the metal plate material 10i by the clamping portion 202 is shifted, predetermined thickness can be secured.

Note that the longitudinal beads 16i may be formed so as to protrude to the front surface side Df, or one of two of the longitudinal beads 16i may be formed so as to protrude to the back surface side Db, and the other one of the longitudinal beads 16i may be formed so as to protrude to the front surface side Df.

More specifically, by setting thickness of the clamped portion 20i clamped by the clamping portion 202 to predetermined thickness, durability can be improved as compared with a case where a bus bar holding portion made from resin is included, and the clamping portion 202 can clamp the clamped portion 20i of the metal plate material 10i with required clamping force. Therefore, it is possible to stably perform conduction by clamping with the clamp 201.

Further, in the jump-start terminal 1i formed of the metal plate material 10i, since the longitudinal bead 16i for locking the clamping portion 202 that performs clamping is provided in a manner protruding from a main surface of the metal plate material 10i, a clamping state of the clamp 201 can be stabilized with respect to the metal plate material 10i. For this reason, it is possible to stably perform conduction via the jump-start terminal 1i clamped by the clamp 201.

Furthermore, since the clamped portion 20i to be clamped by the clamping portion 202 in the jump-start terminal 1i can be clearly indicated by the longitudinal bead 16i, a worker can reliably clamp the clamped portion 20i to be clamped by the clamping portion 202 without making a mistake, and the clamp 201 can be stably clamped to the metal plate material 10i.

Further, the jump-start terminal 1i can ensure strength in the plate thickness direction D of the metal plate material 10i by the longitudinal bead 16i reinforcing the protruding direction H of the metal plate material 10i connected to an electric circuit. Therefore, even the jump-start terminal 1i formed of the metal plate material 10i not including a resin member has strength in the plate thickness direction D, and a clamping state by the clamp 201 is stabilized, so that conduction can be stably performed.

Further, since the clamped portion 20i has the longitudinal bead 16i formed along the protruding direction H, even if the metal plate material 10i is thinner than predetermined thickness, the predetermined thickness can be secured by the longitudinal bead 16i along the protruding direction H.

Further, even when a clamped position in the protruding direction H in the metal plate material 10i by the clamping portion 202 is shifted, predetermined thickness can be secured.

Further, since the longitudinal bead 16i is formed along the protruding direction H, rigidity along the protruding direction H of the metal plate material 10i, that is, in the plate thickness direction D can be improved, and the longitudinal bead 16i formed along the protruding direction H can bite into and be locked to a tip of the clamping portion 202, and a stable clamping state can be obtained.

Further, in the electrical connection box 100, a hole through which the longitudinal bead 16i passes is required when the jump-start terminal 1i is arranged to penetrate a part of the base portion 103. However, a hole for the longitudinal bead 16i having an uneven shape extending in the protruding direction H to pass through the base portion 103 can be made smaller than a hole for the longitudinal bead 16i having an uneven shape extending in the width direction W to pass through, and the jump-start terminal 1i can be stably attached to the base portion 103.

Note that the longitudinal beads 16i may be formed so as to protrude to the front surface side Df, or one of two of the longitudinal beads 16i may be formed so as to protrude to the back surface side Db, and the other one of the longitudinal beads 16i may be formed so as to protrude to the front surface side Df.

More specifically, the jump-start terminal 1i can ensure strength in the plate thickness direction D of the metal plate material 10i by the longitudinal bead 16i reinforcing the protruding direction H of the metal plate material 10i connected to an electric circuit. Therefore, even the jump-start terminal 1i formed of the metal plate material 10i not including a resin member has strength in the plate thickness direction D, and a clamping state by the clamp 201 is stabilized, so that conduction can be stably performed.

Further, in the jump-start terminal 1i formed of the metal plate material 10i, since the longitudinal bead 16i for locking the clamping portion 202 that performs clamping is provided in a manner protruding from a main surface of the metal plate material 10i, a clamping state of the clamp 201 can be stabilized with respect to the metal plate material 10i. For this reason, it is possible to stably perform conduction via the jump-start terminal 1i clamped by the clamp 201.

Furthermore, since the clamped portion 20i to be clamped by the clamping portion 202 in the jump-start terminal 1i can be clearly indicated by the longitudinal bead 16i, a worker can reliably clamp the clamped portion 20i to be clamped by the clamping portion 202 without making a mistake, and the clamp 201 can be stably clamped to the metal plate material 10i.

Further, by setting thickness of the clamped portion 20i clamped by the clamping portion 202 to predetermined thickness, durability can be improved as compared with a case where a bus bar holding portion made from resin is included, and the clamping portion 202 can clamp the clamped portion 20i of the metal plate material 10i with required clamping force. Therefore, it is possible to stably perform conduction by clamping with the clamp 201.

Further, since the longitudinal bead 16i is formed along the protruding direction H, rigidity along the protruding direction H of the metal plate material 10i, that is, in the plate thickness direction D can be improved, and the longitudinal bead 16i formed along the protruding direction H can bite into and be locked to a tip of the clamping portion 202, and a stable clamping state can be obtained.

Further, in the electrical connection box 100, a hole through which the longitudinal bead 16i passes is required when the jump-start terminal 1i is arranged to penetrate a part of the base portion 103. However, a hole for the longitudinal bead 16i having an uneven shape extending in the protruding direction H to pass through the base portion 103 can be made smaller than a hole for the longitudinal bead 16i having an uneven shape extending in the width direction W to pass through, and the jump-start terminal 1i can be stably attached to the base portion 103.

Further, since the clamped portion 20i has the longitudinal bead 16i formed along the protruding direction H, even if the metal plate material 10i is thinner than predetermined thickness, the predetermined thickness can be secured by the longitudinal bead 16i along the protruding direction H.

Further, even when a clamped position in the protruding direction H in the metal plate material 10i by the clamping portion 202 is shifted, predetermined thickness can be secured.

Note that the longitudinal beads 16i may be formed so as to protrude to the front surface side Df, or one of two of the longitudinal beads 16i may be formed so as to protrude to the back surface side Db, and the other one of the longitudinal beads 16i may be formed so as to protrude to the front surface side Df.

### Eleventh Embodiment

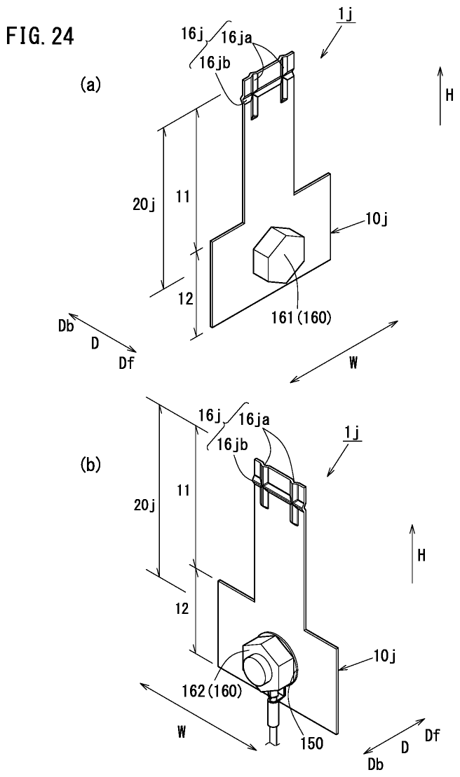

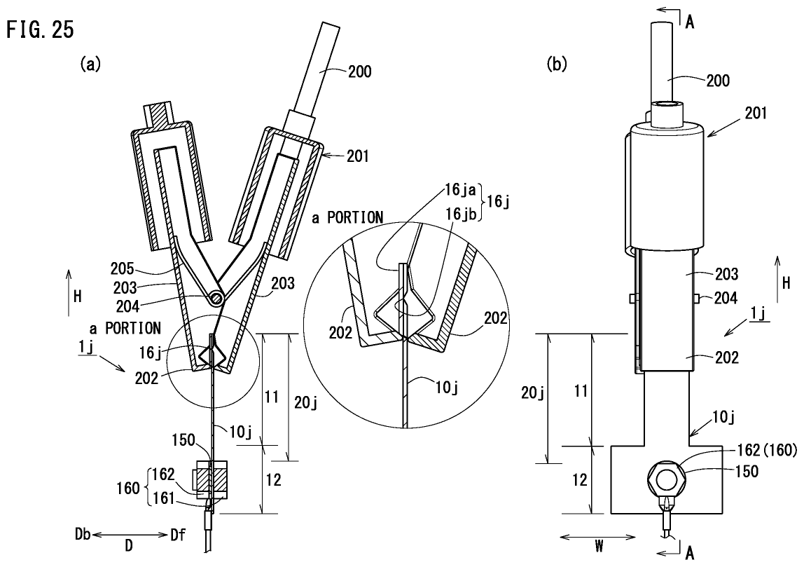

Subsequently, a jump-start terminal 1j of an eleventh embodiment will be described in detail below together with FIGS. 24 and 25.

FIGS. 24 and 25 are explanatory views of the jump-start terminal 1j of the eleventh embodiment. Specifically, FIG. 24(a) is a diagram illustrating a front view, a left side view, and a plan view of the jump-start terminal 1j, FIG. 24(b) is a diagram illustrating a rear view, a left side view, and a plan view of the jump-start terminal 1j, FIG. 25(a) is a cross-sectional view taken along A-A of FIG. 25(b) of the jump-start terminal 1j in a state of being clamped by the clamping portion 202, and FIG. 25(b) is a front view of the jump-start terminal 1j in the same state.

The jump-start terminal 1j of the eleventh embodiment illustrated in FIGS. 24 and 25 is formed of a metal plate material 10j which is formed of the terminal main body portion 11 and the mounting base portion 12 and is formed in a substantially inverted T shape.

The metal plate material 10j is a plate material made from a copper alloy having thickness of about 1 mm.

Unlike the metal plate material 10i in which two longitudinal beads 16i along the protruding direction H are arranged at a predetermined interval in the width direction W in a clamped portion 20j on the tip side in the protruding direction H, the metal plate material 10j includes a lattice bead 16j constituted by two longitudinal beads 16ja along the protruding direction H and a lattice bead 16jb in the width direction W in the clamped portion 20j on the tip side.

The longitudinal bead 16ja and the lateral bead 16jb constituting the lattice bead 16j are formed by being extruded in a semicircular shape in the plate thickness direction D in the clamped portion 20j on the tip side in the protruding direction H in the terminal main body portion 11 formed of the metal plate material 10j, and are beads protruding to the back surface side Db with respect to a main surface of the terminal main body portion 11.

Two of the longitudinal beads 16ja constituting the lattice bead 16j are formed to extend along the protruding direction H, and are arranged at a predetermined interval in the width direction W. The lateral bead 16jb constituting the lattice beads 16j is formed to extend along the width direction W and intersect the longitudinal beads 16ja arranged at a predetermined interval in the width direction W.

Note that the longitudinal bead 16ja and the lateral bead 16jb are formed to have a protrusion amount of about two to four times the plate thickness of the metal plate material 10j.

Similarly to the jump-start terminal 1 and the like described above, the jump-start terminal 1j configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20j penetrates the base portion 103 and protrudes in the protruding direction H from the base portion 103.

Then, as described above, in the jump-start terminal 1j arranged along the terminal holder 110, the clamped portion 20j is exposed as the terminal cover 111 is opened, and the clamped portion 20j of the jump-start terminal 1j can be clamped by the clamping portion 202 of the clamp 201. At this time, as illustrated in FIG. 25(a), the clamping portion 202 clamps in a manner sandwiching a lower portion of the longitudinal bead 16ja and the lattice bead 16jb constituting the lattice beads 16j.

As described above, the above-described jump-start terminal 1j in which the lattice bead 16j for locking the clamping portion 202 that performs clamping is provided in a manner protruding from a main surface of the metal plate material 10j can achieve the same main effect as the main effect of the jump-start terminal 1 of the first embodiment.

Further, in the jump-start terminal 1j formed of the metal plate material 10j, since the lattice bead 16j for locking the clamping portion 202 that performs clamping is provided in a manner protruding from a main surface of the metal plate material 10j, a clamping state of the clamp 201 can be stabilized with respect to the metal plate material 10j. For this reason, it is possible to stably perform conduction via the jump-start terminal 1j clamped by the clamp 201.

Furthermore, since the clamped portion 20j to be clamped by the clamping portion 202 in the jump-start terminal 1j can be clearly indicated by the lattice bead 16j, a worker can reliably clamp the clamped portion 20j to be clamped by the clamping portion 202 without making a mistake, and the clamp 201 can be stably clamped to the metal plate material 10j.

Further, by setting thickness of the clamped portion 20j clamped by the clamping portion 202 to predetermined thickness by forming the lattice bead 16j, durability can be improved as compared with a case where a bus bar holding portion made from resin is included, and the clamping portion 202 can clamp the clamped portion 20j of the metal plate material 10j with required clamping force. Therefore, it is possible to stably perform conduction by clamping with the clamp 201.

Further, the jump-start terminal 1j can ensure strength in the plate thickness direction D of the metal plate material 10j by the longitudinal bead 16ja reinforcing the protruding direction H of the metal plate material 10j connected to an electric circuit. Therefore, even the jump-start terminal 1j formed of the metal plate material 10j not including a resin member has strength in the plate thickness direction D, and a clamping state by the clamp 201 is stabilized, so that conduction can be stably performed.

Further, since the longitudinal bead 16ja of the lattice bead 16j is formed along the protruding direction H, rigidity along the protruding direction H of the metal plate material 10j, that is, in the plate thickness direction D can be improved, and the lattice bead 16j formed along the protruding direction H can bite into and be locked to a tip of the clamping portion 202, and a stable clamping state can be obtained.

Further, since the clamped portion 20j is the lattice bead 16j formed along the protruding direction H, even if the metal plate material 10j is thinner than predetermined thickness, the predetermined thickness can be secured by the longitudinal bead 16ja along the protruding direction H.

Further, even when a clamped position in the protruding direction H in the metal plate material 10j by the clamping portion 202 is shifted, predetermined thickness can be secured.

Note that the lattice bead 16j may be formed so as to protrude to the front surface side Df, or one of two of the longitudinal beads 16ja may be formed so as to protrude to the back surface side Db, and the other one of the longitudinal beads 16ja may be formed so as to protrude to the front surface side Df.

Further, one of the longitudinal bead 16ja and the lateral bead 16jb constituting the lattice bead 16j may be formed so as to protrude to the back surface side Db, and the other may be formed so as to protrude to the front surface side Df.

More specifically, by setting thickness of the clamped portion 20j clamped by the clamping portion 202 to predetermined thickness by forming the lattice bead 16j, durability can be improved as compared with a case where a bus bar holding portion made from resin is included, and the clamping portion 202 can clamp the clamped portion 20j of the metal plate material 10j with required clamping force. Therefore, it is possible to stably perform conduction by clamping with the clamp 201.

Further, in the jump-start terminal 1j formed of the metal plate material 10j, since the lattice bead 16j for locking the clamping portion 202 that performs clamping is provided in a manner protruding from a main surface of the metal plate material 10j, a clamping state of the clamp 201 can be stabilized with respect to the metal plate material 10j. For this reason, it is possible to stably perform conduction via the jump-start terminal 1j clamped by the clamp 201.

Furthermore, since the clamped portion 20j to be clamped by the clamping portion 202 in the jump-start terminal 1j can be clearly indicated by the lattice bead 16j, a worker can reliably clamp the clamped portion 20j to be clamped by the clamping portion 202 without making a mistake, and the clamp 201 can be stably clamped to the metal plate material 10j.

Further, the jump-start terminal 1j can ensure strength in the plate thickness direction D of the metal plate material 10j by the longitudinal bead 16ja reinforcing the protruding direction H of the metal plate material 10j connected to an electric circuit. Therefore, even the jump-start terminal 1j formed of the metal plate material 10j not including a resin member has strength in the plate thickness direction D, and a clamping state by the clamp 201 is stabilized, so that conduction can be stably performed.

Further, since the clamped portion 20j is the lattice bead 16j formed along the protruding direction H, even if the metal plate material 10j is thinner than predetermined thickness, the predetermined thickness can be secured by the longitudinal bead 16ja along the protruding direction H.

Further, even when a clamped position in the protruding direction H in the metal plate material 10j by the clamping portion 202 is shifted, predetermined thickness can be secured.

Further, since the longitudinal bead 16ja of the lattice bead 16j is formed along the protruding direction H, rigidity along the protruding direction H of the metal plate material 10j, that is, in the plate thickness direction D can be improved, and the lattice bead 16j formed along the protruding direction H can bite into and be locked to a tip of the clamping portion 202, and a stable clamping state can be obtained.

Note that the lattice bead 16j may be formed so as to protrude to the front surface side Df, or one of two of the longitudinal beads 16ja may be formed so as to protrude to the back surface side Db, and the other one of the longitudinal beads 16ja may be formed so as to protrude to the front surface side Df.

Further, one of the longitudinal bead 16ja and the lateral bead 16jb constituting the lattice bead 16j may be formed so as to protrude to the back surface side Db, and the other may be formed so as to protrude to the front surface side Df.

More specifically, the jump-start terminal 1j can ensure strength in the plate thickness direction D of the metal plate material 10j by the longitudinal bead 16ja reinforcing the protruding direction H of the metal plate material 10j connected to an electric circuit. Therefore, even the jump-start terminal 1j formed of the metal plate material 10j not including a resin member has strength in the plate thickness direction D, and a clamping state by the clamp 201 is stabilized, so that conduction can be stably performed.

Further, since the jump-start terminal 1j is formed of the metal plate material 10j connected to an electric circuit, durability such as heat resistance against heat generated by conduction or the like and weather resistance can be improved as compared with a jump-start terminal partially formed of a resin member.

Further, in the jump-start terminal 1j formed of the metal plate material 10j, since the lattice bead 16j for locking the clamping portion 202 that performs clamping is provided in a manner protruding from a main surface of the metal plate material 10j, a clamping state of the clamp 201 can be stabilized with respect to the metal plate material 10j. For this reason, it is possible to stably perform conduction via the jump-start terminal 1j clamped by the clamp 201.

Furthermore, since the clamped portion 20j to be clamped by the clamping portion 202 in the jump-start terminal 1j can be clearly indicated by the lattice bead 16j, a worker can reliably clamp the clamped portion 20j to be clamped by the clamping portion 202 without making a mistake, and the clamp 201 can be stably clamped to the metal plate material 10j.

Further, by setting thickness of the clamped portion 20j clamped by the clamping portion 202 to predetermined thickness by forming the lattice bead 16j, durability can be improved as compared with a case where a bus bar holding portion made from resin is included, and the clamping portion 202 can clamp the clamped portion 20j of the metal plate material 10j with required clamping force. Therefore, it is possible to stably perform conduction by clamping with the clamp 201.

Further, since the longitudinal bead 16ja of the lattice bead 16j is formed along the protruding direction H, rigidity along the protruding direction H of the metal plate material 10j, that is, in the plate thickness direction D can be improved, and the lattice bead 16j formed along the protruding direction H can bite into and be locked to a tip of the clamping portion 202, and a stable clamping state can be obtained.

Further, since the clamped portion 20j is the lattice bead 16j formed along the protruding direction H, even if the metal plate material 10j is thinner than predetermined thickness, the predetermined thickness can be secured by the longitudinal bead 16ja along the protruding direction H.

Further, even when a clamped position in the protruding direction H in the metal plate material 10j by the clamping portion 202 is shifted, predetermined thickness can be secured.

Note that the lattice bead 16j may be formed so as to protrude to the front surface side Df, or one of two of the longitudinal beads 16ja may be formed so as to protrude to the back surface side Db, and the other one of the longitudinal beads 16ja may be formed so as to protrude to the front surface side Df.

Further, one of the longitudinal bead 16ja and the lateral bead 16jb constituting the lattice bead 16j may be formed so as to protrude to the back surface side Db, and the other may be formed so as to protrude to the front surface side Df.

### Twelfth Embodiment

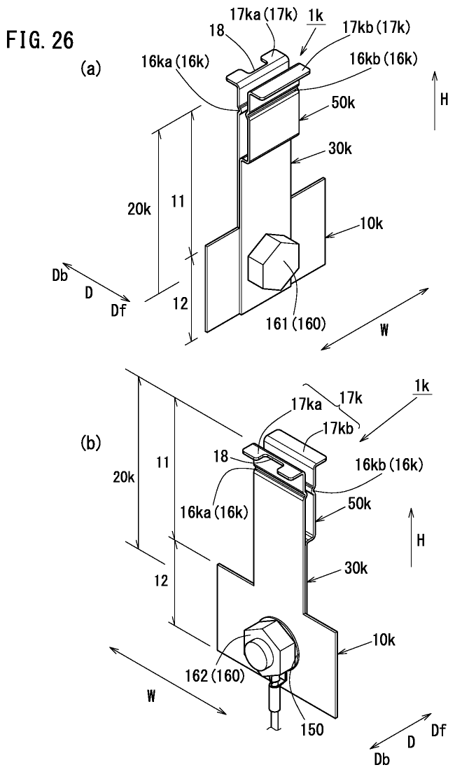

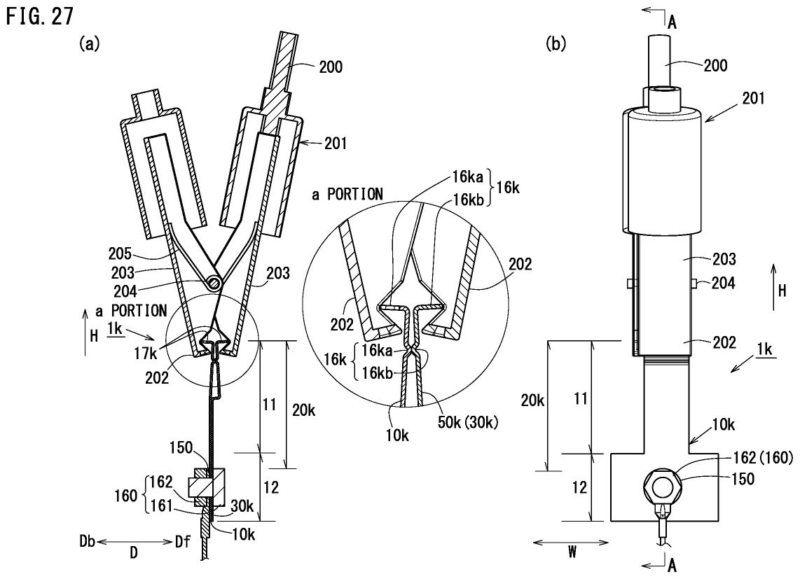

Subsequently, a jump-start terminal 1k of a twelfth embodiment will be described in detail below together with FIGS. 26 and 27.

FIGS. 26 and 27 are explanatory views of the jump-start terminal 1k of the twelfth embodiment. Specifically, FIG. 26(a) is a diagram illustrating a front view, a left side view, and a plan view of the jump-start terminal 1k, FIG. 26(b) is a diagram illustrating a rear view, a left side view, and a plan view of the jump-start terminal 1k, FIG. 27(a) is a cross-sectional view taken along A-A of FIG. 27(b) of the jump-start terminal 1k in a state of being clamped by the clamping portion 202, and FIG. 27(b) is a front view of the jump-start terminal 1k in the same state.

The jump-start terminal 1k of the twelfth embodiment illustrated in FIGS. 26 and 27 is configured by laminating two metal plate materials similarly to the jump-start terminals 1a and 1b described above.

Specifically, the jump-start terminal 1k is formed by laminating, in the plate thickness direction D, a metal plate material 10k formed in a substantially inverted T shape and formed of the terminal main body portion 11 and the mounting base portion 12 and a second metal plate material 30k formed separately.

The metal plate material 10k is a plate material made from a copper alloy having thickness of about 1 mm.

The metal plate material 10k is provided with a bead 16ka along the width direction W and protruding toward the front surface side Df on the tip side in the protruding direction H of the terminal main body portion 11, and is provided with a tip bent portion 17ka obtained by bending a tip of the metal plate material 10k toward the back surface side Db.

The bead 16ka provided on the terminal main body portion 11 of the metal plate material 10k is formed so as to be extruded in a semicircular shape in the plate thickness direction D and extend in the width direction W in a clamped portion 20k on the tip side in the protruding direction H in the terminal main body portion 11 formed of the metal plate material 10k, and is a bead protruding to the front surface side Df with respect to a main surface of the terminal main body portion 11. Note that the bead 16ka is formed with a protrusion amount of about two to four times the plate thickness of the metal plate material 10k.

The tip bent portion 17ka is formed by bending a tip of the terminal main body portion 11 toward the back surface side Db, and forms a central recessed portion 18 in which the center in the width direction W is recessed toward the front surface side Df.

Note that the tip bent portion 17ka is formed to have length substantially equal to height of the nut 162 of the fastening body 160 that fixes the power supply input terminal 150. The central recessed portion 18 is formed to have width of about ½ of the length in the width direction W of the tip bent portion 17ka.

The second metal plate material 30k has a band shape formed with the same width as that of the terminal main body portion 11 in the metal plate material 10k, is formed to have the same length as that in the protruding direction H of the terminal main body portion 11 and the mounting base portion 12, and is a plate material made from a copper alloy having thickness of about 1 mm similarly to the metal plate material 10k.

The second metal plate material 30k is provided with a thickness-increased portion 50k having a hook shape in a side view by bending the tip side toward the front surface side Df.

The thickness-increased portion 50k is formed such that about ⅓ of the tip side of the second metal plate material 30k is once bent to the front surface side Df and is again bent in the protruding direction H to form a hook shape in a side view. Note that the thickness-increased portion 50k is formed to have length substantially equal to height of a bolt head portion of the fixing bolt 161 of the fastening body 160 for fixing the power supply input terminal 150.

Further, a tip bent portion 17kb bent toward the front surface side Df is provided at a tip of the thickness-increased portion 50k, and a recessed bead 16kb protruding toward the back surface side Db is provided at a position corresponding to the bead 16ka of the metal plate material 10k.

The recessed bead 16kb provided in the thickness-increased portion 50k of the second metal plate material 30k is formed so as to be extruded in a semicircular shape in the plate thickness direction D and extend in the width direction W in the second metal plate material 30k having predetermined thickness, and is a bead protruding toward the back surface side Db with respect to a main surface of the second metal plate material 30k. Note that the recessed bead 16kb is formed with a protrusion amount of about two to four times the plate thickness of the metal plate material 10k.

The tip bent portion 17kb is formed to have length substantially equal to height of the nut 162 of the fastening body 160 for fixing the power supply input terminal 150 by bending a tip of the thickness-increased portion 50k of the second metal plate material 30k toward the front surface side Df.

The second metal plate material 30k formed as described above is arranged so as to be laminated on the terminal main body portion 11 in the plate thickness direction D on the front surface side Df of the metal plate material 10k to constitute the jump-start terminal 1k, and the tip side of the terminal main body portion 11 of the metal plate material 10k and the thickness-increased portion 50k of the second metal plate material 30k constitute the clamped portion 20k.

Then, the bead 16ka provided on the terminal main body portion 11 of the metal plate material 10k and the recessed bead 16kb provided on the thickness-increased portion 50k of the second metal plate material 30k are arranged to face each other at a predetermined interval in the plate thickness direction D in a normal state. That is, the recessed beads 16k (16ka and 16kb) protrude toward the sides approaching each other.

Similarly to the jump-start terminal 1 and the like described above, the jump-start terminal 1k configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20k penetrates the base portion 103 and protrudes in the protruding direction H from the base portion 103.

Then, as described above, in the jump-start terminal 1k arranged along the terminal holder 110, the clamped portion 20k is exposed as the terminal cover 111 is opened, and the clamped portion 20k of the jump-start terminal 1k can be clamped by the clamping portion 202 of the clamp 201. At this time, as illustrated in FIG. 27(a), the clamping portion 202 clamps by sandwiching the clamped portion 20k constituted by the tip side of the metal plate material 10k and the thickness-increased portion 50k.

When the clamped portion 20k of the jump-start terminal 1k is clamped by the clamping portion 202, the terminal main body portion 11 and the thickness-increased portion 50k of the metal plate material 10k approach each other in the plate thickness direction D by biasing force of the clamping portion 202, and the recessed beads 16k (16ka and 16kb) abut on each other.

As described above, the above-described jump-start terminal 1k in which the tip bent portion 17k for locking the clamping portion 202 that performs clamping is provided in a manner protruding from a main surface of the metal plate material 10k and the second metal plate material 30k can achieve the same main effect as the main effect of the jump-start terminal 1 of the first embodiment.

Further, in the jump-start terminal 1k constituted by the metal plate material 10k and the second metal plate material 30k, the tip bent portion 17k for locking the clamping portion 202 that performs clamping is provided in a manner protruding from main surfaces of the metal plate material 10k and the second metal plate material 30k, so that a clamping state of the clamp 201 can be stabilized with respect to the metal plate material 10k and the second metal plate material 30k. For this reason, it is possible to stably perform conduction via the jump-start terminal 1k clamped by the clamp 201.

Furthermore, since the clamped portion 20k to be clamped by the clamping portion 202 in the jump-start terminal 1k can be clearly indicated by the tip bent portion 17k, a worker can reliably clamp the clamped portion 20k to be clamped by the clamping portion 202 without making a mistake, and the clamp 201 can be stably clamped to the metal plate material 10k and the second metal plate material 30k.

Further, by setting thickness of the clamped portion 20k clamped by the clamping portion 202 to predetermined thickness, durability can be improved as compared with a case where a bus bar holding portion made from resin is included, and the clamping portion 202 can clamp the clamped portion 20k of the metal plate material 10k and the second metal plate material 30k with required clamping force. Therefore, it is possible to stably perform conduction by clamping with the clamp 201.

Further, since the tip side of the metal plate material 10k and the thickness-increased portion 50k of the second metal plate material 30k are arranged at a predetermined interval in the plate thickness direction D corresponding to predetermined thickness to form the clamped portion 20k, as if the thickness-increased portion 50k of the second metal plate material 30k arranged at a predetermined interval forms the clamped portion 20k having predetermined thickness, and clamping with required clamping force is enabled.

Further, the clamped portion 20k is provided with the recessed bead 16k that holds an interval between the tip side of the metal plate material 10k and the thickness-increased portion 50k of the second metal plate material 30k arranged at a predetermined interval. For this reason, when the clamped portion 20k formed of the tip side of the metal plate material 10k and the thickness-increased portion 50k of the second metal plate material 30k arranged at a predetermined interval is clamped by the clamping portion 202, they tend to approach each other by the clamping force of the clamping portion 202, but a space of the clamped portion 20k can be held at a predetermined interval by the recessed bead 16k. Therefore, the clamp 201 can clamp the clamped portion 20k with required clamping force.

Further, the recessed bead 16k is provided on both the tip side of the metal plate material 10k and the thickness-increased portion 50k of the second metal plate material 30k arranged at a predetermined interval, and projects toward the other. For this reason, when the clamped portion 20k formed of the tip side of the metal plate material 10k and the thickness-increased portion 50k of the second metal plate material 30k arranged at a predetermined interval is clamped by the clamping portion 202, the recessed bead 16k provided on the tip side of the metal plate material 10k can abut on the recessed bead 16k provided in the thickness-increased portion 50k of the other one, the second metal plate material 30k, to hold the interval. Therefore, the clamp 201 can clamp the clamped portion 20k with required clamping force.

Further, since the recessed bead 16k protrudes in directions facing each other in the metal plate material 10k and the second metal plate material 30k, a protrusion amount toward the other can be adjusted by a bead shape, and the recessed bead 16k protruding toward the other abuts on the other, so that a predetermined interval can be maintained. Therefore, the clamp 201 can clamp the clamped portion 20k with required clamping force.

Further, at tips of the metal plate material 10k and the thickness-increased portion 50k of the second metal plate material 30k arranged at a predetermined interval, there are provided the tip bent portions 17k bent toward the side away from the other. For this reason, apparent thickness of the clamped portion 20k to be clamped by the clamping portion 202 is further increased, so that clamping force of the clamping portion 202 is increased, and clamping can be performed in a more stable clamping state.

More specifically, the clamping portion 202 that clamps the clamped portion 20k formed of the tip side of the metal plate material 10k and the thickness-increased portion 50k of the second metal plate material 30k arranged at a predetermined interval also clamps the tip bent portion 17k together. For this reason, the clamping portion 202 is significantly opened against biasing force of the coil spring 205, clamping force of the clamping portion 202 increases, and the clamp 201 can perform clamping in a more stable clamping state.

Further, since the central recessed portion 18 having a recessed shape toward an opposing direction is provided at the center in the width direction W of the tip bent portion 17k, a peripheral component can pass through the central recessed portion 18 provided in the tip bent portion 17k at the time of attachment to the base body 102 of the electrical connection box 100, and interference with the peripheral component can be prevented.

Note that, as described above, the recessed bead 16k and the tip bent portion 17k are provided in each of the terminal main body portion 11 of the metal plate material 10k and the thickness-increased portion 50k of the second metal plate material 30k, but may also be provided only in one of them.

Further, the second metal plate material 30k may be laminated on the back surface side Db of the metal plate material 10k to be integrated.

More specifically, by setting thickness of the clamped portion 20k clamped by the clamping portion 202 to predetermined thickness, durability can be improved as compared with a case where a bus bar holding portion made from resin is included, and the clamping portion 202 can clamp the clamped portion 20k of the metal plate material 10k and the second metal plate material 30k with required clamping force. Therefore, it is possible to stably perform conduction by clamping with the clamp 201.

Further, in the jump-start terminal 1k constituted by the metal plate material 10k and the second metal plate material 30k, the tip bent portion 17k for locking the clamping portion 202 that performs clamping is provided in a manner protruding from main surfaces of the metal plate material 10k and the second metal plate material 30k, so that a clamping state of the clamp 201 can be stabilized with respect to the metal plate material 10k and the second metal plate material 30k. For this reason, it is possible to stably perform conduction via the jump-start terminal 1k clamped by the clamp 201.

Furthermore, since the clamped portion 20k to be clamped by the clamping portion 202 in the jump-start terminal 1k can be clearly indicated by the tip bent portion 17k, a worker can reliably clamp the clamped portion 20k to be clamped by the clamping portion 202 without making a mistake, and the clamp 201 can be stably clamped to the metal plate material 10k and the second metal plate material 30k.

Further, since the tip side of the metal plate material 10k and the thickness-increased portion 50k of the second metal plate material 30k are arranged at a predetermined interval in the plate thickness direction D corresponding to predetermined thickness to form the clamped portion 20k, as if the thickness-increased portion 50k of the second metal plate material 30k arranged at a predetermined interval forms the clamped portion 20k having predetermined thickness, and clamping with required clamping force is enabled.

Further, the clamped portion 20k is provided with the recessed bead 16k that holds an interval between the tip side of the metal plate material 10k and the thickness-increased portion 50k of the second metal plate material 30k arranged at a predetermined interval. For this reason, when the clamped portion 20k formed of the tip side of the metal plate material 10k and the thickness-increased portion 50k of the second metal plate material 30k arranged at a predetermined interval is clamped by the clamping portion 202, they tend to approach each other by the clamping force of the clamping portion 202, but a space of the clamped portion 20k can be held at a predetermined interval by the recessed bead 16k. Therefore, the clamp 201 can clamp the clamped portion 20k with required clamping force.

Further, the recessed bead 16k is provided on both the tip side of the metal plate material 10k and the thickness-increased portion 50k of the second metal plate material 30k arranged at a predetermined interval, and projects toward the other. For this reason, when the clamped portion 20k formed of the tip side of the metal plate material 10k and the thickness-increased portion 50k of the second metal plate material 30k arranged at a predetermined interval is clamped by the clamping portion 202, the recessed bead 16k provided on the tip side of the metal plate material 10k can abut on the recessed bead 16k provided in the thickness-increased portion 50k of the other one, the second metal plate material 30k, to hold the interval. Therefore, the clamp 201 can clamp the clamped portion 20k with required clamping force.

Further, since the recessed bead 16k protrudes in directions facing each other in the metal plate material 10k and the second metal plate material 30k, a protrusion amount toward the other can be adjusted by a bead shape, and the recessed bead 16k protruding toward the other abuts on the other, so that a predetermined interval can be maintained. Therefore, the clamp 201 can clamp the clamped portion 20k with required clamping force.

Further, at tips of the metal plate material 10k and the thickness-increased portion 50k of the second metal plate material 30k arranged at a predetermined interval, there are provided the tip bent portions 17k bent toward the side away from the other. For this reason, apparent thickness of the clamped portion 20k to be clamped by the clamping portion 202 is further increased, so that clamping force of the clamping portion 202 is increased, and clamping can be performed in a more stable clamping state.

More specifically, the clamping portion 202 that clamps the clamped portion 20k formed of the tip side of the metal plate material 10k and the thickness-increased portion 50k of the second metal plate material 30k arranged at a predetermined interval also clamps the tip bent portion 17k together. For this reason, the clamping portion 202 is significantly opened against biasing force of the coil spring 205, clamping force of the clamping portion 202 increases, and the clamp 201 can perform clamping in a more stable clamping state.

Further, since the central recessed portion 18 having a recessed shape toward an opposing direction is provided at the center in the width direction W of the tip bent portion 17k, a peripheral component can pass through the central recessed portion 18 provided in the tip bent portion 17k at the time of attachment to the base body 102 of the electrical connection box 100, and interference with the peripheral component can be prevented.

Note that, as described above, the recessed bead 16k and the tip bent portion 17k are provided in each of the terminal main body portion 11 of the metal plate material 10k and the thickness-increased portion 50k of the second metal plate material 30k, but may also be provided only in one of them.

Further, the second metal plate material 30k may be laminated on the back surface side Db of the metal plate material 10k to be integrated.

### Thirteenth Embodiment

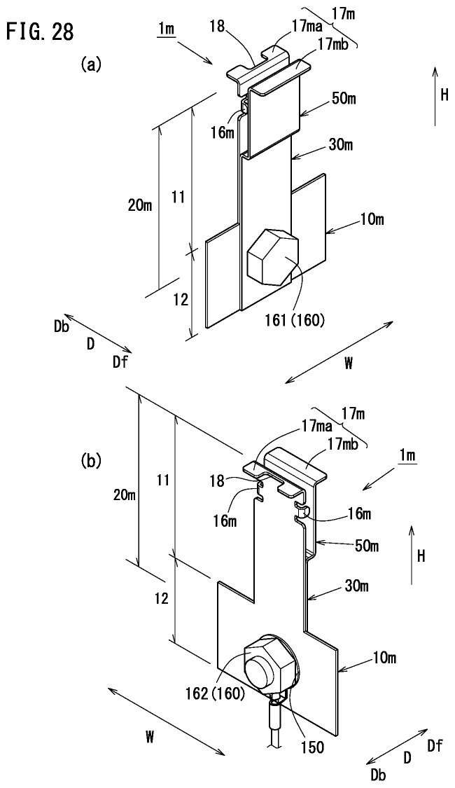

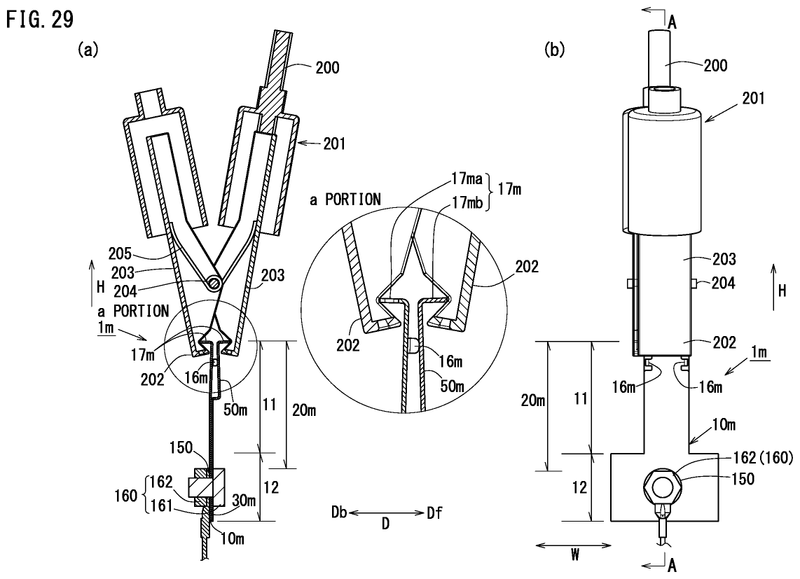

Subsequently, a jump-start terminal 1m of a thirteenth embodiment will be described in detail below together with FIGS. 28 and 29.

FIGS. 28 and 29 are explanatory views of the jump-start terminal 1m of the thirteenth embodiment. Specifically, FIG. 28(a) is a diagram illustrating a front view, a left side view, and a plan view of the jump-start terminal 1m, FIG. 28(b) is a diagram illustrating a rear view, a left side view, and a plan view of the jump-start terminal 1m, FIG. 29(a) is a cross-sectional view taken along A-A of FIG. 29(b) of the jump-start terminal 1m in a state of being clamped by the clamping portion 202, and FIG. 29(b) is a front view of the jump-start terminal 1m in the same state.

The jump-start terminal 1m of the thirteenth embodiment illustrated in FIGS. 28 and 29 is configured by laminating two metal plate materials similarly to the jump-start terminal 1m described above.

Specifically, the jump-start terminal 1m is formed by laminating, in the plate thickness direction D, a metal plate material 10m formed in a substantially inverted T shape and formed of the terminal main body portion 11 and the mounting base portion 12 and a second metal plate material 30m formed separately.

The metal plate material 10m is a plate material made from a copper alloy having thickness of about 1 mm.

Unlike the metal plate material 10k provided with the recessed bead 16k, the metal plate material 10m is provided with a bent section 16m formed by cutting both edges in the width direction W and bending them toward the front surface side Df, and is provided with a tip bent portion 17ma that is formed by bending a tip of the metal plate material 10m toward the back surface side Db and has the central recessed portion 18 at the center in the width direction W.

The bent section 16m provided on the terminal main body portion 11 of the metal plate material 10m is bent and formed so as to protrude toward the front surface side Df from edge portions on both sides in the width direction W of the clamped portion 20m on the tip side in the protruding direction H in the terminal main body portion 11 formed of the metal plate material 10m. Note that the bent section 16m is formed to have a protrusion amount of about two to four times the plate thickness of the metal plate material 10m.

The second metal plate material 30m has the same configuration except that the recessed bead 16kb in the second metal plate material 30k is not provided, and is a plate material made from a copper alloy having thickness of about 1 mm similarly to the metal plate material 10m.

The second metal plate material 30m formed as described above is arranged so as to be laminated on the terminal main body portion 11 in the plate thickness direction D on the front surface side Df of the metal plate material 10m to constitute the jump-start terminal 1m, and the tip side of the terminal main body portion 11 of the metal plate material 10m and a thickness-increased portion 50m of the second metal plate material 30m constitute the clamped portion 20m.

Similarly to the jump-start terminal 1 and the like described above, the jump-start terminal 1m configured as described above is attached to the base portion 103 in the electrical connection box 100 in an aspect in which a portion where the power supply input terminal 150 is attached on the base end side of the terminal main body portion 11 and the mounting base portion 12 is arranged inside the base body 102, and the clamped portion 20m penetrates the base portion 103 and protrudes in the protruding direction H from the base portion 103.

Then, as described above, in the jump-start terminal 1m arranged along the terminal holder 110, the clamped portion 20m is exposed as the terminal cover 111 is opened, and the clamped portion 20m of the jump-start terminal 1m can be clamped by the clamping portion 202 of the clamp 201. At this time, as illustrated in FIG. 29(a), the clamping portion 202 clamps by sandwiching the clamped portion 20m constituted by the tip side of the metal plate material 10m and the thickness-increased portion 50m.

When the clamped portion 20m of the jump-start terminal 1m is clamped by the clamping portion 202, the terminal main body portion 11 of the metal plate material 10m and the thickness-increased portion 50m approach each other in the plate thickness direction D by biasing force of the clamping portion 202, but the bent section 16m provided on the terminal main body portion 11 of the metal plate material 10m abuts on the thickness-increased portion 50m.

As described above, the jump-start terminal 1m is constituted by the metal plate material 10m connected to an electric circuit via the power supply input terminal 150 and the second metal plate material 30m, and the above-described jump-start terminal 1m provided such that the tip bent portion 17m for locking the clamping portion 202 that performs clamping protrudes from main surfaces of the metal plate material 10m and the second metal plate material 30m can achieve the same main effect as the main effect of the jump-start terminal 1 of the first embodiment.

Further, in the jump-start terminal 1m constituted by the metal plate material 10m and the second metal plate material 30m, the tip bent portion 17m for locking the clamping portion 202 that performs clamping is provided in a manner protruding from main surfaces of the metal plate material 10m and the second metal plate material 30m, so that a clamping state of the clamp 201 can be stabilized with respect to the metal plate material 10m and the second metal plate material 30m. For this reason, it is possible to stably perform conduction via the jump-start terminal 1m clamped by the clamp 201.

Furthermore, since the clamped portion 20m to be clamped by the clamping portion 202 in the jump-start terminal 1m can be clearly indicated by the tip bent portion 17m, a worker can reliably clamp the clamped portion 20m to be clamped by the clamping portion 202 without making a mistake, and the clamp 201 can be stably clamped to the metal plate material 10m and the second metal plate material 30m.

Further, by setting thickness of the clamped portion 20m clamped by the clamping portion 202 to predetermined thickness, durability can be improved as compared with a case where a bus bar holding portion made from resin is included, and the clamping portion 202 can clamp the clamped portion 20m formed of the tip side of the metal plate material 10m and the thickness-increased portion 50m of the second metal plate material 30m with required clamping force. Therefore, it is possible to stably perform conduction by clamping with the clamp 201.

Further, since the tip side of the metal plate material 10m and the thickness-increased portion 50m of the second metal plate material 30m are arranged at a predetermined interval in the plate thickness direction D corresponding to predetermined thickness to form the clamped portion 20m, the tip side of the metal plate material 10m and the thickness-increased portion 50m of the second metal plate material 30m arranged at a predetermined interval form the clamped portion 20m having predetermined thickness, and clamping can be performed with required clamping force.

Further, since the clamped portion 20m is provided with the bent section 16m that holds an interval between the tip side of the metal plate material 10m and the thickness-increased portion 50m of the second metal plate material 30m arranged at a predetermined interval, when the clamped portion 20m formed of the tip side of the metal plate material 10m and the thickness-increased portion 50m of the second metal plate material 30m arranged at a predetermined interval is clamped by the clamping portion 202, they approach each other by clamping force of the clamping portion 202, but an interval between the tip side of the metal plate material 10m and the thickness-increased portion 50m can be held at a predetermined interval by the bent section 16m. Therefore, the clamp 201 can clamp the clamped portion 20m with required clamping force.

Further, since the bent section 16m is provided on the tip side of the metal plate material 10m arranged at a predetermined interval and has a projecting shape toward the thickness-increased portion 50m, when the clamped portion 20m formed of the tip side of the metal plate material 10m and the thickness-increased portion 50m of the second metal plate material 30m arranged at a predetermined interval is clamped by the clamping portion 202, the bent section 16m provided on the tip side of the metal plate material 10m can abut on the thickness-increased portion 50m of the second metal plate material 30m to maintain the interval. Therefore, the clamp 201 can clamp the clamped portion 20m with required clamping force.

Further, since the bent section 16m is provided on the tip side of the metal plate material 10m arranged at a predetermined interval and is a bent section directed toward the other, a protrusion amount toward the other can be adjusted by a shape of the bent section 16m, and the bent section 16m having a simple structure of protruding toward the other abuts on the other so that a predetermined interval can be maintained. Therefore, the clamp 201 can clamp the clamped portion 20m with required clamping force.

Further, at tips of the metal plate material 10m and the second metal plate material 30m arranged at a predetermined interval, there are provided the tip bent portions 17m bent toward the side away from the other. For this reason, apparent thickness of the clamped portion 20m to be clamped by the clamping portion 202 is further increased, so that clamping force of the clamping portion 202 is increased, and clamping can be performed in a more stable clamping state.

More specifically, the clamping portion 202 that clamps the clamped portion 20m formed of the tip side of the metal plate material 10m and the thickness-increased portion 50m of the second metal plate material 30m arranged at a predetermined interval also clamps the tip bent portion 17m together. For this reason, the clamping portion 202 is significantly opened against biasing force of the coil spring 205, clamping force of the clamping portion 202 increases, and the clamp 201 can perform clamping in a more stable clamping state.

Further, since the central recessed portion 18 having a recessed shape toward an opposing direction is provided at the center in the width direction W of the tip bent portion 17m, a peripheral component can pass through the central recessed portion 18 provided in the tip bent portion 17m at the time of attachment to the base body 102 of the electrical connection box 100, and interference with the peripheral component can be prevented.

Note that, as described above, the bent section 16m is provided in the terminal main body portion 11 of the metal plate material 10m, but may be provided in the thickness-increased portion 50m of the second metal plate material 30m so as to be directed to the back surface side Db, or may be provided in both the terminal main body portion 11 of the metal plate material 10m and the thickness-increased portion 50m of the second metal plate material 30m and arranged at different positions in the protruding direction H.

Further, the second metal plate material 30m may be laminated on the back surface side Db of the metal plate material 10m to be integrated.

More specifically, by setting thickness of the clamped portion 20m clamped by the clamping portion 202 to predetermined thickness, durability can be improved as compared with a case where a bus bar holding portion made from resin is included, and the clamping portion 202 can clamp the clamped portion 20m formed of the tip side of the metal plate material 10m and the thickness-increased portion 50m of the second metal plate material 30m with required clamping force. Therefore, it is possible to stably perform conduction by clamping with the clamp 201.

Further, in the jump-start terminal 1m constituted by the metal plate material 10m and the second metal plate material 30m, the tip bent portion 17m for locking the clamping portion 202 that performs clamping is provided in a manner protruding from main surfaces of the metal plate material 10m and the second metal plate material 30m, so that a clamping state of the clamp 201 can be stabilized with respect to the metal plate material 10m and the second metal plate material 30m. For this reason, it is possible to stably perform conduction via the jump-start terminal 1m clamped by the clamp 201.

Furthermore, since the clamped portion 20m to be clamped by the clamping portion 202 in the jump-start terminal 1m can be clearly indicated by the tip bent portion 17m, a worker can reliably clamp the clamped portion 20m to be clamped by the clamping portion 202 without making a mistake, and the clamp 201 can be stably clamped to the metal plate material 10m and the second metal plate material 30m.

Further, since the tip side of the metal plate material 10m and the thickness-increased portion 50m of the second metal plate material 30m are arranged at a predetermined interval in the plate thickness direction D corresponding to predetermined thickness to form the clamped portion 20m, the tip side of the metal plate material 10m and the thickness-increased portion 50m of the second metal plate material 30m arranged at a predetermined interval form the clamped portion 20m having predetermined thickness, and clamping can be performed with required clamping force.

Further, since the clamped portion 20m is provided with the bent section 16m that holds an interval between the tip side of the metal plate material 10m and the thickness-increased portion 50m of the second metal plate material 30m arranged at a predetermined interval, when the clamped portion 20m formed of the tip side of the metal plate material 10m and the thickness-increased portion 50m of the second metal plate material 30m arranged at a predetermined interval is clamped by the clamping portion 202, they approach each other by clamping force of the clamping portion 202, but an interval between the tip side of the metal plate material 10m and the thickness-increased portion 50m can be held at a predetermined interval by the bent section 16m. Therefore, the clamp 201 can clamp the clamped portion 20m with required clamping force.

Further, since the bent section 16m is provided on the tip side of the metal plate material 10m arranged at a predetermined interval and has a projecting shape toward the thickness-increased portion 50m, when the clamped portion 20m formed of the tip side of the metal plate material 10m and the thickness-increased portion 50m of the second metal plate material 30m arranged at a predetermined interval is clamped by the clamping portion 202, the bent section 16m provided on the tip side of the metal plate material 10m can abut on the thickness-increased portion 50m of the second metal plate material 30m to maintain the interval. Therefore, the clamp 201 can clamp the clamped portion 20m with required clamping force.

Further, since the bent section 16m is provided on the tip side of the metal plate material 10m arranged at a predetermined interval and is a bent section directed toward the other, a protrusion amount toward the other can be adjusted by a shape of the bent section 16m, and the bent section 16m having a simple structure of protruding toward the other abuts on the other so that a predetermined interval can be maintained. Therefore, the clamp 201 can clamp the clamped portion 20m with required clamping force.

Further, at tips of the metal plate material 10m and the second metal plate material 30m arranged at a predetermined interval, there are provided the tip bent portions 17m bent toward the side away from the other. For this reason, apparent thickness of the clamped portion 20m to be clamped by the clamping portion 202 is further increased, so that clamping force of the clamping portion 202 is increased, and clamping can be performed in a more stable clamping state.

More specifically, the clamping portion 202 that clamps the clamped portion 20m formed of the tip side of the metal plate material 10m and the thickness-increased portion 50m of the second metal plate material 30m arranged at a predetermined interval also clamps the tip bent portion 17m together. For this reason, the clamping portion 202 is significantly opened against biasing force of the coil spring 205, clamping force of the clamping portion 202 increases, and the clamp 201 can perform clamping in a more stable clamping state.

Further, since the central recessed portion 18 having a recessed shape toward an opposing direction is provided at the center in the width direction W of the tip bent portion 17m, a peripheral component can pass through the central recessed portion 18 provided in the tip bent portion 17m at the time of attachment to the base body 102 of the electrical connection box 100, and interference with the peripheral component can be prevented.

Note that, as described above, the bent section 16m is provided in the terminal main body portion 11 of the metal plate material 10m, but may be provided in the thickness-increased portion 50m of the second metal plate material 30m so as to be directed to the back surface side Db, or may be provided in both the terminal main body portion 11 of the metal plate material 10m and the thickness-increased portion 50m of the second metal plate material 30m and arranged at different positions in the protruding direction H.

Further, the second metal plate material 30m may be laminated on the back surface side Db of the metal plate material 10m to be integrated.

### Fourteenth Embodiment

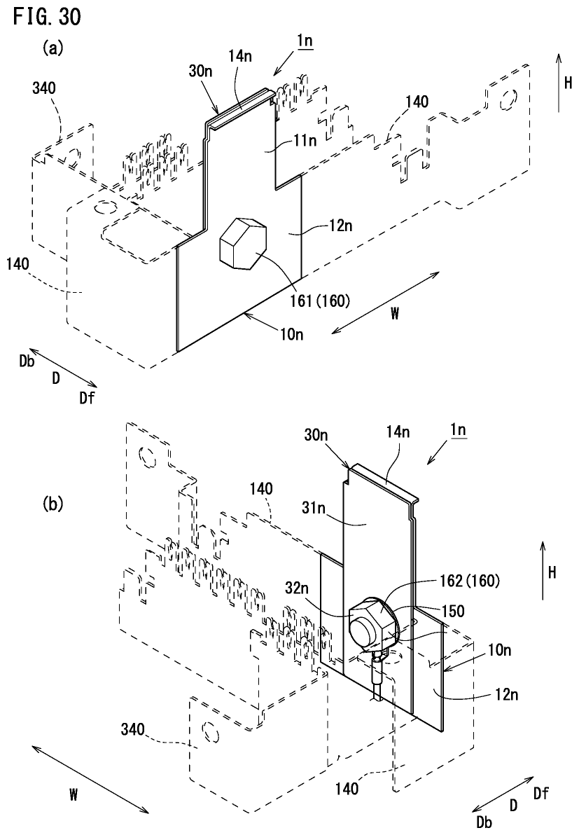

Subsequently, a jump-start terminal 1n of a fourteenth embodiment will be described in detail below together with FIGS. 30 to 32.

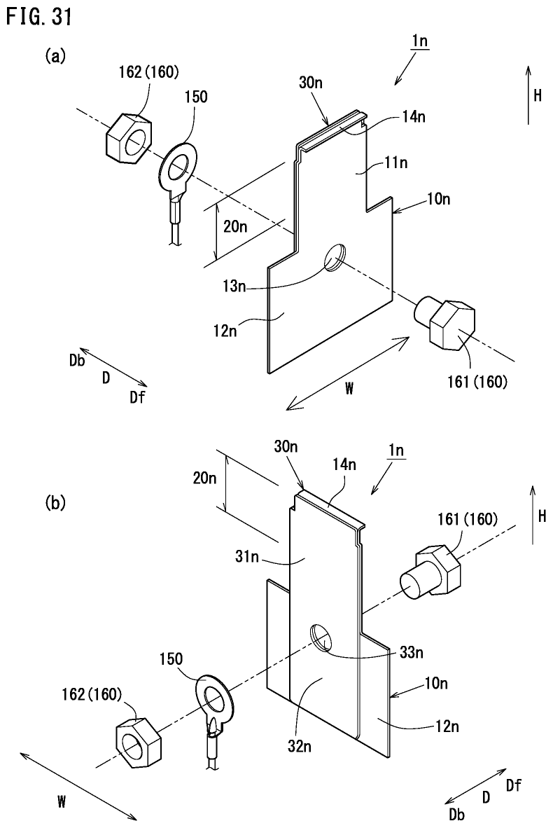

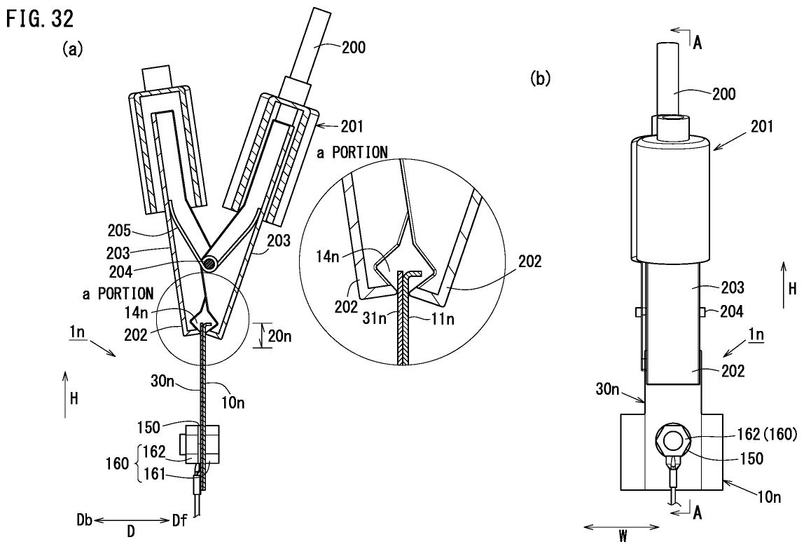

Note that FIG. 30 illustrates an explanatory view of the jump-start terminal 1n of the fourteenth embodiment, FIG. 31 illustrates an exploded explanatory view of the jump-start terminal 1n of the fourteenth embodiment, and FIG. 32 illustrates an explanatory view of the jump-start terminal 1n of the fourteenth embodiment.

Specifically, FIG. 30(a) is a diagram illustrating a front view, a left side view, and a plan view of the jump-start terminal 1n, and FIG. 30(b) is a diagram illustrating a rear view, a left side view, and a plan view of the jump-start terminal 1n. Note that in FIG. 30, the power supply branch portion 140 integrally molded with a first mounting base portion 12n of the first metal plate material 10n and a power supply branch portion 340 integrally molded with a second mounting base portion 32n of a second metal plate material 30n are indicated by a broken line.

Further, FIG. 31(a) is a diagram illustrating a front view, a left side view, and a plan view of the jump-start terminal 1n in a state where a power supply input terminal 150, a fixing bolt 161, and a nut 162 are disassembled, and FIG. 31(b) is a diagram illustrating a rear view, a left side view, and a plan view of the jump-start terminal 1n in the same state.

FIG. 32(a) is a cross-sectional view taken along A-A of FIG. 32(b) of the jump-start terminal 1n in a state of being clamped with a clamping portion 202, and FIG. 32(b) is a front view of the jump-start terminal 1n in the same state.

The jump-start terminal 1n of the fourteenth embodiment illustrated in FIGS. 30 to 32 is configured by laminating two of the metal plate materials 10n and 30n similarly to the jump-start terminal 1a described above.

Specifically, similarly to the jump-start terminal 1a, the jump-start terminal 1n is formed by laminating, in the plate thickness direction D, the metal plate material 10n formed in a substantially inverted T shape and formed of a first terminal main body portion 11n and the first mounting base portion 12n and the second metal plate material 30n formed separately.

More specifically, the metal plate material 10n is formed in a substantially inverted T shape by the first terminal main body portion 11n extending in the protruding direction H and a first mounting base portion 12n extending in the width direction W on the base end side of the first terminal main body portion 11n.

Although not illustrated, the power supply branch portion 140 is integrally molded with a broken line in FIG. 30 at a tip of the first mounting base portion 12n, but the power supply branch portion 140 does not need to be provided.

Then, the first terminal main body portion 11n is formed to have length in the width direction W slightly larger than width corresponding to width of the clamping portion 202 of the clamp 201 and has a band shape long in the protruding direction H, and the power supply input terminal 150 is attached to the first mounting base portion 12n by the fastening body 160.

Specifically, as illustrated in FIG. 31, a bolt hole 13n is provided between the first terminal main body portion 11n and the first mounting base portion 12n. The fastening body 160 for attaching the power supply input terminal 150 connected to a battery (not illustrated) to the bolt holes 13n and 33n includes the fixing bolt 161 passing through the bolt hole 13n and the nut 162 screwed with the fixing bolt 161.

Note that the power supply input terminal 150 and the fastening body 160 may be arranged at appropriate positions in both the protruding direction H and the width direction W without limitation to the first mounting base portion 12n.

In order to attach the power supply input terminal 150 to the jump-start terminal 1n by using the fastening body 160 configured as described above, the power supply input terminal 150 is arranged with respect to the bolt holes 13n and 33n, a shaft portion of the fixing bolt 161 is inserted into the bolt holes 13n and 33n and the power supply input terminal 150, and the nut 162 and the fixing bolt 161 are screwed on the opposite side, so that the power supply input terminal 150 can be attached and fixed to the jump-start terminal 1n.

As described above, a tip in the protruding direction H of the first terminal main body portion 11n is provided with a tip bent portion 14n bent toward the front surface side Df opposite to the tip bent portion 14 provided at a tip in the protruding direction H of the metal plate material 10.

Note that length of the tip bent portion 14n protruding toward the front surface side Df with respect to the first terminal main body portion 11n is about five times the thickness of the metal plate material 10n forming the jump-start terminal 1n, and is formed to have about 5 mm which is predetermined thickness.

Further, the tip bent portion 14n is formed to be narrower than the first terminal main body portion 11n and to have width corresponding to width of the clamping portion 202.

The second metal plate material 30n laminated on the first metal plate material 10n configured as described above has a band shape formed to have the same width as the first terminal main body portion 11n in the metal plate material 10n, is formed to have the same length as length in the protruding direction H of the first terminal main body portion 11n and the first mounting base portion 12n, and is provided with the bolt hole 33n at a position corresponding to the bolt hole 13n in the metal plate material 10n.

Note that in the second metal plate material 30n, a portion corresponding to the first terminal main body portion 11n of the first metal plate material 10n is referred to as a second terminal main body portion 31n, and a portion corresponding to the first mounting base portion 12n of the first metal plate material 10n is referred to as a second mounting base portion 32n.

Although not illustrated, the power supply branch portion 340 is integrally molded with a broken line in FIG. 30 at a tip of the second mounting base portion 32n, but the power supply branch portion 340 does not need to be provided.

The second metal plate material 30n is formed of a metal thick plate material having thickness equivalent to that of the metal plate material 10n. Specifically, in the present embodiment, while the metal plate material 10n is a plate material made from a copper alloy having thickness of about 1 mm, the second metal plate material 30n is also a plate material made from a copper alloy having thickness of about 1 mm.

A side in the protruding direction H of the first terminal main body portion 11n and the second terminal main body portion 31n of the jump-start terminal 1n configured as described above is a clamped portion 20n clamped by the clamping portion 202 of the clamp 201.

Therefore, the clamped portion 20n includes a part of the terminal main body portions 11n and 31n and the tip bent portion 14n protruding to the front surface side Df from the first terminal main body portion 11n.

The jump-start terminal 1n configured as described above is attached to the base portion 103 in the electrical connection box 100 in an aspect in which the mounting base portions 12n and 32n are arranged inside the base body 102, and the clamped portion 20n penetrates the base portion 103 and protrudes in the protruding direction H from the base portion 103.

Then, as described above, when the terminal cover 11I is opened, the clamped portion 20n of the terminal main body portions 11n and 31n is exposed, and the jump-start terminal 1n arranged along the terminal holder 110 can be clamped by the clamping portion 202 of the clamp 201. At this time, as illustrated in FIG. 32(a), the clamping portion 202 clamps by sandwiching a part of the terminal main body portions 11n and 31n and the tip bent portion 14n.

As described above, since the clamped portion 20n on the side in the protruding direction H of the metal plate materials 10n and 30n clamped by the clamping portion 202 has predetermined thickness to be clamped by the clamping portion 202 with required clamping force, the above-described jump-start terminal 1n can achieve the same main effect as the main effect of the jump-start terminal 1 of the first embodiment.

More specifically, the jump-start terminal 1n provided in a manner protruding from the base portion 103 of the base body 102 in the electrical connection box 100 and clamped by the clamping portion 202 in the clamp 201 of the booster cable 200 is connected to an electric circuit, and includes two of the metal plate materials 10n and 30n laminated in the plate thickness direction D, the tip bent portion 14n for locking the clamping portion 202 that performs clamping is provided at a tip portion of the first metal plate material 10n between two of the metal plate materials 10n and 30n, and the tip bent portion 14n protrudes to the front surface side Df opposite to the second metal plate material 30n between two of the metal plate materials 10n and 30n. For this reason, the jump-start terminal 1n has high durability, and can be clamped by the clamp 201 for stable conduction.

More specifically, since the jump-start terminal 1n provided in a manner protruding from the base portion 103 of the base body 102 in the electrical connection box 100 and clamped by the clamping portion 202 in the clamp 201 of the booster cable 200 is formed of two of the metal plate materials 10n and 30n that are connected to an electric circuit and laminated in the plate thickness direction D, it is possible to improve durability such as heat resistance against heat generated by conduction or the like and weather resistance as compared with a jump-start terminal partially formed of a resin member.

Further, in the jump-start terminal 1n formed of two of the metal plate materials 10n and 30n laminated in the plate thickness direction D, the tip bent portion 14n for locking the clamping portion 202 that performs clamping is provided at a tip portion of the first metal plate material 10n between two of the metal plate materials 10n and 30n, and the tip bent portion 14n protrudes to the front surface side Df opposite to the second metal plate material 30n between two of the metal plate materials 10n and 30n. For this reason, a clamping state of the clamp 201 that performs clamping with the clamping portion 202 stably can be stabilized with respect to the jump-start terminal 1n formed of two of the metal plate materials 10n and 30n. For this reason, it is possible to stably perform conduction via the jump-start terminal 1n clamped by the clamp 201.

Further, since two of the metal plate materials 10n and 30n are clamped by the clamping portion 202, a contact area between the clamping portion 202 and two of the metal plate materials 10n and 30n is increased and conductivity is improved as compared with a case where a holding portion made from resin integrally formed on the base body 102 and a metal plate material are clamped by the clamping portion 202. For this reason, it is possible to reduce an amount of heat generation of the jump-start terminal 1n caused by being clamped by the clamping portion 202 and application of large current.

Further, since the tip bent portion 14n is formed by bending a tip of the first metal plate material 10n between two of the metal plate materials 10n and 30n to the front surface side Df that is the opposite side to the second metal plate material 30n between two of the metal plate materials 10n and 30n, the tip bent portion 14n capable of stabilizing a clamping state of the clamp 201 can be easily formed.

Further, between two of the metal plate materials 10n and 30n, one provided with the tip bent portion 14n is the first metal plate material 10n, and the other is the second metal plate material 30n. The first metal plate material 10n includes the first mounting base portion 12n on the mounting base side and the first terminal main body portion 11n having small width protruding in the protruding direction H from the first mounting base portion 12n. The second metal plate material 30n is formed in a substantially band shape with the second terminal main body portion 31n having the same width as the first terminal main body portion 11n of the first metal plate material 10n and the second mounting base portion 32n having the same width as the second terminal main body portion 31n.

For this reason, the first metal plate material 10n including the first mounting base portion 12n having large width and the first terminal main body portion 11n having small width and the second metal plate material 30n formed in a band shape with the second terminal main body portion 31n and the second mounting base portion 32n having the same width can be laminated to form the jump-start terminal 1n capable of stabilizing a clamping state of the clamp 201.

Further, since the tip bent portion 14n is formed to have width corresponding to width of the clamping portion 202 and is formed to have width smaller than width of the first terminal main body portion 11n, it is possible to form the tip bent portion 14n that does not protrude in the width direction W from the first terminal main body portion 11n.

More specifically, the jump-start terminal 1n provided in a manner protruding from the base portion 103 of the base body 102 in the electrical connection box 100 and clamped by the clamping portion 202 in the clamp 201 of the booster cable 200 is provided with two of the metal plate materials 10n and 30n connected to an electric circuit and laminated in the plate thickness direction D, and has an end portion in the protruding direction H as the clamped portion 20n clamped by the clamping portion 202. The tip bent portion 14n protruding to the front surface side Df opposite to the second metal plate material 30n is provided at a tip portion of the first metal plate material 10n between two of the metal plate materials 10n and 30n, and the clamped portion 20n has predetermined thickness for clamping by the clamping portion 202 with required clamping force with two of the metal plate materials 10n and 30n and the tip bent portion 14n. For this reason, the jump-start terminal 1n has high durability, and can be clamped by the clamp 201 for stable conduction.

More specifically, thickness of the clamped portion 20n to be clamped by the clamping portion 202 is set to predetermined thickness with two of the metal plate materials 10n and 30n and the tip bent portion 14n provided at a tip portion of the first metal plate material 10n between two of the metal plate materials 10n and 30n, that is, thickness to be clamped by the clamping portion 202 with application of clamping force that stabilizes a clamping state by the clamping portion 202, so that durability can be improved as compared with a case where a bus bar holding portion made from resin is included, and the clamping portion 202 can clamp the clamped portion 20n of two of the metal plate materials 10n and 30n with required clamping force. Therefore, it is possible to stably perform conduction by clamping with the clamp 201.

Further, since two of the metal plate materials 10n and 30n are clamped by the clamping portion 202, a contact area between the clamping portion 202 and two of the metal plate materials 10n and 30n is increased and conductivity is improved as compared with a case where a holding portion made from resin integrally formed on the base body 102 and a metal plate material are clamped by the clamping portion 202. For this reason, it is possible to reduce an amount of heat generation of the jump-start terminal 1n caused by being clamped by the clamping portion 202 and application of large current.

Further, since the tip bent portion 14n is formed by bending a tip of the first metal plate material 10n between two of the metal plate materials 10n and 30n to the front surface side Df that is the opposite side to the second metal plate material 30n between two of the metal plate materials 10n and 30n, it is possible to easily form the tip bent portion 14n for clamping in a stable clamping state by increasing thickness of the clamped portion 20n to be clamped by the clamping portion 202.

Further, between two of the metal plate materials 10n and 30n, the tip bent portion 14n is provided on the first metal plate material 10n, and the other is the second metal plate material 30n. The first metal plate material 10n includes the first mounting base portion 12n on the mounting base side and the first terminal main body portion 11n having narrow width protruding from the first mounting base portion 12n. The second metal plate material 30n is formed in a substantially band shape with the second terminal main body portion 31n having the same width as the first terminal main body portion 11n and the second mounting base portion 32n having the same width as the second terminal main body portion 31n.

For this reason, the first metal plate material 10n formed of the first mounting base portion 12n having large width and the first terminal main body portion 11n having small width and the second metal plate material 30n formed in a band shape with the second terminal main body portion 31n and the second mounting base portion 32n having the same width can be laminated to form the jump-start terminal 1n having the clamped portion 20n having predetermined thickness that is clamped by the clamping portion 202 with required clamping force.

Further, since the tip bent portion 14n is formed to have width corresponding to width of the clamping portion 202 and is formed to have width smaller than width of the first terminal main body portion 11n, it is possible to form the tip bent portion 14n that does not protrude in the width direction W from the first terminal main body portion 11n.

More specifically, the jump-start terminal 1n provided in a manner protruding from the base portion 103 of the base body 102 in the electrical connection box 100 and clamped by the clamping portion 202 in the clamp 201 of the booster cable 200 includes two of the metal plate materials 10n and 30n connected to an electric circuit and laminated in the plate thickness direction D. One of two of the metal plate materials 10n and 30n reinforces the protruding direction H of the other. For this reason, the jump-start terminal 1n has high durability, and can be clamped by the clamp 201 for stable conduction.

More specifically, in the jump-start terminal 1n provided in a manner protruding from the base portion 103 of the base body 102 in the electrical connection box 100 and clamped by the clamping portion 202 in the clamp 201 of the booster cable 200, one of two of the metal plate materials 10n and 30n connected to an electric circuit and laminated in the plate thickness direction D reinforces the protruding direction H of the other, so that strength in the plate thickness direction D can be secured. Therefore, even the jump-start terminal 1n formed of two of the metal plate materials 10n and 30n not including a resin member has strength in the plate thickness direction D, and a clamping state by the clamp 201 is stabilized, so that conduction can be stably performed.

Further, since two of the metal plate materials 10n and 30n are clamped by the clamping portion 202, a contact area between the clamping portion 202 and two of the metal plate materials 10n and 30n is increased and conductivity is improved as compared with a case where a holding portion made from resin integrally formed on the base body 102 and a metal plate material are clamped by the clamping portion 202. For this reason, it is possible to reduce an amount of heat generation of the jump-start terminal 1n caused by being clamped by the clamping portion 202 and application of large current.

Further, between two of the metal plate materials 10n and 30n, one is the first metal plate material 10n, and the other is the second metal plate material 30n. The first metal plate material 10n includes the first mounting base portion 12n on the mounting base side and the first terminal main body portion 11n having small width protruding in the protruding direction H from the first mounting base portion 12n. The second metal plate material 30n is formed in a substantially band shape with the second terminal main body portion 31n having the same width as the first terminal main body portion 11n of the first metal plate material 10n and the second mounting base portion 32n having the same width as the second terminal main body portion 31n. The tip bent portion 14n bent to the front surface side Df on the opposite side to the second metal plate material 30n is provided at a tip of the first metal plate material 10n.

For this reason, since the first metal plate material 10n formed of the first mounting base portion 12n having large width and the first terminal main body portion 11n having small width and the second metal plate material 30n formed in a band shape with the second terminal main body portion 31n and the second mounting base portion 32n having the same width are laminated, the first terminal main body portion 11n and the second terminal main body portion 31n having the same width are laminated, and one of the first terminal main body portion 11n and the second terminal main body portion 31n reinforces the protruding direction H of the other, and strength in the plate thickness direction D can be secured.

Further, since the tip bent portion 14n is formed to have width corresponding to width of the clamping portion 202 and is formed to have width smaller than width of the first terminal main body portion 11n, it is possible to form the tip bent portion 14n that does not protrude in the width direction W from the first terminal main body portion 11n.

In correspondence between a configuration of the present invention and an embodiment, an electrical connection box of the present invention corresponds to the electrical connection box 100.

Similarly,
a base body corresponds to the base body 102,
a base portion corresponds to the base portion 103,
a booster cable corresponds to the booster cable 200,
a clamp corresponds to the clamp 201,
a clamping portion corresponds to the clamping portion 202,
a jump-start terminal corresponds to the jump-start terminals 1, and 1a to 1n,
a metal plate material corresponds to the metal plate materials 10, and 10a to 10n,
a clamped portion corresponds to the clamped portions 20, and 20a to 20n,
a locking portion corresponds to the locking recessed portion 16, the bead 16a, the folded piece 16b, the engagement recessed portion 16c, the engagement recessed portion 16d, the interlocking portion 16e, the bead 16g, the longitudinal bead 16i, the lattice bead 16j, the tip bent portion 17k, the fastening body 160, the nut portion 162g, and the tip bent portion 14n,
a recessed locking portion corresponds to the locking recessed portion 16, the engagement recessed portion 16c, the engagement recessed portion 16d, and the interlocking portion 16e,
a projecting locking portion corresponds to the bead 16a, the folded piece 16b, the interlocking portion 16e, and the bead 16g,
a bead corresponds to the beads 16a and 16g,
a reference plate material corresponds to the metal plate materials 10a, 10b, 10e, and 10n,
a joining plate material corresponds to the second metal plate materials 30, 30f, and 30n,
a metal thick plate material corresponds to the second metal plate material 30,
one of metal plate materials corresponds to the second metal plate materials 30e and 30f,
a fixing bolt corresponds to the fixing bolt 161,
the other corresponds to the metal plate material 10e,
a fastening hole corresponds to the nut portion 162g, and
a fastening body corresponds to the fastening body 160,
a power supply input terminal corresponds to the power supply input terminal 150,
a protruding direction corresponds to the protruding direction H,
a width direction corresponds to the width direction W, and
a protruding direction bead corresponds to the longitudinal bead 16i and the lattice bead 16j,
a clamped portion corresponds to the clamped portions 20, and 20a to 20m,
a bent clamped portion corresponds to the side bent piece 15,
a locking portion corresponds to the recessed bead 16k and the bead 16g,
a tip bent portion corresponds to the tip bent portions 14 and 14n and the tip bent portion 17k,
a metal thick plate material corresponds to the second metal plate material 30 and the thick plate nut 40g,
a second metal plate material corresponds to the second metal plate materials 30, 30e, 30f, 30h, and 30n and the thick plate nut 40g,
a bead corresponds to the recessed bead 16k,
a recessed portion corresponds to the central recessed portion 18,
an interval holding portion corresponds to the recessed bead 16k and the bent section 16m,
a part of a metal plate material corresponds to a tip side of the second metal plate materials 30k and 30m,
a fastening hole corresponds to the nut portion 162g,
a projecting interval holding portion corresponds to the recessed bead 16k and the bent section 16m,
a projecting piece corresponds to the bent section 16m,
a protruding direction bead corresponds to the longitudinal bead 16i and the lattice bead 16j,
a reinforcing portion corresponds to the side bent piece 15, the longitudinal bead 16i, the second metal plate materials 30, 30e, and 30n, and the thick plate nut 40g,
a bent reinforcing portion corresponds to the side bent piece 15,
a locking portion corresponds to the locking recessed portion 16,
a metal thick plate material corresponds to the second metal plate material 30 and the thick plate nut 40g,
a tip bent portion corresponds to the tip bent portions 14 and 14n,
a second metal plate material corresponds to the second metal plate materials 30, 30e, and 30n and the thick plate nut 40g,
a fastening hole corresponds to the nut portion 162g, and
a protruding direction bead corresponds to the longitudinal bead 16i and the longitudinal bead 16ja. However, the present invention is not limited to only the configuration of the above-described embodiment, and can be applied based on the technical idea shown in the claims, and many embodiments can be obtained.

For example, the jump-start terminal 1 provided in a manner protruding from the base portion 103 of the base body 102 in the above-described electrical connection box 100 is in an aspect of protruding from another portion inside the electrical connection box 100. However, the jump-start terminal 1 may be in an aspect of protruding by providing a recessed portion around the jump-start terminal 1 without protruding from another portion, an aspect of protruding outside the electrical connection box 100, or an aspect of protruding in the inside so as to be exposed to the outside of the electrical connection box 100 without protruding outside the electrical connection box 100.

Two of the interlocking portions 16e and 16f are provided at a predetermined interval in the width direction W, but the number of the interlocking portions 16e and 16f may be one or three or more. In a case where a plurality of the interlocking portions 16e and 16f are provided, all the interlocking portions 16e and 16f may interlock in the same direction, or some of the interlocking portions 16e and 16f may interlock in a direction opposite to another one of the interlocking portions 16e and 16f.

Further, the interlocking portions 16e and 16f may be in an aspect of projecting on a main surface of a metal plate material of the second metal plate materials 30e and 30f among laminated metal plate materials and being recessed on a main surface of the metal plate materials 10e and 10f on another side, or may be in an aspect of being recessed on a main surface of a metal plate material on one side and projecting on a main surface of a metal plate material on another side. Note that a recessed shape may be not only a recess but also an opening or a notch.

In the jump-start terminals 1k and 1 m described above, the metal plate material 10k and the second metal plate materials 30k and 30m are laminated, and the second metal plate materials 30k and 30m are bent to form the thickness-increased portions 50k and 50m. However, a part of the metal plate material 10k may be branched and bent, and arranged at a predetermined interval to form the thickness-increased portions 50k and 50m.

The fastening body 160 includes the fixing bolt 161, the nut 162, and the nut portion 162g, but may be configured in a manner that the nut 162 is screwed to a stud bolt provided on the metal plate material 10.

Note that the clamped portions 20 and 20a to 20n of the jump-start terminals 1 and 1a to 1n described above are formed to have predetermined thickness (about 5 mm or more and 20 mm or less in the present description), but may be formed to have thickness outside the predetermined thickness range as long as a locking portion such as the locking recessed portion 16 that locks the clamping portion 202 that clamps the clamped portions 20 and 20a to 20n is included.

Note that, in the jump-start terminals 1 and 1a to 1n described above, the clamped portions 20 and 20a to 20n include a locking portion such as the locking recessed portion 16 for locking the clamping portion 202 that clamps the clamped portions 20 and 20a to 20n, but the locking portion does not need to be included as long as the clamped portions 20 and 20a to 20n are formed to have predetermined thickness (about 5 mm or more and 20 mm or less in the present description) so that the clamping portion 202 can perform clamping with predetermined clamping force (about 0.5 kgf or more, more preferably about 1.0 kgf or more in the present description).

### REFERENCE SIGNS LIST

1, 1a to 1n jump-start terminal
10, 10a to 10n metal plate material
14, 14n tip bent portion
15 side bent piece
16 locking recessed portion
16a, 16k bead
16b folded piece
16c, 16d engagement recessed portion
16e, 16f interlocking portion
16i longitudinal bead
16i, 16ja longitudinal bead
16j lattice bead
16m bent section
16k recessed bead
16m bent section
17k, 17m tip bent portion
18 central recessed portion
20, 20a to 20n clamped portion
30, 30e, 30f, 30h, 30k, 30m, 30n second metal plate material
40g thick plate nut
100 electrical connection box
102 base body
103 base portion
150 power supply input terminal
160 fastening body
161 fixing bolt
162g nut portion
200 booster cable
201 clamp
202 clamping portion
H protruding direction
W width direction

1-15. (canceled)

16. A jump-start terminal provided in a manner protruding from a base portion of a base body in an electrical connection box and clamped by a clamping portion in a clamp of a booster cable, the jump-start terminal comprising:
two metal plate materials connected to an electric circuit and laminated in a plate thickness direction, wherein
a locking portion that locks the clamping portion that performs clamping is provided at a tip portion of one of two of the metal plate materials, and
the locking portion protrudes to a side opposite to another one of two of the metal plate materials.

17. The jump-start terminal according to claim 16, wherein
the locking portion is formed of a tip bent portion obtained by bending a tip of one of two of the metal plate materials to a side opposite to another one of two of the metal plate materials.

18. The jump-start terminal according to claim 17, wherein
one on which the tip bent portion is provided of two of the metal plate materials is set to a first metal plate material, another one of the metal plate materials is set to a second metal plate material, and the first metal plate material includes a first mounting base portion on a mounting base side and a first terminal main body portion having small width protruding in the protruding direction from the first mounting base portion, and
the second metal plate material is formed in a substantially band shape with a second terminal main body portion having same width as the first terminal main body portion of the first metal plate material and a second mounting base portion having same width as the second terminal main body portion.

19. The jump-start terminal according to claim 18, wherein
the tip bent portion is formed to have width corresponding to width of the clamping portion, and
is formed to have width smaller than width of the first terminal main body portion.

20-36. (canceled)

37. A jump-start terminal provided in a manner protruding from a base portion of a base body in an electrical connection box and clamped by a clamping portion in a clamp of a booster cable, the jump-start terminal comprising:
two metal plate materials connected to an electric circuit and laminated in a plate thickness direction, a tip side being a clamped portion clamped by the clamping portion, wherein
a tip portion of one of two of the metal plate materials is provided with a protruding portion protruding to a side opposite to another one of two of the metal plate materials, and
the clamped portion has, with two of the metal plate materials and the protruding portion, predetermined thickness to be clamped by the clamping portion with required clamping force.

38. The jump-start terminal according to claim 37, wherein
the protruding portion is formed of a tip bent portion obtained by bending a tip of one of two of the metal plate materials to a side opposite to another one of two of the metal plate materials.

39. The jump-start terminal according to claim 38, wherein
one on which the tip bent portion is provided of two of the metal plate materials is set to a first metal plate material, another one of the metal plate materials is set to a second metal plate material, and the first metal plate material includes a first mounting base portion on a mounting base side and a first terminal main body portion having small width protruding from the first mounting base portion, and
the second metal plate material is formed in a substantially band shape with a second terminal main body portion having same width as the first terminal main body portion of the first metal plate material and a second mounting base portion having same width as the second terminal main body portion.

40. The jump-start terminal according to claim 39, wherein
the tip bent portion is formed to have width corresponding to width of the clamping portion, and
is formed to have width smaller than width of the terminal main body portion.

41-49. (canceled)

50. A jump-start terminal provided in a manner protruding from a base portion of a base body in an electrical connection box and clamped by a clamping portion in a clamp of a booster cable, the jump-start terminal comprising:
two metal plate materials connected to an electric circuit and laminated in a plate thickness direction, wherein
one of two of the metal plate materials reinforces a protruding direction of another one of the metal plate materials.

51. The jump-start terminal according to claim 50, wherein
one of two of the metal plate materials is set to a first metal plate material, another one of the metal plate materials is set to a second metal plate material, and the first metal plate material includes a first mounting base portion on a mounting base side and a first terminal main body portion having small width protruding in the protruding direction from the first mounting base portion,
the second metal plate material is formed in a substantially band shape with a second terminal main body portion having same width as the first terminal main body portion of the first metal plate material and a second mounting base portion having same width as the second terminal main body portion, and
a tip bent portion which is bent toward a side opposite to the second metal plate material is provided at a tip of the first metal plate material.

52. The jump-start terminal according to claim 51, wherein
the tip bent portion is formed to have width corresponding to width of the clamping portion, and
is formed to have width smaller than width of the first terminal main body portion.
